(19) United States
(12) Patent Application Publication
(10) Pub. No.: US 2011/0160947 A1
(43) Pub. Date: Jun. 30, 2011

(54) CONTROL DEVICE OF A HYBRID VEHICLE

(75) Inventors: Yukihiko Ideshio, Susono-shi (JP); Hideaki Komada, Susono-shi (JP); Hiroyuki Shibata, Susono-shi (JP); Tomohito Ono, Susono-shi (JP); Wataru Yokoyama, Susono-shi (JP)

(73) Assignee: Toyota Jidosha Kabushiki Kaisha, Toyota-shi, Aichi-ken (JP)

(21) Appl. No.: 13/061,432

(22) PCT Filed: Nov. 5, 2008
(86) PCT No.: PCT/JP2008/070103

§ 371 Date: Feb. 28, 2011

(51) Int. Cl. B60W 20/00; B60W 10/02; B60W 10/08

(52) U.S. Cl. 701/22; 180/65.265; 903/930

(57) ABSTRACT

A control device of a hybrid vehicle includes: a map defined by an accelerator opening degree and a vehicle speed and in which an infinite variable speed mode and a fixed speed change mode are set; and a control means which switches the speed change mode in accordance with the movement of the vehicle operation point on the map. The fixed speed change mode area includes: a first fixed speed change mode area in which the reaction torque becomes equal to or smaller than the maximum rating torque of the motor generator, and a second fixed speed change mode area in which the reaction torque becomes larger than the maximum rating torque. The control means differentiates the speed change mode switching method in accordance with which one of the first and the second fixed speed change mode areas the vehicle operation point locates in or moves to.

### TECHNICAL FIELD

The present invention relates to a control device suitable for a hybrid vehicle.

### BACKGROUND TECHNIQUE

There is known a hybrid vehicle provided with a motor generator functioning as a motor and/or a generator, in addition to an internal combustion engine. The hybrid vehicle drives the internal combustion engine at as high efficiency state as possible and compensates for excess and deficiency of the driving power and/or the engine brake by the motor generator.

As an example of such a hybrid vehicle, there is a hybrid vehicle configured to be able to drive by switching an infinite variable speed mode and a fixed speed change mode as described in the following Patent Reference 1. In this hybrid vehicle, the engine, the generator and the driving axis are connected to the respective revolution elements of the planetary gear mechanism. The brake is connected to the rotor of the generator, and the motor is connected to the driving axis. In the state that brake is released, the reaction torque corresponding to the engine torque is outputted to the motor-generator, thereby to continuously change the number of revolution of the generator. By this, the number of engine revolution continuously changes, and the driving is performed in the infinite variable speed mode. On the other hand, in the state that the brake is engaged, the revolution of the generator is fixed, and the revolution of one of the revolution element of the planetary gear mechanism is prevented. By this, the gear ratio is fixed, and the driving is performed in the fixed speed change mode. Patent Reference 1 discloses such a technique that the brake is engaged to fix the generator (i.e., set to the fixed speed change mode) when the accelerator opening degree is small, and the brake is released (i.e., set to the infinite variable speed mode) when the accelerator opening degree is large, thereby to increase the number of revolution of the generator in proportion to the accelerator opening degree to increase the power generation quantity.

### Patent Reference 1:

Japanese Patent Application Laid-open under No. H09-156387

### DISCLOSURE OF INVENTION

### Problem to be Solved by the Invention

By the way, in the Patent Reference 1, the infinite variable speed mode is set in the range from medium speed to high speed. In this case, however, there is no consideration of the case in which the reaction torque corresponding to the engine torque exceeds the upper limit torque that the generator can output. If the brake is engaged in this case, there may occurs the engine blow-up, i.e., the number of engine revolution abruptly increases. However, it is difficult to clarify whether or not the motor-generator can output the reaction torque corresponding to the engine torque beforehand, when the switching control of the speed change mode is performed. In addition, if the motor-generator is controlled to constantly output the reaction torque corresponding to the engine torque, the generator cannot be downsized.

The present invention is achieved to solve the above-described problem. It is an object of the present invention to provide a control device of a hybrid vehicle capable of clarifying whether the motor-generator can output the reaction torque corresponding to the engine torque beforehand when the switching control of the speed change mode is performed, thereby to prevent the engine blow-up at the time of switching the speed change mode.

### Means for Solving the Problem

According to one aspect of the present invention, there is provided a control device of a hybrid vehicle comprising: an engine; a motor generator; a power distribution mechanism to which the engine and the motor generator are connected; and an engaging mechanism which is connected to a driving axis that receives an output from the power distribution mechanism and any one of revolution elements of the power distribution mechanism, and which fixes and releases the revolution element, the control device comprising: a map which is defined by an accelerator opening degree and a vehicle speed, and in which an infinite variable speed mode and a fixed speed change mode are set; and a control means which releases the revolution element by the engaging mechanism and switches a speed change mode to the infinite variable speed mode of making the motor generator output a reaction torque corresponding to an engine torque of the engine in a case that a vehicle operation point moves from a fixed speed change mode area to an infinite variable speed mode area on the map, and which fixes the revolution element by the engaging mechanism and switches the speed change mode to the fixed speed change mode of making the engaging mechanism receive the reaction torque in a case that the vehicle operation point moves from the infinite variable speed mode area to the fixed speed change mode area on the map, wherein the fixed speed change mode area includes: a first fixed speed change mode area in which the reaction torque becomes equal to or smaller than a maximum rating torque of the motor generator; and a second fixed speed change mode area in which the reaction torque becomes larger than the maximum rating torque, and wherein the control means differentiates a switching method of the speed change mode in accordance with which one of the first and the second fixed speed change mode areas the vehicle operation point locates in or moves to.

The above control device of the hybrid vehicle is applied to a hybrid vehicle comprising: an engine; a motor generator; a power distribution mechanism to which the engine and the motor generator are connected; and an engaging mechanism which is connected to a driving axis that receives an output from the power distribution mechanism and any one of revolution elements of the power distribution mechanism, and which fixes and releases the revolution element. The control device of the hybrid vehicle includes the control means such as an ECU (Electronic Control Unit), and the map which is defined by the accelerator opening degree and the vehicle speed and in which the infinite variable speed mode area and the fixed speed change mode area are set. The control means releases the revolution element by the engaging mechanism and switches a speed change mode to the infinite variable speed mode of making the motor generator output a reaction torque corresponding to an engine torque of the engine in a case that a vehicle operation point moves from a fixed speed change mode area to an infinite variable speed mode area on the map, and fixes the revolution element by the engaging mechanism and switches the speed change mode to the fixed speed change mode of making the engaging mechanism receive the reaction torque in a case that the vehicle operation point moves from the infinite variable speed mode area to the fixed speed change mode area on the map. The engaging mechanism may be a clutch such as a wet-type multiple plate clutch. The fixed speed change mode area includes: a first fixed speed change mode area in which the reaction torque becomes equal to or smaller than a maximum rating torque of the motor generator; and a second fixed speed change mode area in which the reaction torque becomes larger than the maximum rating torque. The control means differentiates a switching method of the speed change mode in accordance with which one of the first and the second fixed speed change mode areas the vehicle operation point locates in or moves to. By this, at the time of performing the speed change mode switching control, it is possible to perform the systematic control that clarifies, in advance, whether or not the motor generator can output the reaction torque corresponding to the engine torque.

One mode of the above control device of the hybrid vehicle further comprises an assist means which outputs at least a part of the reaction torque, and the control means makes the assist means output at least a part of the reaction torque in a case that the vehicle operation point moves to or locates in the second fixed speed change mode area and the revolution element is released at a time of switching the speed change mode. By this, the engine blow-up can be prevented at the time of switching the speed change mode.

In another mode of the above control device of the hybrid vehicle, the control means sets the torque outputted by the motor generator to the maximum rating torque in a case that the assist means outputs the part of the reaction torque at the time of switching the speed change mode. By this, the load on the engaging mechanism can be reduced, and the power generation amount of the motor generator can be large.

In still another mode of the above control device of the hybrid vehicle, the control means sets the torque outputted by the motor generator to the maximum rating torque in a case that the vehicle operation point moves from the infinite variable speed mode area to the second fixed speed change mode area by an increase of the accelerator opening degree or the vehicle speed. By this, the load on the engaging mechanism can be reduced, the power generator amount of the motor generator can be large, and the control can be simplified.

In still another mode of the above control device of the hybrid vehicle, the hybrid vehicle includes an assist motor generator which outputs a torque to the driving axis by an electric power generated by the motor generator, and the control means controls the torque outputted by the assist motor generator such that a driving force of the driving axis becomes a requested driving force, at the time of switching the speed change mode. By this, the shock caused at the time of switching the speed change mode can be suppressed.

In still another mode of the above control device of the hybrid vehicle, the assist means is the engaging mechanism configured such that engaging elements engaging with each other can perform differential rotation. By this, the engaging torque generated in the engaging mechanism can be continuously changed, and the reaction torque corresponding to the engine torque can be received by the engaging mechanism.

In still another mode of the above control device of the hybrid vehicle, the control means controls the engine torque such that the driving force becomes constant, in a case that the vehicle operation point moves from the infinite variable speed mode area to the second fixed speed change mode area by the increase of the accelerator opening degree or the vehicle speed. By this, the shock at the time of engagement of the engaging mechanism can be reduced.

In still another mode of the above control device of the hybrid vehicle, the control means makes the motor generator output the reaction torque in a case that the vehicle operation point moves from the first fixed speed change mode area to the infinite variable speed area by the increase of the accelerator opening degree. By this, the time required until the completion of the engagement of the engaging mechanism can be shortened, and the drivability can be improved.

In still another mode of the above control device of the hybrid vehicle, the control means makes the motor generator and the assist means output the reaction torque in a case that the vehicle operation point moves from the second fixed speed change mode area to the infinite variable speed area by the increase of the accelerator opening degree. By this, the driving force can be increased.

In still another mode of the above control device of the hybrid vehicle, the assist means is a torque-up means which temporarily increases the torque, that can be outputted from the motor generator, to be larger than the maximum rating torque, and the control means increases the torque outputted by the motor generator by the torque-up means and limits the engine torque in accordance with the increased torque outputted by the motor generator in a case that the vehicle operation point moves from the infinite variable speed mode to the second fixed speed change mode. Here, the torque-up means may be an ECU, for example. By this, the number of revolution synchronization control can be performed by the responsive motor generator, while maintaining the driving force.

In still another mode of the above control device of the hybrid vehicle, the control means increases an assist torque outputted by the assist motor generator and decreases the engine torque in accordance with an increased amount of the assist torque such that a driving force of the driving axis becomes a requested driving force in a case that he vehicle operation point moves from the second fixed speed change mode to the infinite variable speed mode. By this, the decrease of the driving force can be prevented at the time of switching the speed change mode.

### BRIEF DESCRIPTION OF THE DRAWINGS

FIG. 1 is a diagram showing a schematic configuration of a hybrid vehicle according to embodiments.

FIGS. 2A and 2B are diagrams showing examples of alignment charts in an infinite variable speed mode and a fixed speed change mode.

FIG. 3 is a diagram showing a moving manner of a vehicle operation point according to a first embodiment.

FIGS. 4A and 4B are diagrams showing a movement of the engine operation point and a change of the alignment chart in the case that the vehicle operation point moves from the infinite variable speed mode area to a first fixed speed change mode area.

FIG. 5 is a timing chart showing a speed change mode switching control in the case that the vehicle operation point moves from the infinite variable speed mode area to the first fixed speed change mode area.

FIGS. 6A and 6B are diagrams showing a movement of the engine operation point and a change of the alignment chart in the case that the vehicle operation point moves from the infinite variable speed mode area to a second fixed speed change mode area.

FIG. 7 is a timing chart showing a speed change mode switching control in the case that the vehicle operation point moves from the infinite variable speed mode area to the second fixed speed change mode area.

FIG. 8 is a flowchart showing a speed change mode switching process according to the first embodiment.

FIG. 9 is a diagram showing a moving manner of the vehicle operation point according to the second embodiment.

FIGS. 10A and 10B are diagrams showing a movement of the engine operation point and a change of the alignment chart in the case that the vehicle operation point moves from the infinite variable speed mode area to the first fixed speed change mode area.

FIG. 11 is a timing chart showing a speed change mode switching control in the case that the vehicle operation point moves from the infinite variable speed mode area to the first fixed speed change mode area.

FIGS. 12A and 12B are diagrams showing a movement of the engine operation point and a change of the alignment chart in the case that the vehicle operation point moves from the infinite variable speed mode area to the second fixed speed change mode area.

FIG. 13 is a timing chart showing a speed change mode switching control in the case that the vehicle operation point moves from the infinite variable speed mode area to the second fixed speed change mode area.

FIG. 14 is a flowchart showing a speed change mode switching process according to the second embodiment.

FIG. 15 shows a moving manner of the vehicle operation point according to the third embodiment.

FIGS. 16A and 16B are diagrams showing a movement of the engine operation point and a change of the alignment chart in the case that the vehicle operation point moves from the infinite variable speed mode area to the first fixed speed change mode area.

FIG. 17 is a timing chart showing a speed change mode switching control in the case that the vehicle operation point moves from the infinite variable speed mode area to the first fixed speed change mode area.

FIGS. 18A and 18B are diagrams showing a movement of the engine operation point and a change of the alignment chart in the case that the vehicle operation point moves from the infinite variable speed mode area to the second fixed speed change mode area.

FIG. 19 is a timing chart showing a speed change mode switching control in the case that the vehicle operation point moves from the infinite variable speed mode area to the second fixed speed change mode area.

FIG. 20 is a flowchart showing a speed change mode switching process according to the third embodiment.

FIG. 21 shows a moving manner of the vehicle operation point according to the fourth embodiment.

FIGS. 22A and 22B are diagrams showing a movement of the engine operation point and a change of the alignment chart in the case that the vehicle operation point moves from the infinite variable speed mode area to the first fixed speed change mode area.

FIG. 23 is a timing chart showing a speed change mode switching control in the case that the vehicle operation point moves from the infinite variable speed mode area to the first fixed speed change mode area.

FIGS. 24A and 24B are diagrams showing a movement of the engine operation point and a change of the alignment chart in the case that the vehicle operation point moves from the infinite variable speed mode area to the second fixed speed change mode area.

FIG. 25 is a timing chart showing a speed change mode switching control in the case that the vehicle operation point moves from the infinite variable speed mode area to the second fixed speed change mode area.

FIG. 26 is a flowchart showing a speed change mode switching process according to the fourth embodiment.

FIG. 27 shows a moving manner of the vehicle operation point according to the fifth embodiment.

FIGS. 28A and 28B are diagrams showing a movement of the engine operation point and a change of the alignment chart in the case that the vehicle operation point moves from the infinite variable speed mode area to the first fixed speed change mode area.

FIG. 29 is a timing chart showing a speed change mode switching control in the case that the vehicle operation point moves from the infinite variable speed mode area to the first fixed speed change mode area.

FIGS. 30A and 30B are diagrams showing a movement of the engine operation point and a change of the alignment chart in the case that the vehicle operation point moves from the infinite variable speed mode area to the second fixed speed change mode area and the MG1 torque-up is performed.

FIG. 31 is a timing chart showing a speed change mode switching control in the case that the vehicle operation point moves from the infinite variable speed mode area to the second fixed speed change mode area and the MG1 torque-up is performed.

FIGS. 32A and 32B are diagrams showing a movement of the engine operation point and a change of the alignment chart in the case that the vehicle operation point moves from the infinite variable speed mode area to the second fixed speed change mode area and the MG1 torque-up is not performed.

FIG. 33 is a timing chart showing a speed change mode switching control in the case that the vehicle operation point moves from the infinite variable speed mode area to the second fixed speed change mode area and the MG1 torque-up is not performed.

FIG. 34 is a timing chart showing a speed change mode switching control in the case that the vehicle operation point moves from the infinite variable speed mode area to the second fixed speed change mode area and the MG1 torque-up is not performed.

FIG. 35 is a flowchart showing a speed change mode switching process according to the fifth embodiment.

FIG. 36 shows a moving manner of the vehicle operation point according to the sixth embodiment.

FIGS. 37A and 37B are diagrams showing a movement of the engine operation point and a change of the alignment chart in the case that the vehicle operation point moves from the first fixed speed change mode area to the infinite variable speed mode area.

FIG. 38 is a timing chart showing a speed change mode switching control in the case that the vehicle operation point moves from the first fixed speed change mode area to the infinite variable speed mode area.

FIGS. 39A and 39B are diagrams showing a movement of the engine operation point and a change of the alignment chart in the case that the vehicle operation point moves from the second fixed speed change mode area to the infinite variable speed mode area and the MG1 torque-up is performed.

FIG. 40 is a timing chart showing a speed change mode switching control in the case that the vehicle operation point moves from the second fixed speed change mode area to the infinite variable speed mode area and the MG1 torque-up is performed.

FIGS. 41A and 41B are diagrams showing a movement of the engine operation point and a change of the alignment chart in the case that the vehicle operation point moves from the second fixed speed change mode area to the infinite variable speed mode area and the MG1 torque-up is not performed.

FIG. 42 is a timing chart showing a speed change mode switching control in the case that the vehicle operation point moves from the second fixed speed change mode area to the infinite variable speed mode area and the MG1 torque-up is not performed.

FIG. 43 is a timing chart showing a speed change mode switching control in the case that the vehicle operation point moves from the second fixed speed change mode area to the infinite variable speed mode area and the MG1 torque-up is not performed.

FIG. 44 is a flowchart showing a speed change mode switching process according to the sixth embodiment.

### DESCRIPTION OF REFERENCE NUMBERS

MG1, MG2 Motor Generator
1 Engine
7 Lock Mechanism
20 Power Distribution Mechanism
4 ECU

### MOST PREFERRED FORM TO EXERCISE THE INVENTION

Preferred embodiments of the present invention will be described below with reference to the attached drawings.

[Device Configuration]

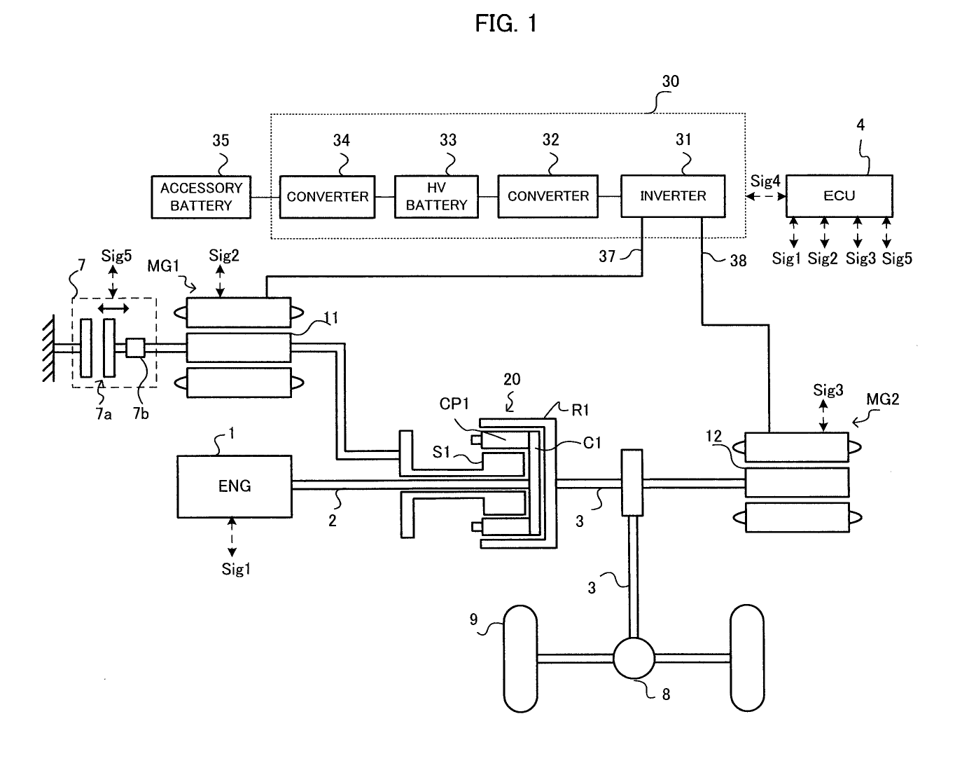

FIG. 1 shows a schematic configuration of a hybrid vehicle to which a control device according to each embodiment is applied. The example of FIG. 1 is a hybrid vehicle of mechanical distribution system two motor type, and includes an engine (internal combustion engine) 1, a first motor-generator MG1, a second motor-generator MG2 and a power distribution mechanism 20. The engine 1 corresponding to a power source and the first motor-generator MG1 are connected to the power distribution mechanism 20. To the driving axis 3 of the power distribution mechanism 20, the second motor-generator MG2 which is the power source for assisting the torque (driving force) or the braking force of the driving axis 3 is connected. Further, the driving axis 3 is connected to the left and right driving wheels 9 via the final reduction gear 8. The first motor-generator MG1 and the second motor-generator MG2 are electrically connected to each other via the battery, the inverter or a suitable controller (see. FIG. 1) or directly, and are configured to drive the second motor-generator MG2 by the electric power generated by the first motor-generator MG1.

The engine 1 is a heat engine which combusts fuel and generates the power, e.g., a diesel engine and a gasoline engine. Mainly, the first motor generator MG1 receives the torque from the engine 1, and revolves to generate the power. At this time, reaction force of the torque caused by the power generation operates on the first motor generator MG1. By controlling the number of revolution of the first motor generator MG1, the number of revolution of the engine 1 continuously changes. Such a speed change mode is referred to as the infinite variable speed mode. Accordingly, the first motor generator MG1 functions as the motor generator of the present invention.

The second motor generator MG2 is the device which assists the driving force or the braking force. When assisting the driving force, the second motor generator MG2 receives the power supply to function as an electromotor. Meanwhile, when assisting the braking force, the second motor generator MG2 is revolved by the torque transferred from the driving wheels 9, and functions as a generator which generates the power. Accordingly, the second motor generator MG2 functions as the assist motor generator of the present invention.

The power distribution mechanism 20 is a so-called single-pinion type planetary gear mechanism, which includes a ring gear R1, a carrier C1 and a sun gear S1. The carrier C1 holds pinion gears CP1 which engage both the ring gear R1 and the sun gear S1.

The output axis 2 of the engine 1 is connected to the carrier C1 of the planetary gear mechanism. One end of the rotor 11 of the first motor generator MG1 is connected to the sun gear S1 of the planetary gear mechanism. The ring gear R1 is connected to the driving axis 3.

The other end of the first motor generator MG1 is connected to a lock mechanism 7. The lock mechanism includes a clutch 7a and an actuator 7b. The clutch 7a includes a pair of engaging elements which engage with each other. Out of the pair of engaging elements, one engaging element is fixed to the case or the like, and the other engaging element is connected to the rotor 11 of the first motor generator MG1. The lock mechanism 7 is configured to engage and release the clutch 7a by using the actuator 7b. Specifically, the actuator 7b engages the clutch 7b by the pushing pressure by oil pressure, for example. The lock mechanism 7 engages the clutch 7a to fix the rotor 11 of the first motor generator MG1 and to fix the sun gear S1 of the power distribution mechanism 20. Also, the lock mechanism 7 releases the engagement of the clutch 7a to release the rotor 11 of the first motor generator MG1 and to release the sun gear S1 of the power distribution mechanism 20. Namely, the clutch 7a functions as a brake which fixes the sun gear S1 of the power distribution mechanism 20. The lock mechanism 7 controls the actuator 7b, based on the control signal Sig5 transmitted from the ECU 4, to control the engagement and the release of the clutch 7a.

In the state that the lock mechanism 7 releases the clutch 7a, the number of the engine revolution of the engine 1 continuously changes by continuously changing the number of revolution of the first motor generator MG1, thereby achieving the infinite variable speed mode. On the other hand, in the state that the lock mechanism 7 engages the clutch 7a, the gear ratio determined by the power distribution mechanism 20 is fixed to the overdrive state (i.e., the state in which the number of revolution of the engine 1 is smaller than the number of revolution of the driving axis 3), thereby achieving the fixed speed change mode.

A power source unit 30 includes an inverter 31, a converter 32, an HV battery 33 and a converter 34. The first motor generator MG1 is connected to the inverter 31 by a power source line 37, and the second motor generator MG2 is connected to the inverter 31 by a power source line 38. In addition, the inverter 31 is connected to the converter 32, and the converter 32 is connected to the HV battery 33. Moreover, the HV battery 33 is connected to an accessory battery 35 via the converter 34.

The inverter 31 gives and receives the power to and from the motor generators MG1 and MG2. At the time of regenerating the motor generators, the inverter 31 converts the power generated by the regeneration of the motor generators MG1 and MG2 to the direct current, and supplies it to the converter 32. The converter 32 converts the voltage of the power supplied from the inverter 31, and charges the HV battery 33. Meanwhile, at the time of powering the motor generators, the voltage of the direct current power outputted from the HV battery 33 is raised by the converter 32 to be supplied to the inverter 31, and is supplied to the motor generator MG1 or MG2 via the power source line 37 or 38.

The voltage of the power of the HV battery 33 is converted by the converter 34, and is supplied to the accessory battery 35 to be used for driving various kinds of accessories.

The operation of the inverter 31, the converter 32, the HV battery 33 and the converter 34 is controlled by an ECU 4. The ECU 4 transmits a control signal Sig4, and controls the operation of each of the components in the power source unit 30. In addition, the signal necessary to show the state of each component in the power source unit 30 is supplied to the ECU 4 as the control signal Sig4. Concretely, a SOC (State Of Charge) showing the state of the HV battery 33 and an input/output limit value of the battery are supplied to the ECU 4 as the control signal Sig4.

The ECU 4 transmits and receives the control signals Sig1 to Sig3 among the engine 1, the first motor generator MG1 and the second motor generator MG2 to control them, and transmits the control signal Sig5 to the lock mechanism 7 to control the lock mechanism 7. For example, the ECU 4 detects the accelerator opening degree to calculate the requested driving force based on the control signal from the accelerator pedal not shown, and controls the engine 1, the first motor generator MG1 and the second motor generator MG2 such that the driving force becomes equal to the requested driving force. In addition, the ECU 4 controls the lock mechanism 7 based on the vehicle speed detected based on the detection signal from the vehicle speed sensor not shown and the number of engine revolution detected based on the detection signal from the crank angle sensor not shown. Therefore, the ECU 4 functions as the control means of the present invention.

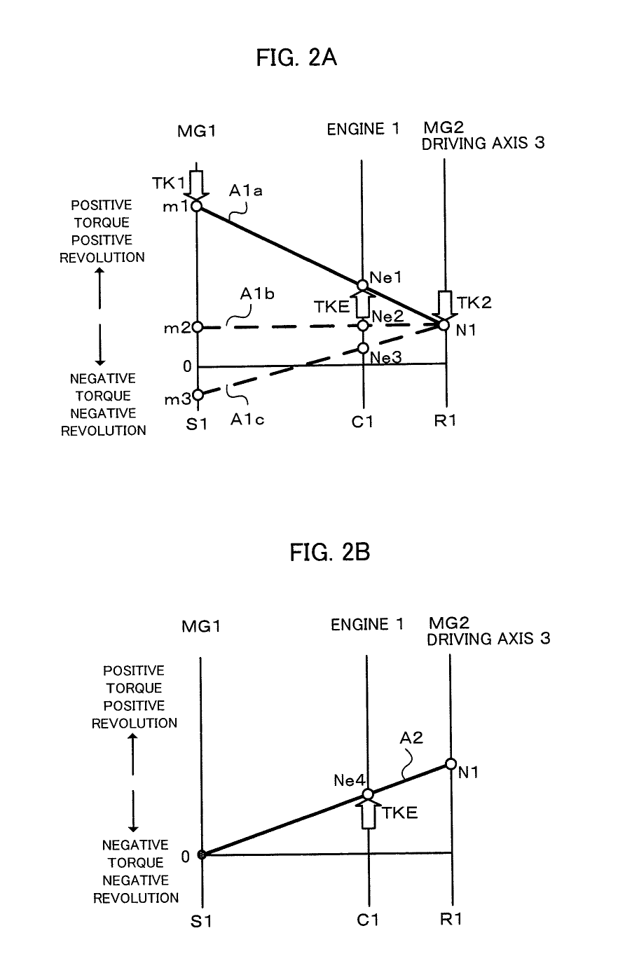

Next, the description will be given of the operation state of the hybrid vehicle in the infinite variable speed mode and the fixed speed change mode with reference to FIGS. 2A and 2B. FIGS. 2A and 2B show examples of the alignment chart in the infinite variable speed mode and the fixed speed change mode. In FIGS. 2A and 2B, the up-down direction corresponds to the number of revolution. The upward direction corresponds to the positive revolution, and the downward direction corresponds to the negative revolution. In FIGS. 2A and 2B, the torque in the upward direction corresponds to the positive torque, and the torque in the downward direction corresponds to the negative torque.

The straight lines Ala, A1b, A1c in FIG. 2A show the examples of the alignment chart in the infinite variable speed mode. In the infinite variable speed mode, the reaction torque corresponding to the engine torque TKE of the engine 1 is outputted by the first motor generator as the torque TK1. As is understood from FIG. 2A, the engine torque TKE is the positive torque, and the torque TK1 is the negative torque. The torque TK2 shows the torque outputted by the second motor generator MG2. In the infinite variable speed mode, by changing the number of revolution of the first motor generator MG1 to increase and decrease, the number of revolution of the engine 1 can be continuously controlled. In the case that the number of revolution of the driving axis 3 is N1, when the number of revolution of the first motor generator MG1 is changed as the white dots m1, m2, m3, in order, for example, the number of revolution of the engine 1 changes as the white dots Ne1(>N1), Ne2(=N1), Ne3(<N1), in order. Namely, the number of revolution of the engine 1 changes to the value higher than, the value equal to and the value lower than the number of revolution of the driving axis 3, in order. At this time, the first motor generator MG1 generates power, and supplies the power to the second motor generator MG2 for assisting the driving axis 3 via the inverter 31. Namely, in the infinite variable speed mode, the output from the engine 1 is transferred to the driving axis 3 via two routes, i.e., the route in which the output is directly transferred to the driving axis 3 via the power distribution mechanism 20, and the route in which the output is electrically transferred from the first motor generator MG1 to the second motor generator MG2 for assisting the driving axis 3.

The straight line A2 in FIG. 2B shows an example of the alignment chart in the fixed speed change mode. In the case of the fixed speed change mode, the lock mechanism 7 fixes the rotor 11 of the first motor generator MG1 and the sun gear S1, and hence the gear ratio determined by the power distribution mechanism 20 is fixed to the overdrive state (i.e., the number of revolution Ne4 of the engine 1 becomes smaller than the number of revolution N1 of the driving axis 3). At this time, the clutch 7a of the lock mechanism 7 receives the reaction torque corresponding to the engine toque of the engine 1. Since the first motor generator MG1 does not function as the generator and the motor, the power is not supplied from the first motor generator MG1 to the second motor generator MG2. Therefore, in the fixed speed change mode, the output from the engine 1 is transferred to the driving axis 3 only via the route directly to the driving axis 3 via the power distribution mechanism 20.

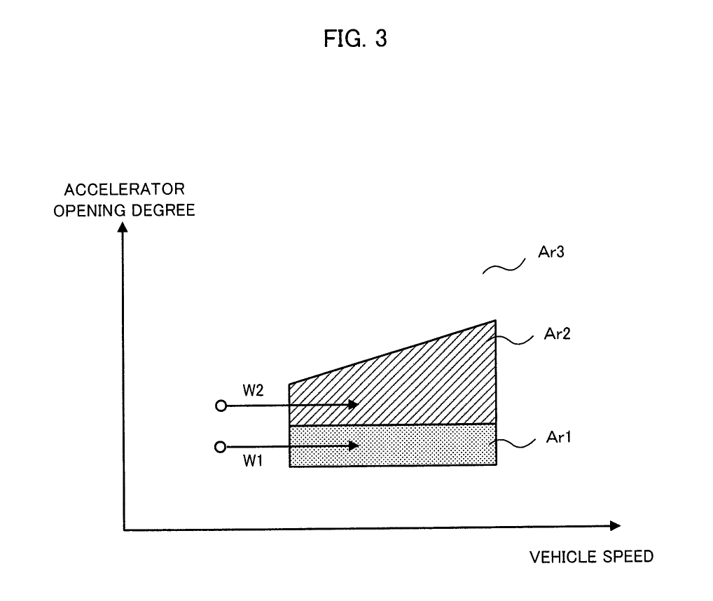

Next, the speed change mode switching control method of the present invention will be specifically described. FIG. 3 is a diagram showing the moving manner of the operation point (vehicle operation point) on the map defined by the vehicle speed and the accelerator opening degree. The vertical axis shows the accelerator opening degree and the horizontal axis shows the vehicle speed. The vehicle operation point is shown by the white dot. On the map shown in FIG. 3, there are set a fixed speed change mode areas Ar1, Ar2, and an infinite variable speed mode area Ar3 which is different from the fixed speed change mode areas Ar1, Ar2. Based on the map shown in FIG. 3, the ECU 4 sets the speed change mode to the fixed speed change mode when the vehicle operation point moves to the fixed speed change mode areas Ar1, Ar2, and sets the speed change mode to the infinite variable speed mode when the vehicle operation point moves to the infinite variable speed mode area Ar3. Although the map is defined by the vehicle speed and the accelerator opening degree, the map is not limited to this. Alternatively, the map may be defined by the vehicle speed and the driving force.

The fixed speed change mode areas Ar1, Ar2 includes a first fixed speed change mode area Ar1 and a second fixed speed change mode area Ar2. The first fixed speed change mode area Ar1 is the area where the reaction torque corresponding to the engine torque is equal to or smaller than the maximum rating torque of the first motor generator MG1. On the other hand, the second fixed speed change mode area Ar2 is the area where the reaction torque corresponding to the engine torque exceeds the maximum rating torque of the first motor generator MG1. Here, the maximum rating torque is the maximum value of the toque that the first motor generator MG1 can continuously output.

For example, at the time of switching the speed change mode, when the vehicle operation point moves from the infinite variable speed mode area Ar3 to the first fixed speed change mode area Ar1 as shown by the arrow W1, the reaction toque corresponding to the engine torque is always equal to or smaller than the maximum rating torque of the first motor generator MG1. Accordingly, the first motor generator MG1 can always output the reaction torque corresponding to the engine torque. In this case, the ECU 4 engages the clutch 7a of the lock mechanism 7 to switch the speed change mode from the infinite variable speed mode to the fixed speed change mode after controlling the first motor generator MG1 to perform the number of revolution synchronizing control which controls the number of revolution of the first motor generator MG1 to “0”.

On the other hand, at the time of switching the speed change mode, when the vehicle operation point moves from the infinite variable speed change mode area Ar3 to the second fixed speed change mode area Ar2 as shown by the arrow W2, the reaction torque corresponding to the engine torque exceeds the maximum rating torque of the first motor generator MG1 when the vehicle operation point reaches the second fixed speed change mode area Ar2. Therefore, when the clutch 7a of the lock mechanism 7 is released, there is a possibility that the phenomenon (blow-up) that the number of engine revolution suddenly increases occurs. In this case, it becomes difficult to make the number of revolution of the first motor generator MG1 “0”. If the clutch 7a is engaged without making the number of revolution of the first motor generator MG1 “0”, the engagement shock takes place, and excessive load is applied to the clutch 7a.

Therefore, in the control device of the hybrid vehicle according to the present invention, the ECU 4 changes the switching control method of the speed change mode, at the time of switching the speed change mode, based on the area to which the vehicle operation point moves to or locates in, on the map shown in FIG. 3 in which the first fixed speed change mode area Ar1 and the second fixed speed change mode area Ar2 are set. By this, at the time of performing the speed change mode switching control, it is possible to perform the systematic control that clarifies, in advance, whether the first motor generator MG1 can output the reaction torque corresponding to the engine torque. As a specific control method, the ECU 4 makes an auxiliary means such as the clutch 7a output at least a part of the reaction torque corresponding to the engine torque, when the vehicle operation point moves to or locates in the second fixed speed change mode area Ar2 and the clutch 7a is being released. By this, the blow-up of the engine can be prevented. Each of the embodiments of the present invention will be hereinafter described in detail.

### 1st Embodiment

First, a first embodiment of the present invention will be described. In the first embodiment, the description will be given of the method of the speed change mode switching control in the case that the vehicle speed increases and the vehicle operation point moves from the infinite variable speed mode area Ar3 to the fixed speed change mode areas Ar1, Ar2, respectively, as shown by the arrows W1, W2 in FIG. 3.

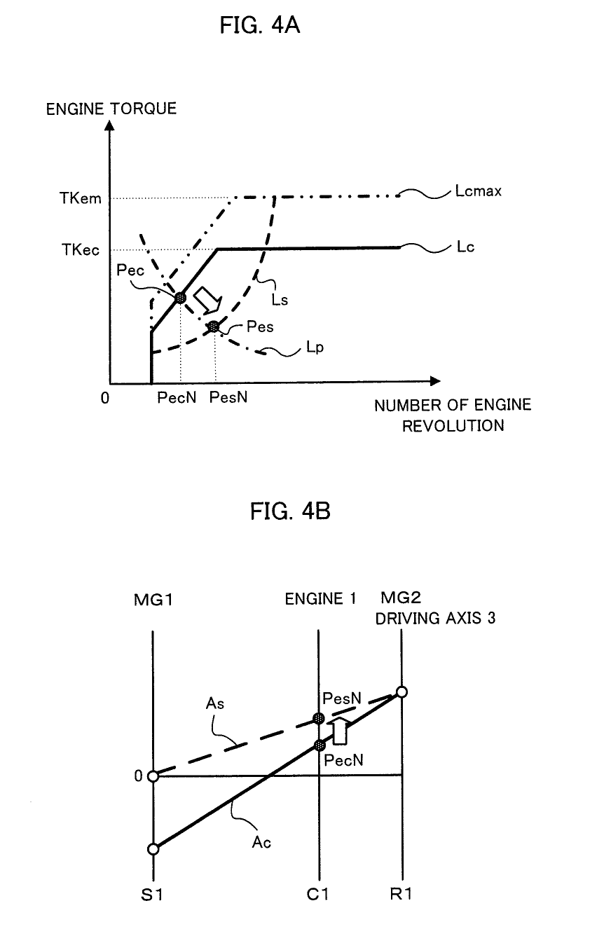

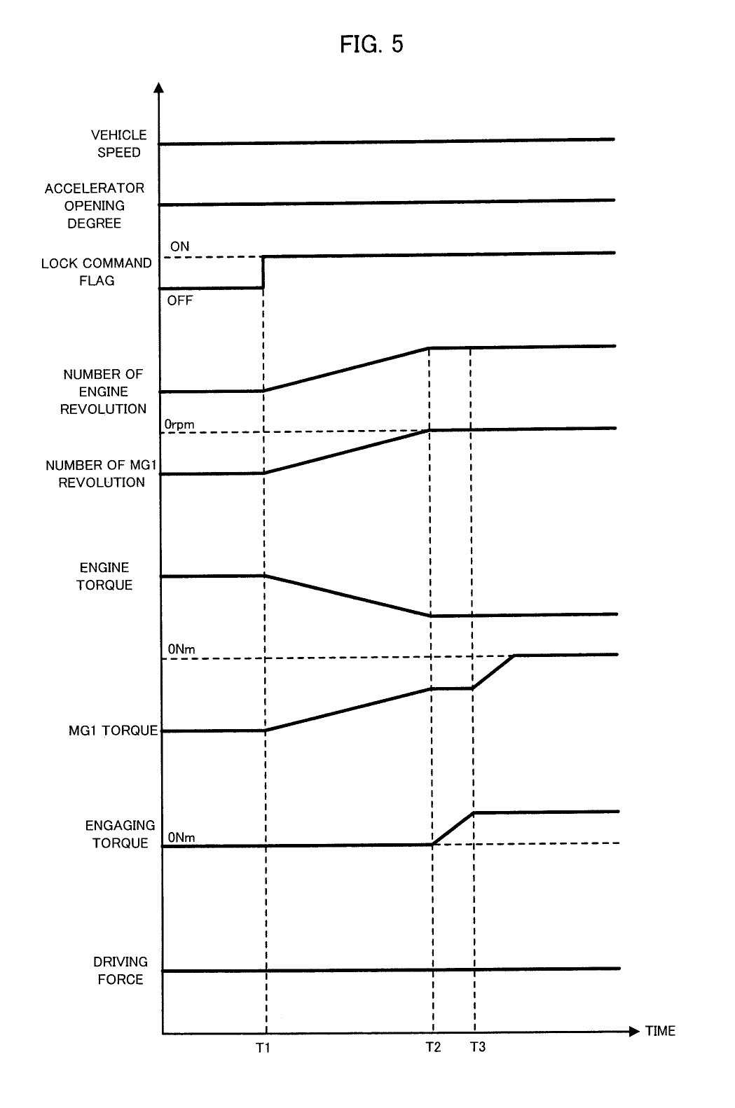

First, the description will be given of the speed change mode switching control method in the case that the vehicle speed increases and the vehicle operation point moves from the infinite variable speed mode area Ar3 to the first fixed speed change mode area Ar1 (the case shown by the arrow W1 in FIG. 3), with reference to FIGS. 4 and 5.

FIG. 4A is a diagram showing the moving manner of the operation point of the engine 1 (engine operation point) determined by the engine torque and the number of engine revolution. The vertical axis shows the engine toque, and the horizontal axis shows the number of engine revolution. Specifically, FIG. 4A shows the moving manner of the engine operation point in the case that the vehicle speed increases and the vehicle operation point moves from the infinite variable speed mode area Ar3 to the first fixed speed change mode area Ar1.

In FIG. 4A, the solid line Lc shows the operation line of the engine 1 in the infinite variable speed mode (hereinafter referred to as “CVT operation line”). The CVT operation line is defined to be optimum in view of improving the fuel consumption. As shown in FIG. 4A, on the CVT operation line Lc, the maximum value of the engine torque of the engine 1 is the torque TKec. The torque TKec indicates the engine torque at the time when the reaction torque becomes equal to the maximum rating torque of the first motor generator MG1. In other words, when the engine torque exceeds the torque TKec, the reaction torque corresponding to the engine torque exceeds the maximum rating torque of the first motor generator MG1. The torque TKec will be hereinafter referred to as “reaction force upper limit engine torque”. The point Pec on the CVT operation line indicates the engine operation point in the infinite variable speed mode.

In FIG. 4A, the torque TKem indicates the maximum value of the engine torque that the engine 1 itself can output (hereinafter referred to as “maximum engine torque”). The chain double-dashed line Lcmax shows the operation line (hereinafter referred to as “maximum engine torque operation line”) when the engine 1 outputs the maximum engine torque. The broken line Ls shows the operation line of the engine 1 in the fixed speed change mode, and the dashed line Lp shows the equi-power line. The point Pes on the operation line Ls indicates the engine operation point in the fixed speed change mode.

FIG. 4B shows the changing manner of the alignment chart at that time. In FIGS. 4A and 4B, the number of engine revolution when the engine operation point is the point Pec is indicated by PecN, and the number of engine revolution when the engine operation point is the point Pes is indicated by PesN.

In FIG. 4A, when the engine torque decreases as the number of engine revolution increases, the engine operation point moves along the equi-power line Lp from the point Pec to the point Pes. When the engine operation point moves from the point Pec to the point Pes, the alignment chart changes from the straight line Ac to the straight line As as shown in FIG. 4B. Namely, in order to engage the clutch 7a, the first motor generator MG1 is controlled from the state of negative revolution to the state of number of revolution “0”.

FIG. 5 shows the timing chart of the speed change mode switching control in the case that the engine operating point moves from the point Pec to the point Pes in FIG. 4A. In FIG. 5, the vertical axes show the vehicle speed, the accelerator opening degree, the lock command flag, the number of engine revolution, the number of revolution of the first motor generator MG1 (the number of MG1 revolution), the engine torque, the torque of the first motor generator MG1 (the MG1 torque), the engaging torque of the clutch 7a of the lock mechanism 7 and the driving force, in this order from the top, and the horizontal axis shows the time. In the timing charts described below, including FIG. 5, the positive value indicates the positive revolution and the negative value indicates the negative revolution, with respect to the number of MG1 revolution and the number of revolution of the second motor generator MG2 (number of MG2 revolution). The number of engine revolution is always the positive revolution. Also, the positive value indicates the positive torque and the negative value indicates the negative torque, with respect to the engine torque, the MG1 torque and the torque of the second motor generator MG2 (the MG2 torque). Hereinafter, the increase/decrease of the torque and the number of revolution means the increase/decrease of the magnitude of the torque and the number of revolution, i.e., the increase/decrease of the absolute value, unless it is specially noted. In the example shown in FIG. 5, since the engine operation point moves along the equi-power line Lp, the driving force is kept constant during the speed change mode switching control.

The ECU 4 stores the relation between the vehicle speed and the accelerator opening degree as shown in FIG. 3 in the memory or the like as the map (hereinafter referred to as “speed change mode determination map”). When the ECU 4 determines that the vehicle operation point moves from the infinite variable speed mode area Ar3 to the first fixed speed change mode area Ar1, from the speed change mode determination map based on the vehicle speed, the ECU 4 changes the lock command flag from OFF to ON. The time is defined as T1. When the ECU 4 confirms that the lock command flag becomes ON, it starts the speed change mode switching control.

From time T1 to time T2, the ECU 4 performs the control of gradually decreases the engine torque from the engine torque at time T1. Further, from time T1 to time T2, the ECU 4 controls the first motor generator MG1 to gradually decrease the MG1 torque to be equal to the reaction torque corresponding to the engine torque and make the number of MG1 revolution approach “0” from the number of revolution of the negative revolution. When the number of MG1 revolution approaches “0” from the number of revolution of the negative revolution, the number of engine revolution increases as shown in FIG. 4B. Thus, in FIG. 4A, the engine operation point moves from the point Pec to the point Pes. When the number of MG1 revolution becomes “0” (time T2), the ECU 4 increases the pushing pressure of the actuator 7b to make the clutch 7a completely engage, and decreases the MG1 torque. When the clutch 7a completely engages (time T3), the ECU 4 makes the MG1 torque “0” and ends the speed change mode switching control. In this way, by completely engaging the clutch 7a after making the number of MG1 revolution “0”, the shock can be prevented at the time of engaging the clutch 7a and the load on the clutch 7a can be suppressed.

As described above, in the case that the vehicle speed increases and the vehicle operation point moves from the infinite variable speed mode area Ar3 to the first fixed speed change mode area Ar1, the ECU 4 performs the synchronization control of controlling the MG1 torque to be the reaction torque corresponding to the engine torque and making the number of MG1 revolution approach “0”, thereby to switch the speed change mode from the infinite variable speed mode to the fixed speed change mode.

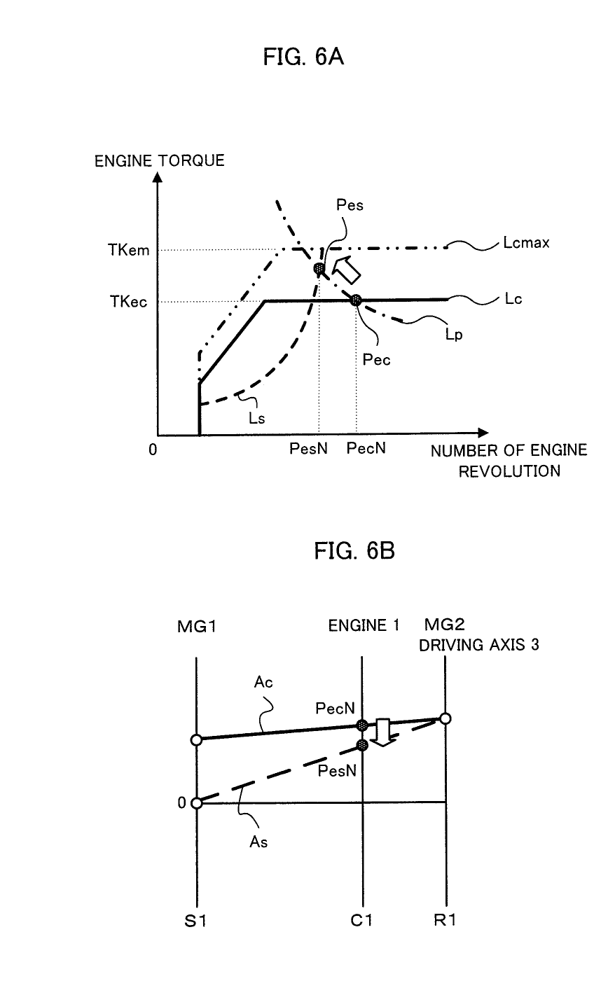

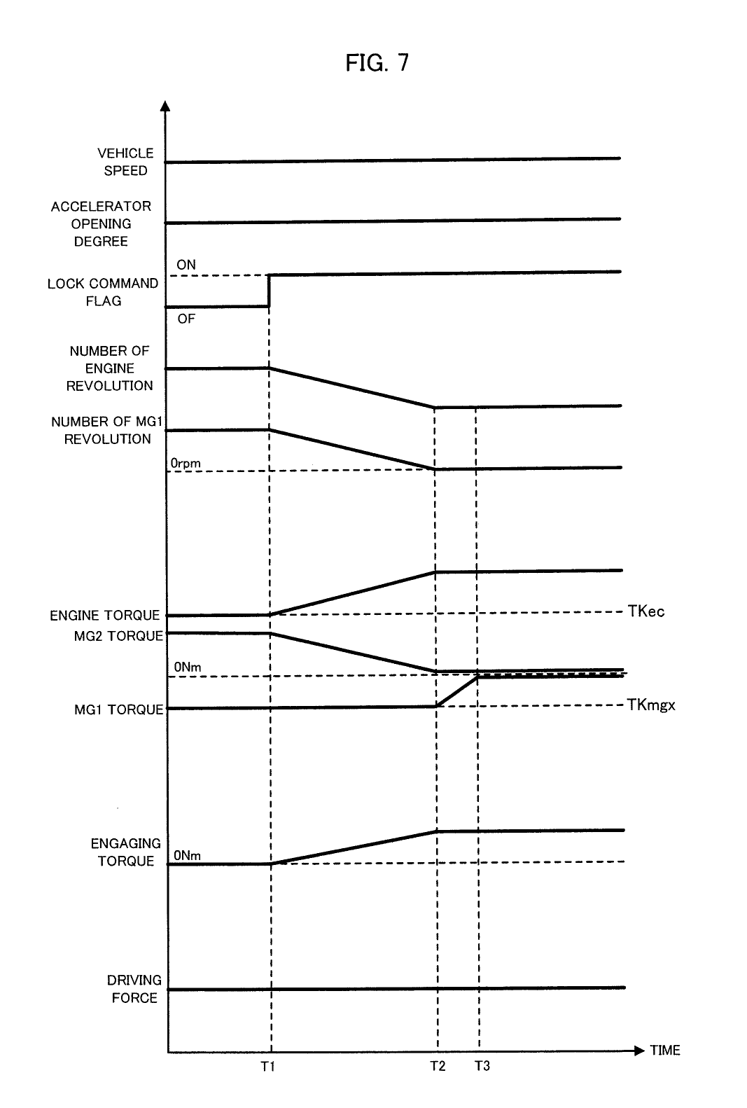

Next, the description will be given of the speed change mode switching control method in the case that the vehicle speed increases and the vehicle operation point moves from the infinite variable speed mode area Ar3 to the second fixed speed change mode area Ar2 (the case shown by the arrow W2 in FIG. 3), with reference to FIGS. 6 and 7.

FIG. 6A is a diagram showing the moving manner of the engine operation point in the case that the vehicle speed increases and the vehicle operation point moves from the infinite variable speed mode area Ar3 to the second fixed speed change mode area Ar2. The vertical axis shows the engine torque, and the horizontal axis shows the number of engine revolution. Similarly to FIG. 4A, FIG. 6A shows the CVT operation line Lc, the operation line Ls of the engine 1 in the fixed speed change mode, the equi-power line Lp and the maximum engine torque operation line Lcmax. FIG. 6B shows the changing manner of the alignment chart at that time.

In FIG. 6A, when the number of engine revolution decreases and the engine torque increases, the engine operation point moves along the equi-power line Lp from the point Pec on the CVT operation line Lc to the point Pes on the operation line Ls. At that time, as shown in FIG. 6B, the alignment chart changes from the straight line Ac to the straight line As. Namely, in order to engage the clutch 7a of the lock mechanism 7, the first motor generator MG1 is controlled from the state of positive revolution to the state of the number of revolution “0”.

FIG. 7 shows the timing chart of the speed change mode switching control in the case that the engine operation point moves from the point Pec to the point Pes in FIG. 6A. In FIG. 7, the vertical axes show the vehicle speed, the accelerator opening degree, the lock command flag, the number of engine revolution, the number of MG1 revolution, the engine torque, the torque of the second motor generator (the MG2 torque), the MG1 torque, the engaging torque of the clutch 7a of the lock mechanism 7 and the driving force, in this order from the top, and the horizontal axis shows the time. Also in the example shown in FIG. 7, since the engine operation point moves along the equi-power line Lp, the driving force is kept constant during the speed change mode switching control.

When the ECU 4 determines that the vehicle operation point moves from the infinite variable speed mode area Ar3 to the second fixed speed change mode area Ar2, from the speed change mode determination map based on the vehicle speed, the ECU 4 changes the lock command flag from OFF to ON (time T1). When the ECU 4 confirms that the lock command flag becomes ON, it starts the speed change mode switching control.

From time T1 to time T2, the ECU 4 performs the control of gradually increasing the engine torque from the engine torque at the time T1. Here, as shown in FIG. 6A, when the engine torque increases in the state that the engine operation point is at the point Pec, the engine torque exceeds the reaction force upper limit engine torque TKec, i.e., the reaction torque corresponding to the engine torque exceeds the maximum rating torque TKmgx of the MG1 torque.

Therefore, in the first embodiment, a clutch configured such that the engaging elements that engage with each other can perform differential revolution is used as the clutch 7a. In such a clutch, it is possible to change the friction force caused between the engaging elements and continuously change the engaging torque by controlling the pushing pressure of the actuator 7b. For example, the ECU 4 can increase the friction force caused between the engaging elements to increase the engaging torque by increasing the pushing pressure against the clutch. An example of such a clutch is a wet-type multi-plate clutch. From time T1 to time T2, the ECU 4 sets the MG1 torque to the maximum rating torque TKmgx, and, at the same time, gradually increases the engaging torque of the clutch 7a and gradually makes the number of MG1 revolution approach “0” by gradually increasing the pushing pressure of the actuator 7b. Namely, from time T1 to time T2, the ECU 4 makes not only the first motor generator MG1 but the clutch 7a output the reaction torque corresponding to the engine torque. By this, the engine blow-up can be prevented, and the number of MG1 revolution can be “0”. When the number of MG1 revolution gradually approaches “0” from the number of revolution of the negative revolution, the number of engine revolution also gradually decreases as shown in FIG. 6B. Thus, the engine operation point moves from the point Pec to the point Pes in FIG. 6A.

As described above, the ECU 4 sets the MG1 torque to the maximum rating torque TKmgx from time T1 to time T2. By this, in comparison with the case in which the MG1 torque is set to the torque smaller than the maximum rating torque TKmgx, the load on the clutch 7a of the lock mechanism 7 can be reduced, and the power generation amount of the first motor generator MG1 can be large. In addition, in the case that the vehicle operation point moves from the infinite variable speed mode area Ar3 to the second fixed speed change mode area Ar2, by determining in advance that the MG1 torque is always set to the maximum rating torque TKmgx, it becomes unnecessary to perform the cooperative control for the first motor generator MG1, and the control can be simplified.

In addition to the above-mentioned control, the ECU 4 may correct the engine torque such that the driving force becomes constant in accordance with the engaging torque. Specifically, the ECU 4 calculates the engine torque to keep the driving force constant by using the following equations of motion (1) to (6) of the differential mechanism, and calculates the difference between the calculated engine torque and the actual engine torque as the correction torque. Then, the ECU 4 supplies the control signal to the engine 1 to correct the engine torque by the amount of the correction torque. Thus, the shock at the time of engaging the clutch 7a can be reduced. In addition, if it is determined in advance that the correction torque is calculated by using the equations of motion of the differential mechanism and the engine torque is corrected by the amount of the correction torque, it becomes unnecessary to perform the cooperative control for the engine 1, and the control can be simplified.

$$\begin{matrix}Is \cdot \ddot{θ} s = Ts + \frac{ρ}{1 + ρ} Tx & ( 1 ) \\ Ic \cdot \ddot{θ} c = Tc - Tx & ( 2 ) \\ Ir \cdot \ddot{θ} r = Tr + \frac{1}{1 + ρ} Tx & ( 3 ) \\ \dot{θ} c = \frac{ρ \dot{θ} s + \dot{θ} r}{1 + ρ} & ( 4 ) \\ ρ = \frac{Zs}{Zr} & ( 5 ) \\ \ddot{θ} r = 0 ( for constant driving force ) \\ Is , θ s , Ts : Inertial Mass , Angular Acceleration , \\ Torque of Revolution Element connected to Sun Gear \\ Ic , θ c , Tc : Inertial Mass , Angular Acceleration , \\ Torque of Revolution Element connected to Carrier \\ Ir , θ r , Tr : Inertial Mass , Angular Acceleration , \\ Torque of Revolution Element connected to Ring Gear Tx : Transferr Torque of Differential Mechanism \\ Zs : Number of T eeth of Sun Gear \\ Zr : Number of T eeth of Ring Gear & ( 6 )\end{matrix}$$

The ECU 4 may perform the compensation control by the second motor generator MG2 to make the driving force equal to the requested driving force, irrespective of which one of the first fixed speed change mode area Ar1 and the second fixed speed change mode area Ar2 the vehicle operation point moves to.

For example, in the case that the vehicle operation point moves to the second fixed speed change mode area Ar2, if the engine torque cannot be corrected for the amount of the correction torque, the ECU 4 may correct the MG2 torque in addition to the above-mentioned engine torque control such that the driving force becomes constant. For example, in the example shown in FIG. 7, the ECU 4 gradually decreases the MG2 torque, in accordance with the engine torque gradually increasing, from time T1 to time T2. By this, the driving force can be kept constant. In addition, during the period after transmitting the control signal to the engine 1 until the engine torque is corrected by the amount of the correction torque, the ECU 4 may control the second motor generator MG2 having faster response than the engine 1 to correct the MG2 torque such that the driving force becomes constant. By doing this, the variation of the driving force due to the delayed response of the engine 1 can be suppressed. Also in this example, out of the engine torque and the MG2 torque, the engine torque is corrected with higher priority. By this, in comparison with the case of correcting the MG2 torque with higher priority, the power consumption amount of the HV battery 33 can be suppressed, and the load on the HV battery 33 can be reduced. Further, the shock at the time of engaging the clutch 7a can be suppressed irrespective of the charging condition of the HV battery 33.

As described above, in the case that the vehicle speed increases and the vehicle operation point moves from the infinite variable speed mode area Ar3 to the fixed speed change mode area Ar2, the ECU 4 controls the MG1 torque to be the maximum rating torque TKmgx and controls the engaging torque of the clutch 7a to switch the speed change mode from the infinite variable speed mode to the fixed speed change mode.

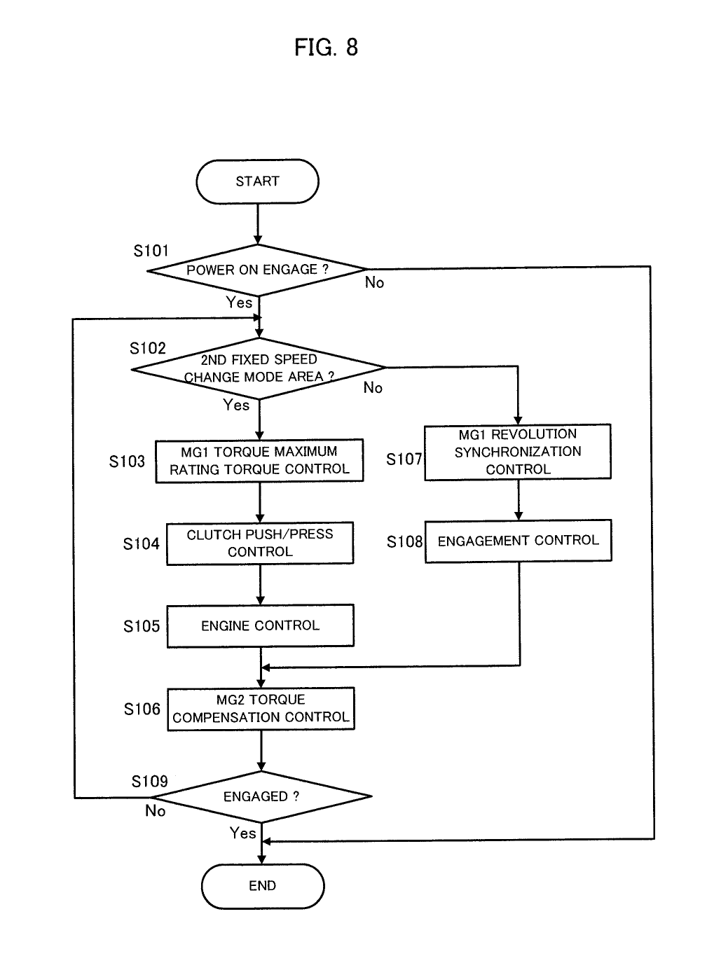

Next, the speed change mode switching process according to the first embodiment will be described with reference to the flowchart shown in FIG. 8. In the speed change mode switching process according to the first embodiment, based on the vehicle speed, the ECU 4 determines which one of the fixed speed change mode areas Ar1 and Ar2 the vehicle operation point moves from the infinite variable speed mode area Ar3, and performs the speed change mode switching control in accordance with the respective cases.

In step S101, the ECU 4 determines whether the vehicle operation point moves to the fixed speed change mode area, i.e., the clutch 7a of the lock mechanism 7 should be engaged (power-on engagement), based on the vehicle speed by using the speed change mode determination map. The ECU 4 ends this control process when it determines that the clutch 7a should not be engaged (step S101: No), and goes to step S102 when it determines that the clutch 7a should be engaged (step S101: Yes).

In step S102, the ECU 4 determines whether the vehicle operation point moves to the second fixed speed change mode area Ar2 by the speed change mode determination map, and goes to step S103 when it determines that the vehicle operation point moves to the second fixed speed change mode area Ar2 (step S102: Yes). On the contrary, the ECU 4 goes to step S107 when it determines that the vehicle operation point does not move to the second fixed speed change mode area Ar2, i.e. it determines that the vehicle operation point moves to the first fixed speed change mode area Ar1 (step S102:No).

In step S103, the ECU 4 sets the MG1 torque to the maximum rating torque. In step S104, the ECU 4 performs the clutch push/press control for gradually increasing the pushing pressure of the actuator 7b, and gradually increases the engaging torque of the clutch 7a of the lock mechanism 7. By this, the reaction torque corresponding to the engine torque is outputted by the clutch 7a and the first motor generator MG1.

In step S105, the ECU 4 performs the engine control to correct the engine torque in accordance with the engaging torque such that the driving force becomes constant.

In step S106, the ECU 4 performs the MG2 torque compensation control to correct the MG2 torque such that the driving force becomes constant. Thereafter, the ECU 4 goes to step S109.

In step S109, the ECU 4 determines whether or not the engagement of the clutch 7a is completed. When the ECU 4 determines that the engagement of the clutch 7a is not completed (step S109: No), it goes back to step S102. When the ECU 4 determines that the engagement of the clutch 7a is completed (step S109: Yes), it ends this control process.

On the other hand, in the aforementioned step S102, when the ECU 4 determines that the vehicle operation point does not move to the second fixed speed change mode area Ar2, i.e., the vehicle operation point moves to the first fixed speed change mode area Ar1 (step S102: No), it goes to step S107. In step S107, the ECU 4 performs the number of MG1 revolution synchronization control, which controls the first motor generator MG1 to control the MG1 torque to be equal to the reaction torque corresponding to the engine torque and gradually makes the number of MG1 revolution approach “0”. In the following step S108, the ECU 4 performs the engagement control of increasing the pushing pressure of the actuator 7b to completely engage the clutch 7a. Thereafter, the ECU 4 goes to steps S106, S109, and ends this control process.

As is understood from the above description, in the first embodiment, in the case that the vehicle operation point moves from the infinite variable speed mode area Ar3 to the first fixed speed change mode area Ar1 according to the increase of the vehicle speed, the ECU 4 performs the synchronization control of making the number of MG1 revolution approach “0” while controlling the MG1 torque to the reaction torque corresponding to the engine torque. By this, the shock at the time of the engagement of the clutch 7a can be prevented, and the load on the clutch 7a can be suppressed. Further, in the first embodiment, in the case that the vehicle operation point moves from the infinite variable speed mode area Ar3 to the second fixed speed change mode area Ar2 according to the increase of the vehicle speed, the ECU 4 makes the clutch 7a of the lock mechanism 7 to receive a part of the reaction torque corresponding to the engine torque. By this, the engine blow-up at the time of the speed change mode switching can be prevented.

### 2nd Embodiment

Next, the second embodiment of the present invention will be described.

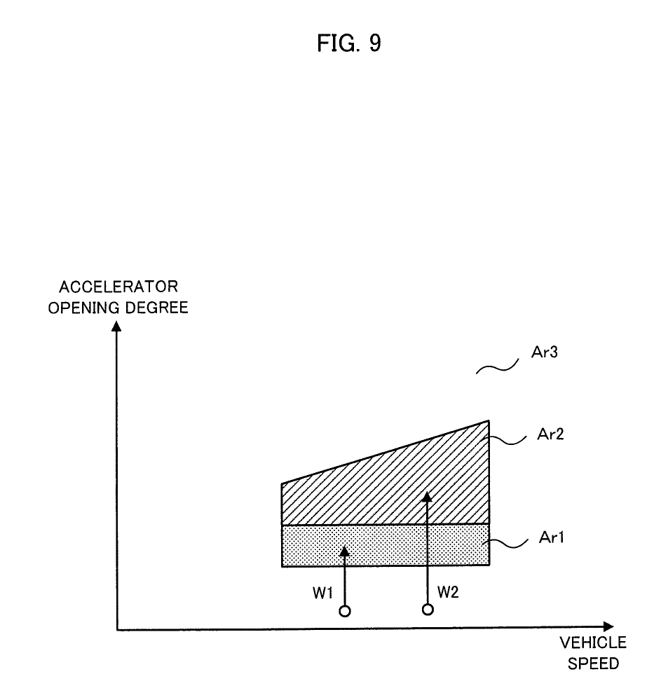

FIG. 9 is a diagram showing the moving manner of the vehicle operation point according to the second embodiment. The vertical axis shows the accelerator opening degree, and the horizontal axis shows the vehicle speed. FIG. 9 also shows the infinite variable speed mode area Ar3 and the fixed speed change mode areas Ar1, Ar2, and the vehicle operation point is indicated by the white dot. In the second embodiment, as shown by the arrows W1, W2 in FIG. 9, the description will be given of the speed change mode switching control method in the case that the accelerator opening degree increases and the vehicle operation point moves from the infinite variable speed mode area Ar3 to the fixed speed change mode areas Ar1, Ar2.

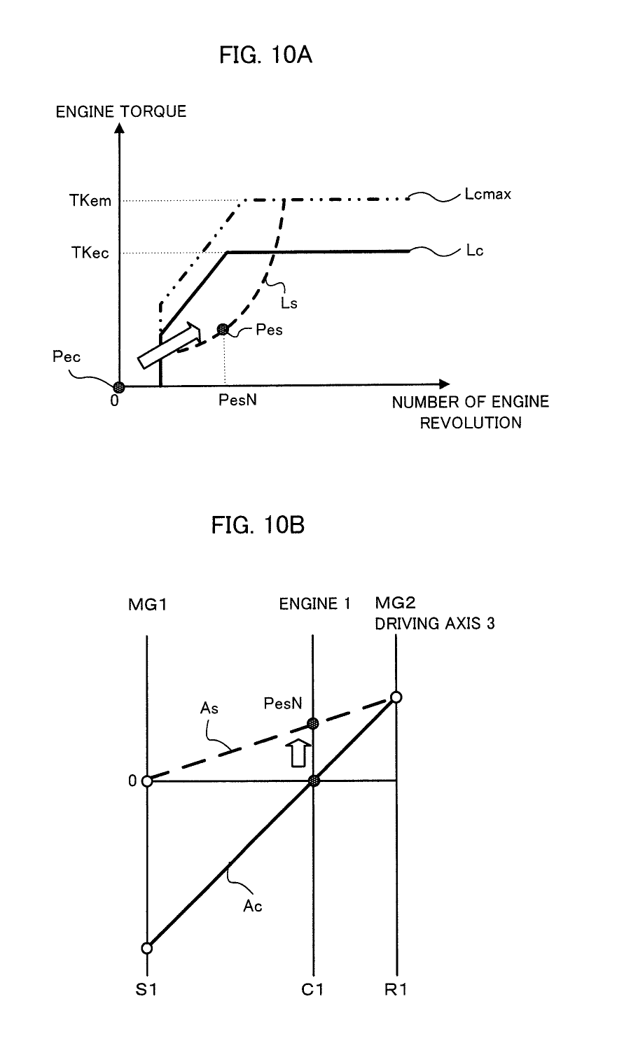

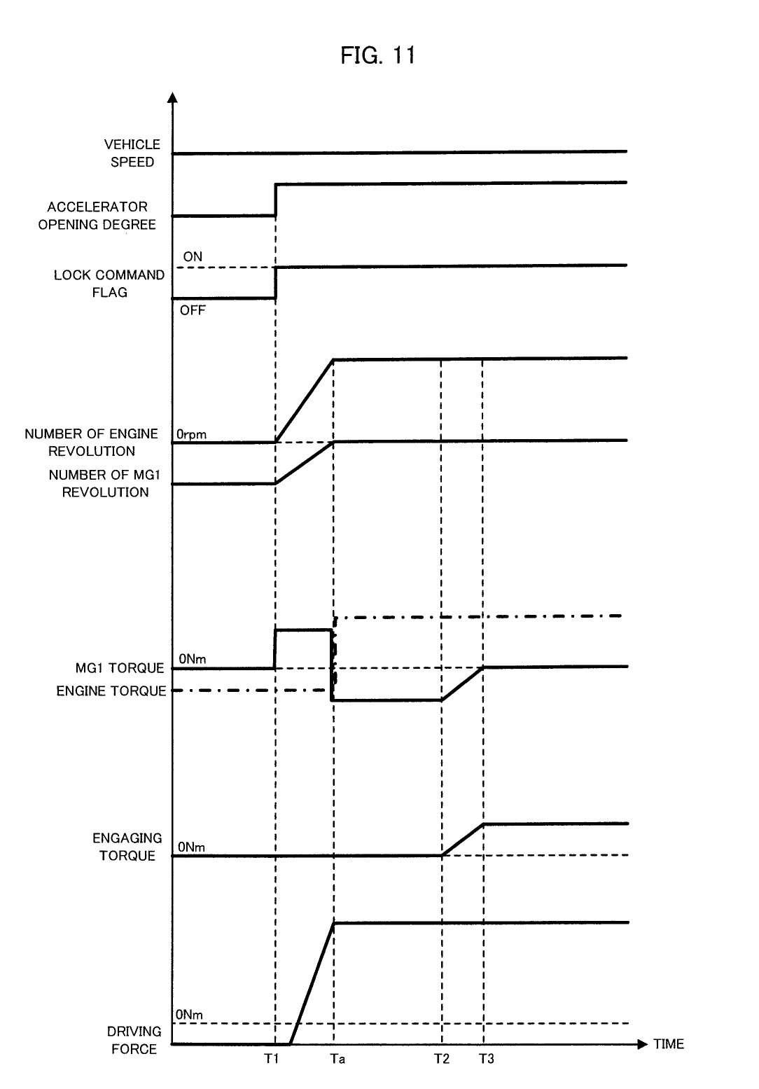

First, the description will be given of the speed change mode switching control method in the case that the accelerator opening degree increases and the vehicle operation point moves from the infinite variable speed mode area Ar3 to the first fixed speed change mode area Ar1 (the case shown by the arrow W1 in FIG. 9), with reference to FIGS. 10, 11.

FIG. 10A is a diagram showing the moving manner of the engine operation point in the case that the accelerator opening degree increases and the vehicle operation point moves from the infinite variable speed mode area Ar3 to the first fixed speed change mode area Ar1. The vertical axis shows the engine torque, and the horizontal axis shows the number of engine revolution. FIG. 10A also shows the CVT operation line Lc, the operation line Ls of the engine 1 in the fixed speed change mode and the maximum engine torque operation line Lcmax. FIG. 10B shows the changing manner of the alignment chart at this time.

In FIG. 10A, when the engine starts and the engine torque and the number of engine revolution increase, the engine operation point moves along the arrow from the point Pec to the point Pes on the operation line Ls. At this time, as shown in FIG. 10B, the alignment chart changes from the straight line Ac to the straight line As. Namely, in order to engage the clutch 7a of the lock mechanism 7, the first motor generator MG1 is controlled from the state of negative revolution to the state of the number of revolution “0”.

FIG. 11 shows the timing chart of the speed change mode switching control in the case that the engine operation point moves from the point Pec to the point Pes in FIG. 10A. In FIG. 11, the vertical axes shows the vehicle speed, the accelerator opening degree, the lock command flag, the number of engine revolution, the number of MG1 revolution, the MG1 torque, the engine torque, the engaging torque of the clutch 7a of the lock mechanism 7 and the driving force, in this order from the top, and the horizontal axis shows the time. In FIG. 11, in order to distinguish from the timing chart of the MG1 torque, the timing chart of the engine torque is shown by the dashed line.

The ECU 4 stores the relation of the vehicle speed and the accelerator opening degree with respect to the speed change mode, as shown in FIG. 9, in a memory or the like as the speed change mode determination map. When the ECU 4 determines that the vehicle operation point moves from the infinite variable speed mode area Ar3 to the first fixed speed change mode area Ar1, based on the accelerator opening degree by the speed change mode determination map, it changes the lock command flag from OFF to ON (time T1). When the ECU 4 confirms that the lock command flag becomes ON, it starts the speed change mode switching control.

When the ECU 4 confirms that the lock command flag becomes ON at time T1, it performs the cranking of the engine 1 by the first motor generator MG1. Since the cranking of the engine 1 is performed from time T1 to time Ta, the MG1 torque of positive torque is outputted by the first motor generator MG1. By this, from time T1 to time Ta, the number of MG1 revolution approaches “0” from the number of revolution of the negative revolution. When the number of MG1 revolution approaches “0” from the number of revolution of the negative revolution, the number of engine revolution increases as shown in FIG. 10B. At time Ta, the engine 1 is started by the cranking, and the engine 1 outputs the engine torque of the positive torque. Thus, the engine operation point moves from the point Pec to the point Pes in FIG. 10A, and the driving force increases.

When the engine 1 is started at time Ta, the first motor generator MG1 needs to output the reaction torque of the engine torque. Therefore, the MG1 torque of the negative torque is outputted by the first motor generator MG1. Since the ECU 4 determines this time that the vehicle operation point moves from the infinite variable speed mode area Ar3 to the first fixed speed change mode area Ar1, the reaction torque corresponding to the engine torque does not exceed the maximum rating torque TKmgx of the first motor generator MG1. Therefore, from time T1 to time T2, the ECU 4 makes the first motor generator MG1 output the reaction torque corresponding to the engine torque.

Thereafter, from time T2 to time T3, the ECU 4 increases the pushing pressure of the actuator 7b to increase the engaging torque of the clutch 7a, and decreases the MG1 torque. When the clutch 7a completely engages (time T3), the ECU 4 makes the MG1 torque “0” and ends the speed change mode switching control. By this, the shock at the time of engaging the clutch 7a can be prevented, and the load on the clutch 7a can be suppressed.

As described above, in the case that the accelerator opening degree increases and the vehicle operation point moves from the infinite variable speed mode area Ar3 to the first fixed speed change mode area Ar1, the ECU 4 controls the MG1 torque to be equal to the reaction torque corresponding to the engine torque, and switches the speed change mode from the infinite variable speed mode to the fixed speed change mode.

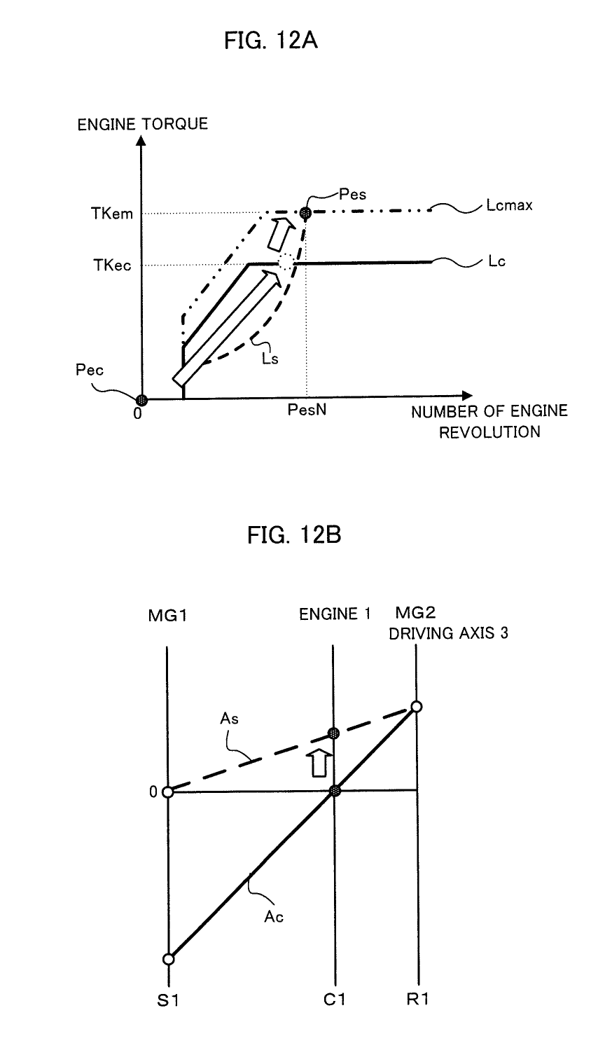

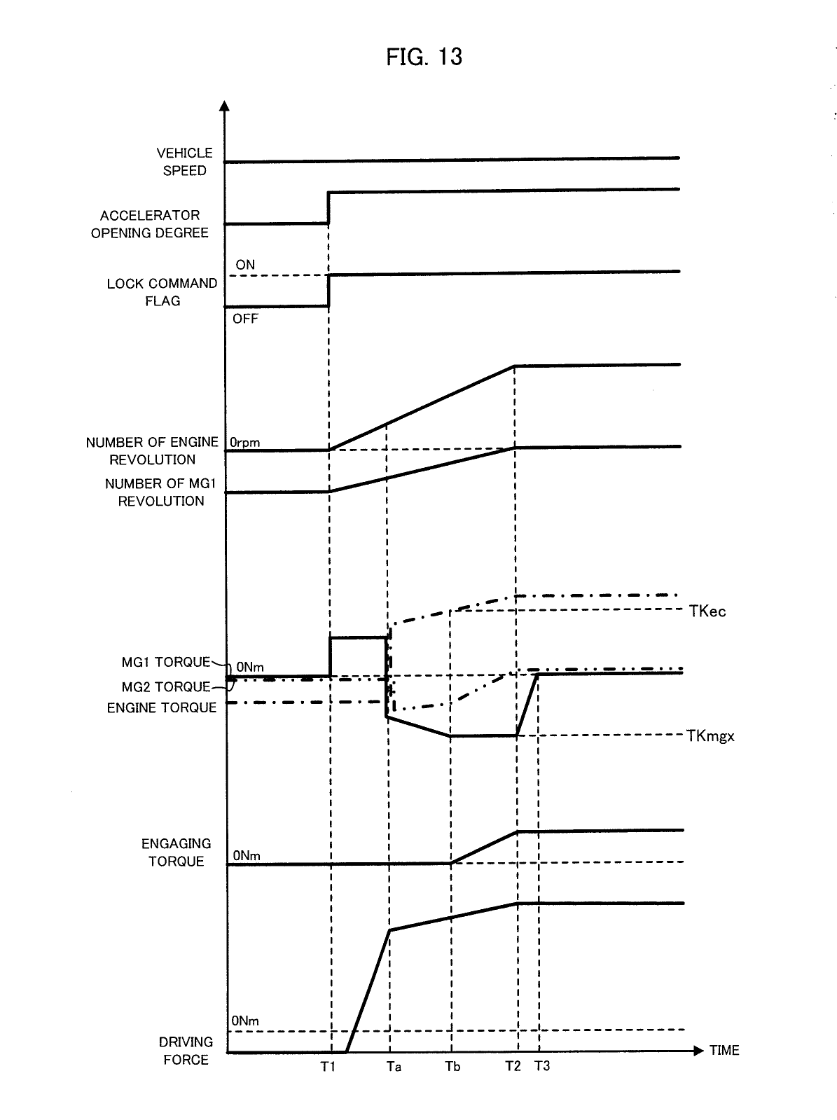

Next, the description will be given of the method of the speed change mode switching control, with reference to FIGS. 12, 13, in the case that the accelerator opening degree increases and the vehicle operation point moves from the infinite variable speed mode area Ar3 to the second fixed speed change mode area Ar2 (the case shown by the arrow W2 in FIG. 9). In this case, as shown in FIG. 9, the vehicle operation point moves from the infinite variable speed mode area Ar3 to the second fixed speed change mode area Ar2 via the first fixed speed change mode area Ar1.

FIG. 12A shows the moving manner of the engine operation point in the case that the accelerator opening degree increases and the vehicle operation point moves from the infinite variable speed mode area Ar3 to the second fixed speed change mode area Ar2. The vertical axis shows the engine torque, and the horizontal axis shows the number of engine revolution. FIG. 12A also shows the CVT operation line Lc, the operation line Ls of the engine 1 in the fixed speed change mode, and the maximum engine torque operation line Lcmax. FIG. 12B shows the changing manner of the alignment chart at that time.

In FIG. 12A, when the engine is started and the engine torque and the number of engine revolution increase, the engine operation point moves along the arrow from the point Pec to the point Pes on the operation line Ls. At this time, as shown in FIG. 12B, the alignment chart changes from the straight line Ac to the straight line As. Namely, in order to engage the clutch 7a of the lock mechanism 7, the first motor generator MG1 is controlled from the state of negative revolution to the number of revolution “0”, after starting the engine.

FIG. 13 shows the timing chart of the speed change mode switching control in the case that the engine operation point moves from the point Pec to the point Pes in FIG. 12A. In FIG. 13, the vertical axes show the vehicle speed, the accelerator opening degree, the lock command flag, the number of engine revolution, the number of MG1 revolution, the MG1 torque, the MG2 torque, the engine torque, the engaging torque of the clutch 7a of the lock mechanism 7, and the driving force, in this order from the top, and the horizontal axis shows the time. In FIG. 13, in order to distinguish from the timing chart of the MG1 torque, the timing chart of the engine torque is indicated by the dashed line, and the timing chart of the MG2 torque is indicated by the chain double-dashed line.

When the ECU 4 determines that the vehicle operation point moves from the infinite variable speed mode area Ar3 to the second fixed speed change mode area Ar2, based on the accelerator opening degree by the speed change mode determination map, it changes the lock command flag from OFF to ON (time T1). When the ECU 4 confirms that the lock command flag becomes ON, it starts the speed change mode switching control.

When the ECU 4 confirms that the lock command flag becomes ON at time T1, it performs the cranking of the engine 1 by the first motor generator MG1 from time T1 to time Ta. Since the cranking of the engine 1 is performed from time T1 to time Ta, the MG1 torque of positive torque is outputted by the first motor generator MG1. By this, from time T1 to time Ta, the number of MG1 revolution approaches “0” from the number of revolution of the negative revolution. At time Ta, the engine 1 is started by the cranking, and the engine 1 outputs the engine torque of the positive torque.

When the engine 1 is started at time Ta, the first motor generator MG1 needs to output the reaction torque of the engine torque. Therefore, the MG1 torque of negative torque is outputted by the first motor generator MG1. Then, from time Ta to time Tb, the engine torque further increases to exceed the reaction force upper limit engine torque TKec. Therefore, the reaction torque corresponding to the engine torque exceeds the maximum rating torque TKmgx of the first motor generator MG1 at time Tb. At this time, the ECU 4 holds the MG1 torque at the maximum rating torque TKmgx and gradually increases the pushing pressure of the actuator 7b, thereby to make the number of MG1 revolution “0” while gradually increasing the engaging torque of the clutch 7a of the lock mechanism 7. Namely, at this moment, the reaction torque corresponding to the engine torque is outputted by the first motor generator MG1 and the clutch 7a. When the number of MG1 revolution approaches “0” from the number of revolution of the negative revolution, the number of engine revolution increases as shown in FIG. 12B. Thus, the engine operation point moves from the point Pec to the point Pes in FIG. 12A, and the driving force increases. Similarly to the description in the first embodiment, also in the second embodiment, the blow-up of the engine can be prevented by making the clutch 7a receive the reaction torque corresponding to the engine torque when the vehicle operation point moves to the second fixed speed change mode area Ar2. In addition, by setting the MG1 torque to the maximum rating torque TKmgx, the load on the clutch 7a of the lock mechanism 7 can be reduced and the control can be simplified.

The ECU 4 increases the pushing pressure of the actuator 7b, and completely engages the clutch 7a at time T2 when the number of MG1 revolution becomes “0”. Thereafter, the ECU 4 makes the MG1 torque “0” and ends the speed change mode switching control at time T3.

Also in the example shown in FIG. 13, the ECU 4 performs the MG2 torque compensation control of correcting the MG2 torque such that the driving force becomes the requested driving force. Specifically, from time Tb to time T2, the ECU 4 performs the control to correct the MG2 torque, in accordance with the engaging torque, such that the reaction torque of the engaging torque is cancelled. Specifically, as the engaging torque increases, the ECU 4 decreases the MG2 torque. By this, the shock due to the engaging torque of the clutch 7a can be reduced.

As described above, in the case that the accelerator opening degree increases and the vehicle operation point moves from the infinite variable speed mode area Ar3 to the second fixed speed change mode area Ar2, when the reaction torque corresponding to the engine torque exceeds the maximum rating torque of the MG1 torque, the ECU 4 controls the MG1 torque to be equal to the maximum rating torque and controls the pushing pressure of the clutch 7a, thereby to switch the speed change mode from the infinite variable speed mode to the fixed speed change mode.

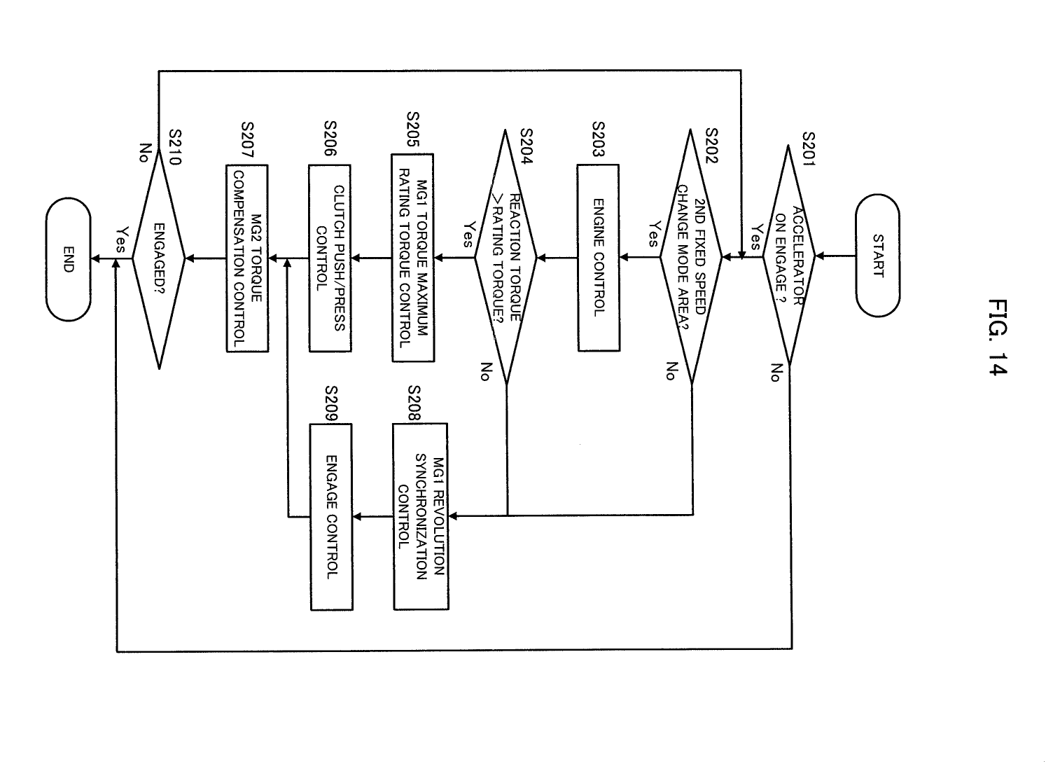

Next, the speed change mode switching process according to the second embodiment will be described with reference to the flow chart shown in FIG. 14. In the speed change mode switching process according to the second embodiment, based on the accelerator opening degree, the ECU 4 determines which one of the fixed speed change mode areas Ar1 and Ar2 the vehicle operation point moves from the infinite variable speed mode area Ar3, and performs the speed change mode switching control in accordance with the respective cases.

In step S201, the ECU 4 determines, based on the accelerator opening degree, whether or not the vehicle operation point moves to the fixed speed change mode area, i.e., whether or not the clutch 7a of the lock mechanism 7 should be engaged (accelerator-ON engagement). When the ECU 4 determines that the clutch 7a should not be engaged (step S201: No), it ends this control process. When the ECU 4 determines that the clutch 7a should be engaged (step S201: Yes), it goes to step S202. In step S202, the ECU 4 determines, by the speed change mode determination map, whether or not the vehicle operation point moves to the second fixed speed change mode area Ar2. When the ECU 4 determines that the vehicle operation point moves to the second fixed speed change mode area Ar2, it goes to step S203. When the ECU 4 determines that the vehicle operation point does not move to the second fixed speed change mode area Ar2, i.e., determines that the vehicle operation point moves to the first fixed speed change mode area Ar1, it goes to step S208.

In step S203, the ECU 4 increases the engine torque after starting the engine by cranking. In next step S204, the ECU 4 determines whether or not the reaction torque of the engine torque exceeds the maximum rating torque of the MG1 torque. When the ECU 4 determines that the reaction torque of the engine torque exceeds the maximum rating torque of the MG1 torque (step S204: Yes), it goes to step S205. When the ECU 4 determines that the reaction torque of the engine torque is equal to or smaller than the maximum rating torque of the MG1 torque (step S204: No), it goes to step S208.

In step S205, the ECU 4 sets the MG1 torque to the maximum rating torque. In step S206, the ECU 4 performs the clutch push/press control of gradually increasing the pushing pressure of the actuator 7b, and gradually increases the engaging torque of the clutch 7a. By this, the reaction torque corresponding to the engine torque is outputted by the first motor generator MG1 and the clutch 7a.

In step S207, the ECU 4 corrects the MG2 torque, in accordance with the engaging torque, to cancel the reaction torque of the engaging torque. Thereafter, the ECU 4 goes to step S210.

In step S210, the ECU 4 determines whether or not the engagement of the clutch 7a is completed. The ECU 4 returns to step S202 when it determines that the engagement of the clutch 7a is not completed, and ends this control process when it determines that the engagement of the clutch 7a is completed.

Meanwhile, when it is determined in the aforementioned step S202 that the vehicle operation point does not move to the second fixed speed change mode area Ar2 (step S202: No), or when it is determined in the aforementioned step S204 that the reaction torque of the engine torque is equal to or smaller than the maximum rating torque of the MG1 torque (step S204: No), the ECU 4 goes to step S208.

In step S208, the ECU 4 performs the number of MG1 revolution synchronization control of controlling the first motor generator MG1 to control the MG1 torque to be equal to the reaction torque corresponding to the engine torque and making the number of MG1 revolution gradually approach “0”. In next step S209, the ECU 4 performs the engagement control of engaging the clutch 7a. Thereafter, the ECU 4 goes to steps S207, S210, and ends this control process.

As is understood from the above description, in the second embodiment, in the case that the vehicle operation point moves from the infinite variable speed mode area Ar3 to the second fixed speed change mode area Ar2 due to the increase of the accelerator opening degree, the ECU 4 makes the first motor generator MG1 output the reaction torque corresponding to the engine torque until the reaction torque corresponding to the engine torque exceeds the maximum rating torque of the first motor generator MG1. Then, when the engine torque increases and the reaction torque corresponding to the engine torque exceeds the maximum rating torque of the first motor generator MG1, the ECU 4 makes the clutch 7a of the lock mechanism 7 receive a part of the reaction torque corresponding to the engine torque. In other words, in the second embodiment, the ECU 4 makes the first motor generator MG1 receive the reaction torque corresponding to the engine torque when the vehicle operation point moves in the first fixed speed change mode area Ar1. Then, when the vehicle operation point moves in the second fixed speed change mode area Ar2, the ECU 4 makes the first motor generator MG1 and the clutch 7a receive the reaction torque. By this, similarly to the first embodiment, the engine blow-up can be prevented at the time of switching the speed change mode.

### 3rd Embodiment

Next, the third embodiment of the present invention will be described.

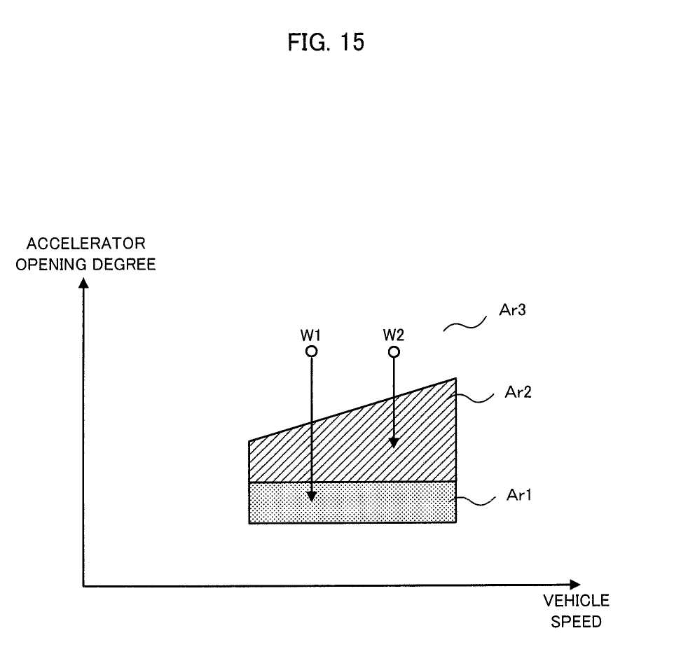

FIG. 15 is a diagram showing the moving manner of the vehicle operation point according to the third embodiment. The vertical axis shows the accelerator opening degree, and the horizontal axis shows the vehicle speed. FIG. 15 also shows the infinite variable speed mode area Ar3 and the fixed speed change mode areas Ar1, Ar2, and the vehicle operation point is indicated by the white dot. In the third embodiment, as shown by the arrows W1, W2 in FIG. 15, the description will be given of the speed change mode switching control method in the case that the accelerator opening degree decreases and the vehicle operation point moves from the infinite variable speed mode area Ar3 to the fixed speed change mode areas Ar1, Ar2.

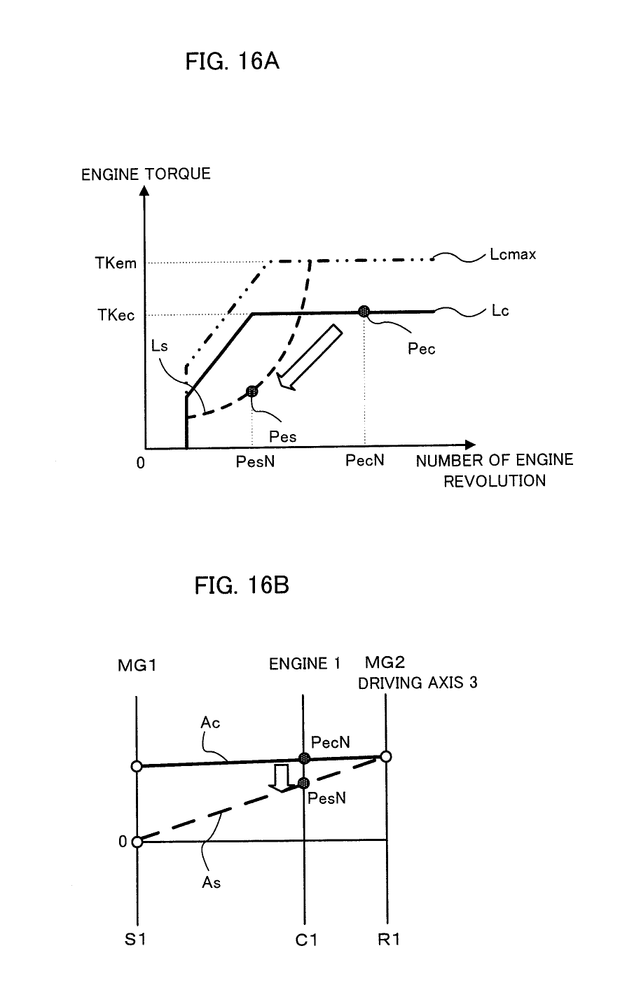

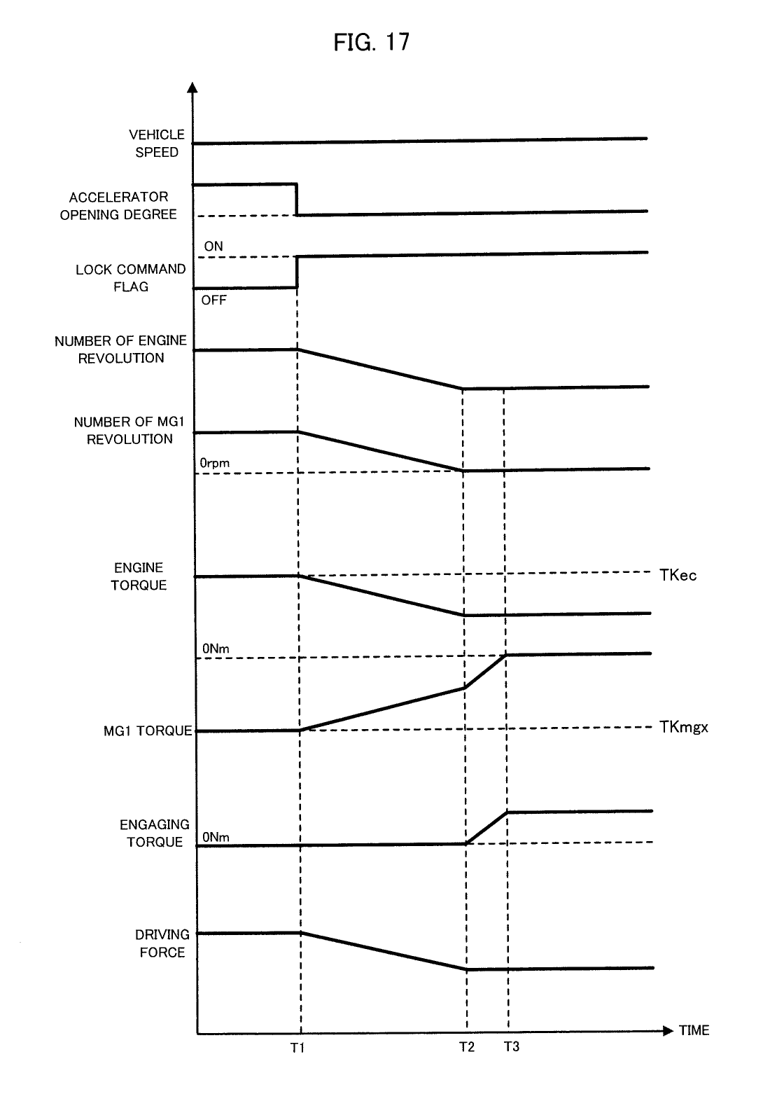

First, the description will be given of the speed change mode switching control method in the case that the accelerator opening degree decreases and the vehicle operation point moves from the infinite variable speed mode area Ar3 to the first fixed speed change mode area Ar1 (the case shown by the arrow W1 in FIG. 15), with reference to FIGS. 16, 17.

FIG. 16A is a diagram showing the moving manner of the engine operation point in the case that the accelerator opening degree decreases and the vehicle operation point moves from the infinite variable speed mode area Ar3 to the first fixed speed change mode area Ar1. The vertical axis shows the engine torque, and the horizontal axis shows the number of engine revolution. FIG. 16A also shows the CVT operation line Lc, the operation line of the engine 1 in the fixed speed change mode, and the maximum engine torque operation line Lcmax. FIG. 16B shows the changing manner of the alignment chart at this time.

In FIG. 16A, when the engine torque and the number of engine revolution decreases, the engine operation point moves along the arrow from the point Pec on the CVT operation line to the point Pes on the operation line Ls. At this time, as shown in FIG. 16B, the alignment chart changes from the straight line Ac to the straight line As. Namely, in order to engage the clutch 7a of the lock mechanism 7, the first motor generator MG1 is controlled from the state of positive revolution to the state of the number of revolution “0”.

FIG. 17 shows the timing chart of the speed change mode switching control in the case that the engine operation point moves from the point Pec to the point Pes in FIG. 16A. In FIG. 17, the vertical axes show the vehicle speed, the accelerator opening degree, the lock command flag, the number of engine revolution, the number of MG1 revolution, the engine torque, the MG1 torque, the engaging torque of the clutch 7a of the lock mechanism 7 and the driving force, in this order from the top, and the horizontal axis shows the time.

The ECU 4 stores the relation of the vehicle speed and the accelerator opening degree with respect to the speed change mode, as shown in FIG. 15, in a memory or the like as the speed change mode determination map. When the ECU 4 determines that the vehicle operation point moves from the infinite variable speed mode area Ar3 to the first fixed speed change mode area Ar1, based on the accelerator opening degree by the speed change mode determination map, the ECU 4 changes the lock command flag from OFF to ON (time T1). When the ECU 4 confirms that the lock command flag becomes ON, it starts the speed change mode switching control.

From time T1 to time T2, the ECU 4 performs the control of gradually decreasing the engine torque from the engine torque at the time T1. From time T1 to time T2, since the engine torque gradually decreases from the torque TKec, the reaction torque corresponding to the engine torque also gradually decreases. Accordingly, the reaction torque corresponding to the engine torque does not exceed the maximum rating torque TKmgx of the MG1 torque. From time T1 to time T2, the ECU 4 controls the first motor generator MG1 to gradually decrease the MG1 torque to be equal to the reaction torque corresponding to the engine torque, and makes the number of MG1 revolution to gradually approach “0”. When the number of MG1 revolution approaches “0” from the number of revolution of positive revolution, the number of engine revolution also gradually decreases as shown in FIG. 16B. In this way, the engine operation point moves from the point Pec to the point Pes in FIG. 16, and the driving force decreases.

When the number of MG1 revolution becomes “0” (time T2), the ECU 4 increases the pushing pressure of the actuator 7b. Then, at time T3, the ECU 4 completely engages the clutch 7a of the lock mechanism 7 and makes the number of MG1 revolution “0” to end the speed change mode switching control. Thus, the shock at the time of engaging the clutch 7a can be prevented, and the load on the clutch 7a can be suppressed.

As described above, in the case that the accelerator opening degree decreases and the vehicle operation point moves from the infinite variable speed mode area Ar3 to the first fixed speed change mode area Ar1, the ECU 4 controls the MG1 torque to be equal to the reaction torque corresponding to the engine torque, and switches the speed change mode from the infinite variable speed mode to the fixed speed change mode.

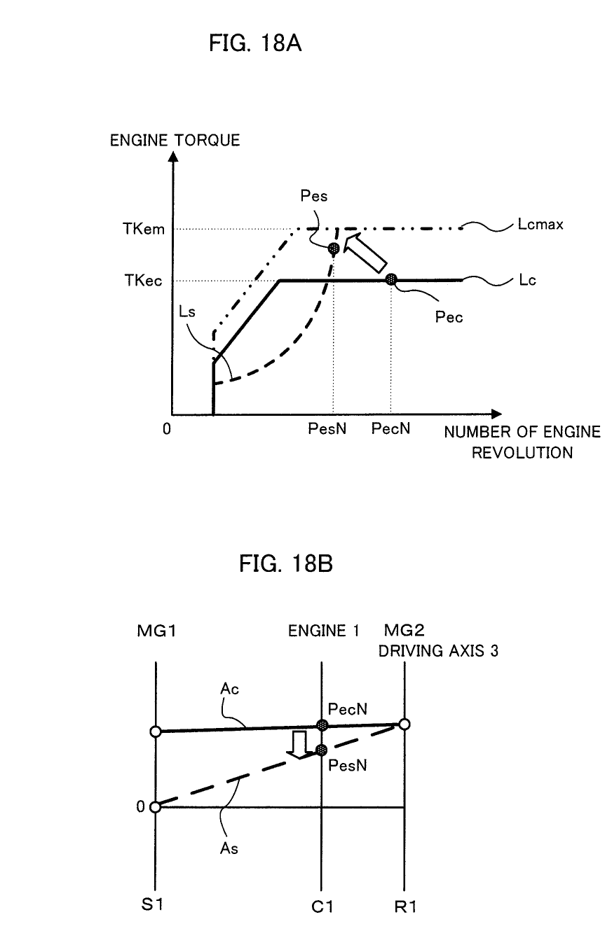

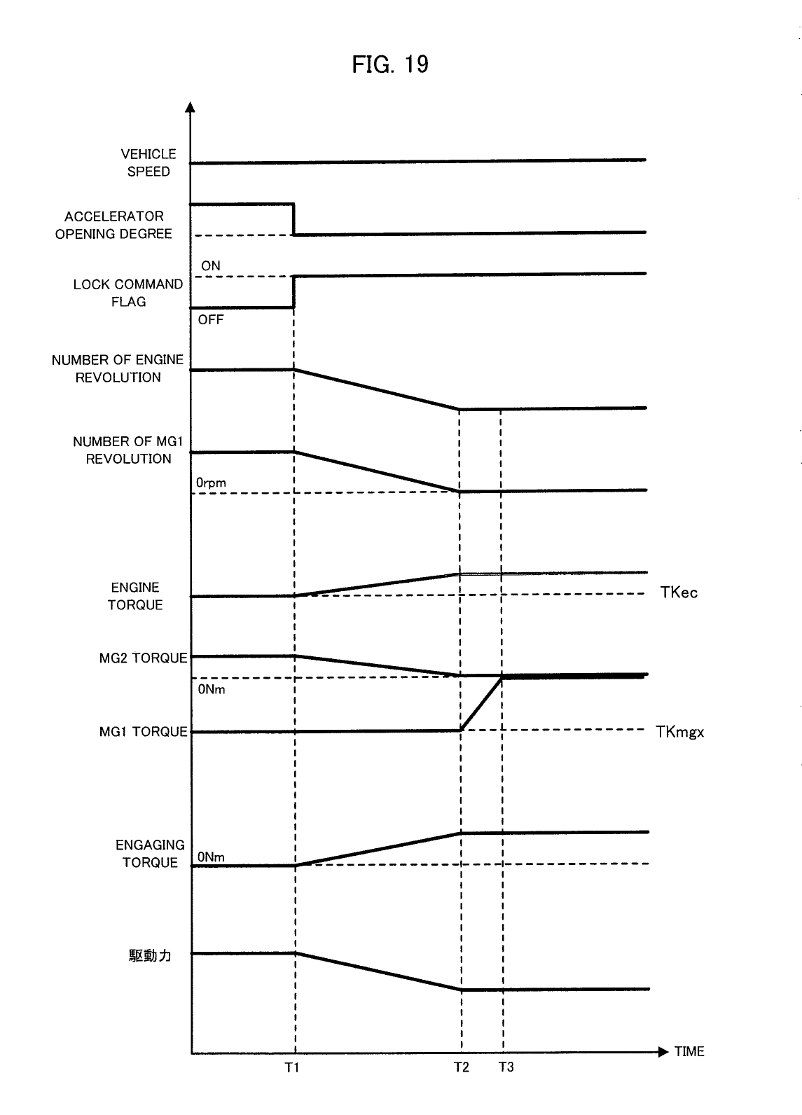

Next, the description will be given of the method of the speed change mode switching control, with reference to FIGS. 18, 19, in the case that the accelerator opening degree decreases and the vehicle operation point moves from the infinite variable speed mode area Ar3 to the second fixed speed change mode area Ar2 (the case shown by the arrow W2 in FIG. 15).

FIG. 18A shows the moving manner of the engine operation point in the case that the accelerator opening degree decreases and the vehicle operation point moves from the infinite variable speed mode area Ar3 to the second fixed speed change mode area Ar2. The vertical axis shows the engine torque, and the horizontal axis shows the number of engine revolution. FIG. 18A also shows the CVT operation line Lc, the operation line Ls of the engine 1 in the fixed speed change mode, and the maximum engine torque operation line Lcmax. FIG. 18B shows the changing manner of the alignment chart at that time.

In FIG. 18A, when the number of engine revolution decreases and the engine torque increases, the engine operation point moves along the arrow from the point Pec on the CVT operation line to the point Pes on the operation line Ls. At this time, as shown in FIG. 18B, the alignment chart changes from the straight line Ac to the straight line As. Namely, in order to engage the clutch 7a of the lock mechanism 7, the first motor generator MG1 is controlled from the state of positive revolution to the state of the number of revolution “0”.

FIG. 19 shows the timing chart of the speed change mode switching control in the case that the engine operation point moves from the point Pec to the point Pes in FIG. 18A. In FIG. 19, the vertical axes show the vehicle speed, the accelerator opening degree, the lock command flag, the number of engine revolution, the number of MG1 revolution, the engine torque, the MG2 torque, the MG1 torque, the engaging torque of the clutch 7a of the lock mechanism 7, and the driving force, in this order from the top, and the horizontal axis shows the time.

When the ECU 4 determines that the vehicle operation point moves from the infinite variable speed mode area Ar3 to the second fixed speed change mode area Ar2, based on the accelerator opening degree by the speed change mode determination map, the ECU 4 changes the lock command flag from OFF to ON (time T1). When the ECU 4 confirms that the lock command flag becomes ON, it starts the speed change mode switching control.

From time T1 to time T2, the ECU 4 performs the control of gradually increases the engine torque from the engine torque at the time T1. As shown in FIG. 18A, if the engine torque increases in the state that the engine operation point locates at the point Pec, the engine torque exceeds the reaction force upper limit engine torque TKmgx, i.e., the reaction torque corresponding to the engine torque exceeds the maximum rating torque TKmgx of the MG1 torque.

Therefore, from time T1 to time T2, the ECU 4 sets the MG1 torque to the maximum rating torque TKmgx, and gradually increases the pushing pressure of the actuator 7b to make the number of MG1 revolution approach “0”. By this, the reaction torque corresponding to the engine torque is outputted by the first motor generator MG1 and the clutch 7a, and the engine blow-up can be prevented. When the number of MG1 revolution approached “0” from the number of revolution at the time of positive revolution, the number of engine revolution also gradually decreases as shown in FIG. 18B. In this way, the engine operation point moves from the point Pec to the point Pes in FIG. 18A, and the driving force decreases. By setting the MG1 torque to the maximum rating torque TKmgx from time T1 to time T2, the load on the clutch 7a of the lock mechanism 7 can be reduced and the control can be simplified.

In the example shown in FIG. 19, from time T1 to time T2, the ECU 4 performs the control of correcting the MG2 torque to cancel the reaction torque of the engaging torque, as the MG2 torque compensation control of compensating the MG2 torque such that the driving force becomes equal to the requested driving force. Specifically, the ECU 4 performs the control of decreasing the MG12 torque according to the increase of the engaging torque.

The ECU 4 completely engages the clutch 7a at time T2 when the number of MG1 revolution becomes “0”, and then makes the MG1 torque “0” to end the speed change mode switching control at time T3.

As described above, in the case that the accelerator opening degree decreases and the vehicle operation point moves from the infinite variable speed mode area Ar3 to the second fixed speed change mode area Ar2, the ECU 4 controls the MG1 torque to be equal to the maximum rating torque and controls the pushing pressure of the clutch 7a, thereby to switch the speed change mode from the infinite variable speed mode to the fixed speed change mode.

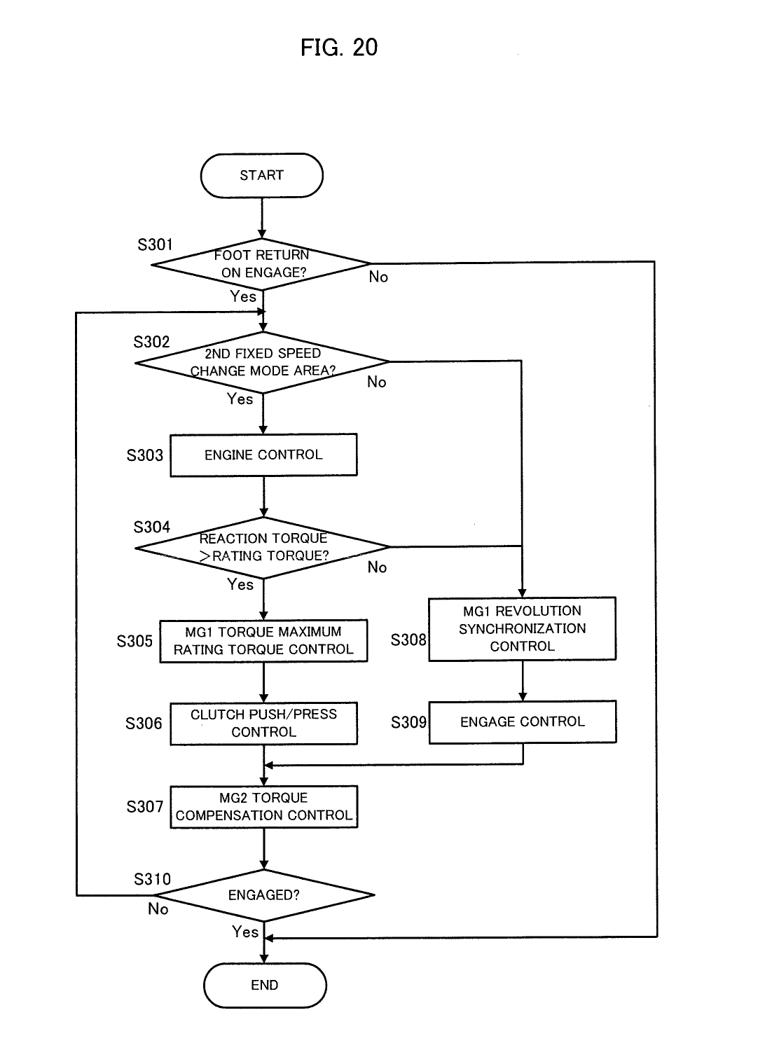

Next, the speed change mode switching process according to the second embodiment will be described with reference to the flow chart shown in FIG. 20. In the speed change mode switching process according to the third embodiment, based on the accelerator opening degree, the ECU 4 determines which one of the fixed speed change mode areas Ar1 and Ar2 the vehicle operation point moves from the infinite variable speed mode area Ar3, and performs the speed change mode switching control in accordance with the respective cases.

In step S301, the ECU 4 determines, based on the accelerator opening degree, whether or not the vehicle operation point moved to the fixed speed change mode area, i.e., whether or not the clutch 7a of the lock mechanism 7 should be engaged (foot return-ON engagement). When the ECU 4 determines that the clutch 7a should not be engaged (step S301: No), it ends this control process. When the ECU 4 determines that the clutch 7a should be engaged (step S301: Yes), it goes to step S302.

In step S302, the ECU 4 determines, by the speed change mode determination map, whether or not the vehicle operation point moves to the second fixed speed change mode area Ar2. When the ECU 4 determines that the vehicle operation point moves to the second fixed speed change mode area Ar2 (step S302: Yes), it goes to step S303. When the ECU 4 determines that the vehicle operation point does not move to the second fixed speed change mode area Ar2, i.e., determines that the vehicle operation point moves to the first fixed speed change mode area Ar1 (step S302: No), it goes to step S308.

In step S303, the ECU 4 increases the engine torque. In next step S304, the ECU 4 determines whether or not the reaction torque of the engine torque exceeds the maximum rating torque of the MG1 torque. When the ECU 4 determines that the reaction torque of the engine torque exceeds the maximum rating torque of the MG1 torque (step S304: Yes), it goes to step S305. When the ECU 4 determines that the reaction torque of the engine torque is equal to or smaller than the maximum rating torque of the MG1 torque (step S304: No), it goes to step S308.

In step S305, the ECU 4 sets the MG1 torque to the maximum rating torque. In step S306, the ECU 4 performs the clutch push/press control of gradually increasing the pushing pressure of the actuator 7b, and gradually increases the engaging torque of the clutch 7a. By this, the reaction torque corresponding to the engine torque is outputted by the first motor generator MG1 and the clutch 7a.

In step S307, the ECU 4 corrects the MG2 torque, in accordance with the engaging torque, to cancel the reaction torque of the engaging torque. In next step S310, the ECU 4 determines whether or not the engagement of the clutch 7a is completed. The ECU 4 returns to step S302 when it determines that the engagement of the clutch 7a is not completed, and ends this control process when it determines that the engagement of the clutch 7a is completed.

Meanwhile, when it is determined in the aforementioned step S302 that the vehicle operation point does not move to the second fixed speed change mode area Ar2 (step S302: No), or when it is determined in the aforementioned step S304 that the reaction torque of the engine torque is equal to or smaller than the maximum rating torque of the MG1 torque (step S304: No), the ECU 4 goes to step S308.

In step S308, the ECU 4 performs the number of MG1 revolution synchronization control of controlling the first motor generator MG1 to control the MG1 torque to be equal to the reaction torque corresponding to the engine torque, and making the number of MG1 revolution gradually approach “0”. In next step S309, the ECU 4 performs the engagement control of engaging the clutch 7a. Thereafter, the ECU 4 goes to steps S307, S310, and ends this control process.

As is understood from the above description, in the third embodiment, in the case that the vehicle operation point moves from the infinite variable speed mode area Ar3 to the second fixed speed change mode area Ar2 due to the decrease of the accelerator opening degree, the ECU 4 makes the clutch 7a of the lock mechanism 7 to receive a part of the reaction torque corresponding to the engine torque. By this, similarly to the first and the second embodiments, the engine blow-up can be prevented at the time of switching the speed change mode.

### 4th Embodiment

Next, the fourth embodiment of the present invention will be described.

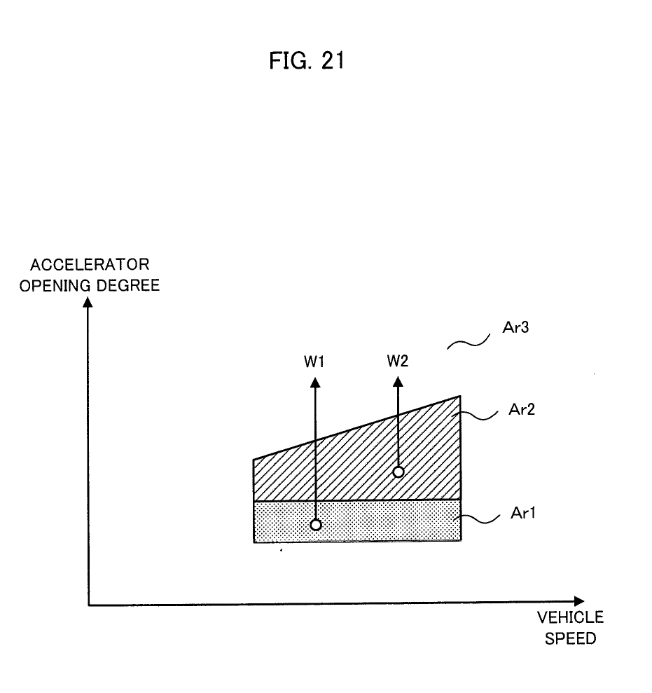

FIG. 21 is a diagram showing the moving manner of the vehicle operation point according to the fourth embodiment. The vertical axis shows the accelerator opening degree, and the horizontal axis shows the vehicle speed. FIG. 21 also shows the infinite variable speed mode area Ar3 and the fixed speed change mode areas Ar1, Ar2, and the vehicle operation point is indicated by the white dot. In the fourth embodiment, as shown by the arrows W1, W2 in FIG. 21, the description will be given of the speed change mode switching control method in the case that the accelerator opening degree increases and the vehicle operation point moves from each of the fixed speed change mode areas Ar1, Ar2 to the infinite variable speed mode area Ar3.

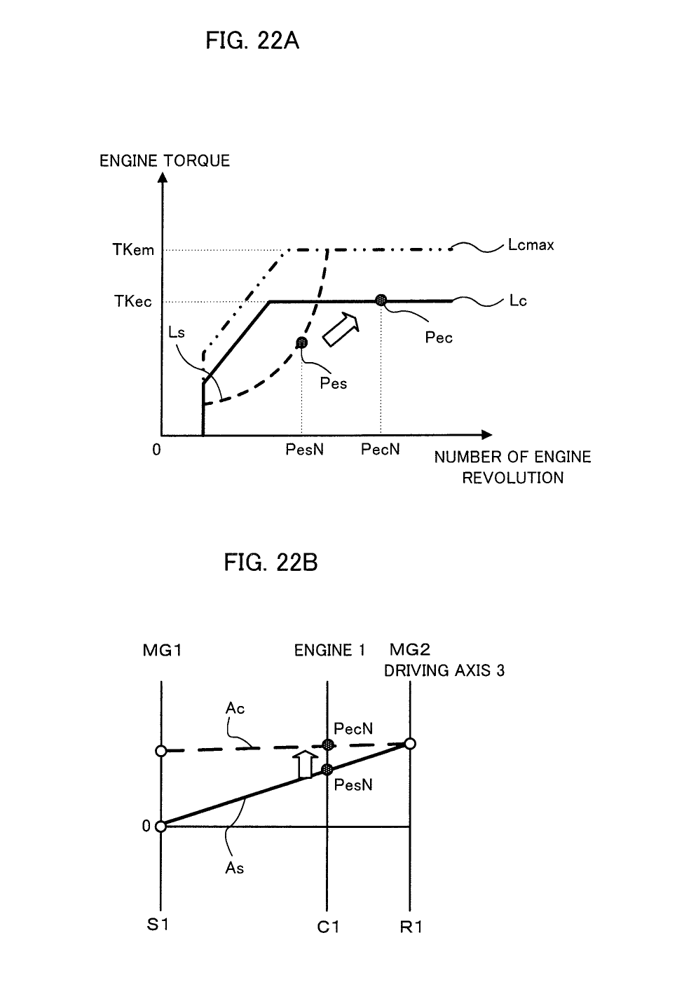

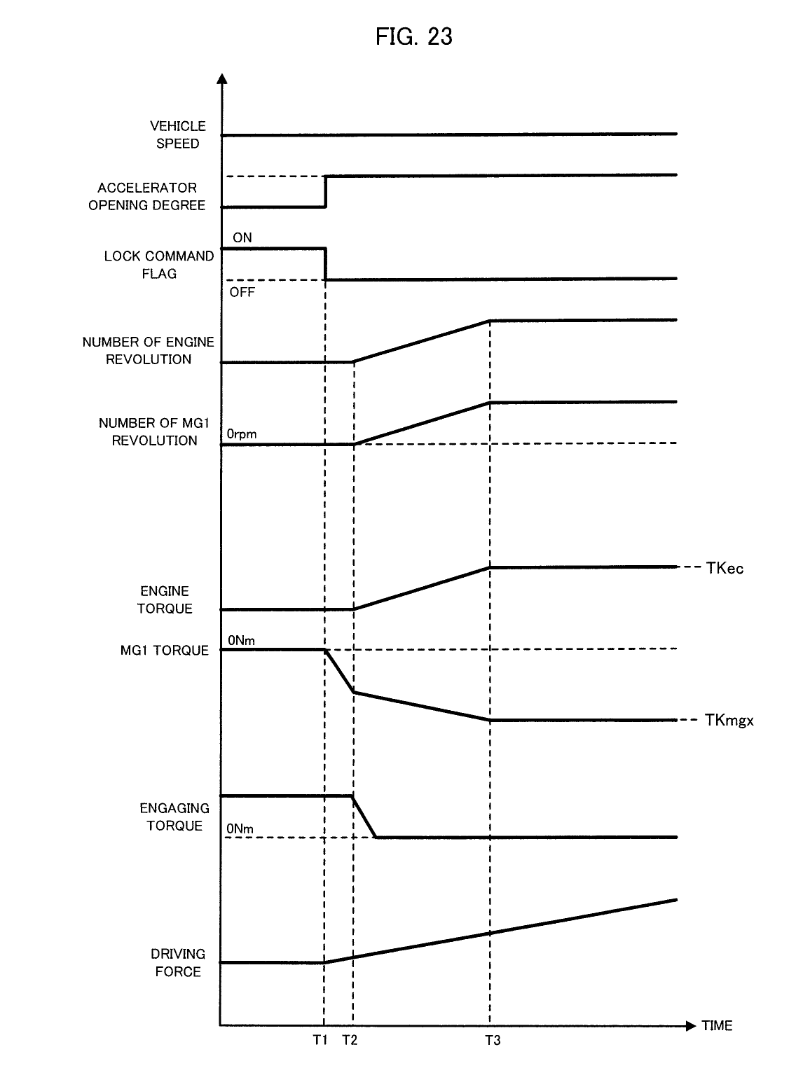

First, the description will be given of the speed change mode switching control method in the case that the accelerator opening degree increases and the vehicle operation point moves from the first fixed speed change mode area Ar1 to the infinite variable speed mode area Ar3 (the case shown by the arrow W1 in FIG. 21), with reference to FIGS. 22, 23.

FIG. 22A is a diagram showing the moving manner of the engine operation point in the case that the accelerator opening degree increases and the vehicle operation point moves from the first fixed speed change mode area At1 to the infinite variable speed mode area Ar3. The vertical axis shows the engine torque, and the horizontal axis shows the number of engine revolution. FIG. 22A also shows the CVT operation line Lc, the operation line Ls of the engine 1 in the fixed speed change mode, and the maximum engine torque operation line Lcmax. FIG. 22B shows the changing manner of the alignment chart at this time.

In FIG. 22A, the number of engine revolution and the engine torque increase, and the engine operation point moves along the arrow from the point Pes on the operation ling Ls to the point Pec on the CVT operation line. At this time, as shown in FIG. 22B, the alignment chart changes from the straight line As to the straight line Ac. Namely, due to the increase of the accelerator opening degree, the clutch 7a of the lock mechanism 7 is released, and the first motor generator MG1 is controlled to positively revolve from the state of the number of revolution “0”.

FIG. 23 shows the timing chart of the speed change mode switching control in the case that the engine operation point moves from the point Pes to the point Pec in FIG. 22A. In FIG. 23, the vertical axes show the vehicle speed, the accelerator opening degree, the lock command flag, the number of engine revolution, the number of MG1 revolution, the engine torque, the MG1 torque, the engaging torque of the clutch 7a of the lock mechanism 7 and the driving force, in this order from the top, and the horizontal axis shows the time.

When the ECU 4 determines that the vehicle operation point moves from the first fixed speed change mode area Ar1 to the infinite variable speed mode area Ar3 based on the accelerator opening degree by the speed change determination map, it changes the lock command flag from ON to OFF (time T1). When the ECU 4 confirms that the lock command flag becomes OFF, it starts the speed change mode switching control.

From time T1 to time T2, the ECU 4 keeps the clutch 7a in the engaged state, and quickly increases the MG1 torque. At time T2, when the MG1 torque becomes equal to the reaction torque corresponding to the engine torque, the ECU 4 completely releases the clutch 7a. By this, the blow-up of the engine and the first motor generator MG1 can be prevented. In addition, by doing this, the time required to complete the release of the clutch 7a can be shortened, and the drivability can be improved. After time T2, the ECU 4 increases the engine torque, and increases the number of MG1 revolution from “0” in the positive revolution direction while controlling the first motor generator MG1 to control the MG1 torque to be equal to the reaction torque corresponding to the engine torque. When the number of MG1 revolution increases from “0” in the positive revolution direction, the number of engine revolution also increases as shown in FIG. 22B. Thus, the engine operation point moves from the point Pes to the point Pec in FIG. 22, and the driving force increases.

As described above, in the case that the accelerator opening degree increases and the vehicle operation point moves from the first fixed speed change mode area Ar1 to the infinite variable speed mode area Ar3, the ECU 4 performs the control of releasing the clutch 7a after controlling the MG1 torque to be equal to the reaction torque corresponding to the engine torque, thereby switching the speed change mode from the fixed speed change mode to the infinite variable speed mode.

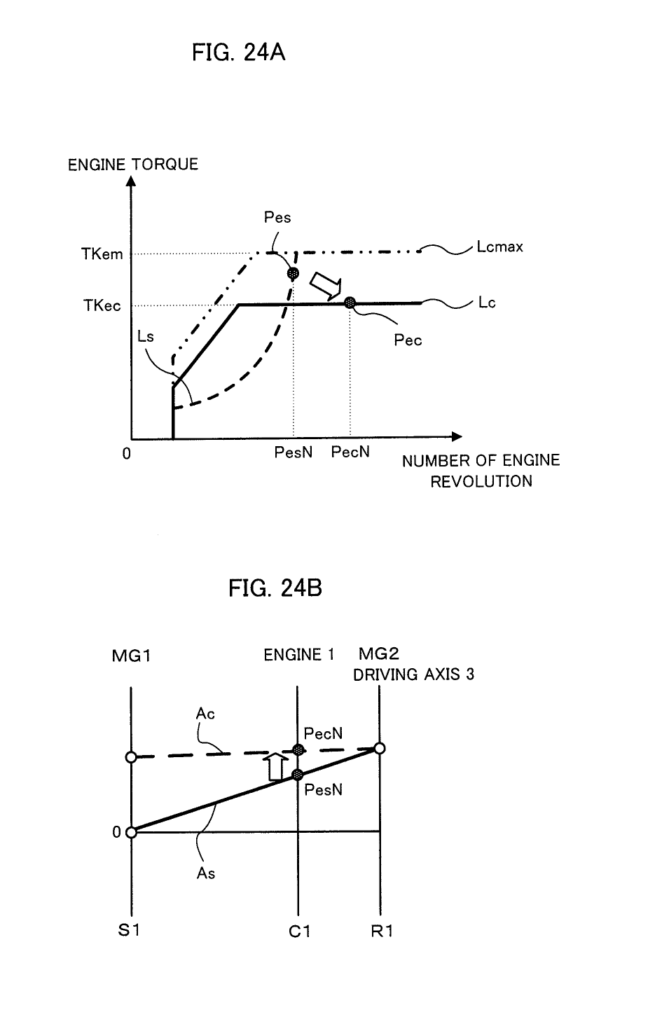

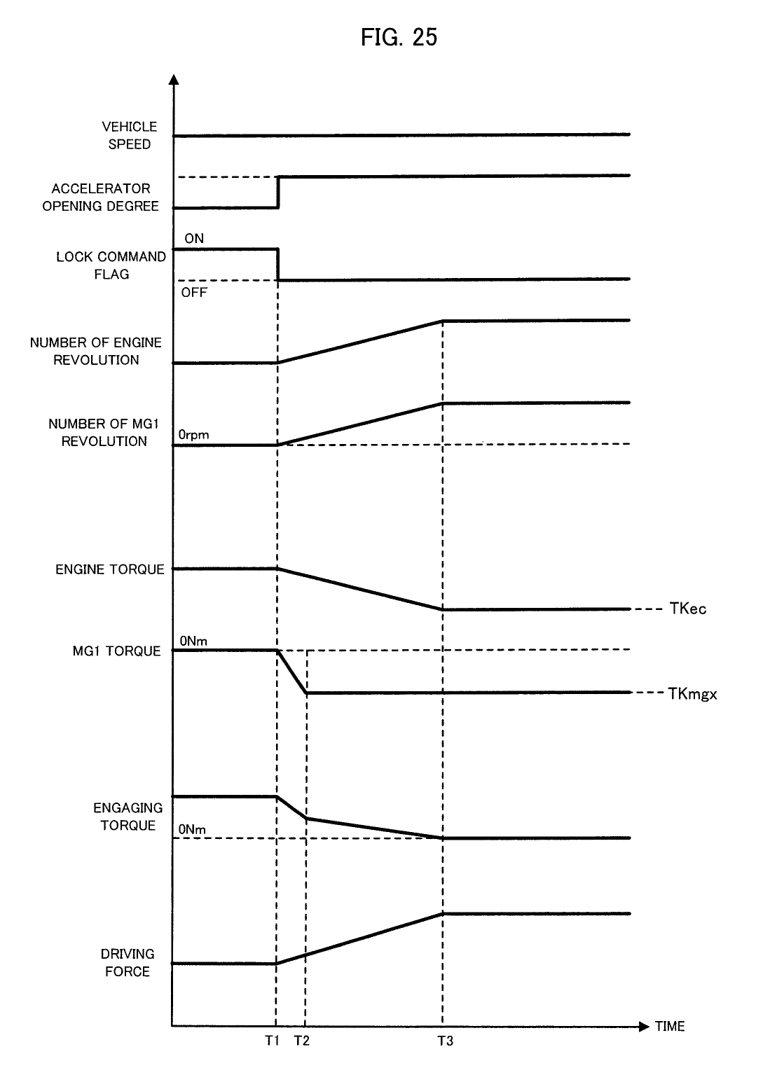

Next, the description will be given of the method of the speed change mode switching control, with reference to FIGS. 24, 25, in the case that the accelerator opening degree increases and the vehicle operation point moves from the second fixed speed change mode area Ar2 to the infinite variable speed mode area Ar3 (the case shown by the arrow W2 in FIG. 21).

FIG. 24A shows the moving manner of the engine operation point in the case that the vehicle operation point moves from the second fixed speed change mode area Ar2 to the infinite variable speed mode area Ar3. The vertical axis shows the engine torque, and the horizontal axis shows the number of engine revolution. FIG. 24A also shows the CVT operation line Lc, the operation line Ls of the engine 1 in the fixed speed change mode, and the maximum engine torque operation line Lcmax. FIG. 24B shows the changing manner of the alignment chart at that time.

In FIG. 24A, when the engine torque decreases and the number of engine revolution increase, the engine operation point moves along the arrow from the point Pes on the operation line Ls to the point Pec on the CVT operation line Lc. At this time, as shown in FIG. 22B, the alignment chart changes from the straight line As to the straight line Ac. Namely, due to the increase of the accelerator opening degree, the clutch 7a of the lock mechanism 7 is released, and the first motor generator MG1 is controlled to positively revolve from the state of the number of revolution “0”.

FIG. 25 shows the timing chart of the speed change mode switching control in the case that the engine operation point moves from the point Pes to the point Pec in FIG. 24A. In FIG. 25, the vertical axes show the vehicle speed, the accelerator opening degree, the lock command flag, the number of engine revolution, the number of MG1 revolution, the engine torque, the MG1 torque, the engaging torque of the clutch 7a of the lock mechanism 7 and the driving force, in this order from the top, and the horizontal axis shows the time.

When the ECU 4 determines that the vehicle operation point moves from the second fixed speed change mode area Ar2 to the infinite variable speed mode area Ar3, based on the accelerator opening degree by the speed change mode determination map, it changes the lock command flag from ON to OFF (time T1). When the ECU 4 confirms that the lock command flag becomes OFF, it starts the speed change mode switching control.

From time T1 to time T3, the ECU 4 performs the control of gradually decreasing the engine torque from the engine torque at the time T1. From time T1 to time T2, the ECU 4 increases the MG1 torque to be the maximum rating torque TKmgx, and decreases the engaging torque in accordance with the increase of the MG1 torque. Then, from time T2 to time T3, the ECU 4 keeps the MG1 torque to be the maximum rating torque TKmgx, and further decreases the engaging torque in accordance with the decrease of the engine torque. Namely, from time T1 to time T3, the reaction force corresponding to the engine torque is received by the first motor generator MG1 and the clutch 7a. From time T2 to T3, the ECU 4 controls the pushing pressure of the actuator 7b to decrease the engaging torque and increase the number of MG1 revolution in the position revolution direction. When the number of MG1 revolution increases in the positive revolution direction, the number of engine revolution also increases as shown in FIG. 24B. By this, the engine operation point moves from the point Pes to the point Pec in FIG. 24, and the driving force increases. In this way, by receiving the reaction torque corresponding to the engine torque by the first motor generator MG1 and the clutch 7a, the driving force can be increased.

At time T3, the engine torque decreases, and the reaction torque corresponding to the engine torque becomes equal to the maximum rating torque of the MG1 torque. Namely, at time T3, the first motor generator MG1 becomes able to receive the reaction torque corresponding to the engine torque by itself. Accordingly, at this time, the ECU 4 controls the engaging torque to be “0”, i.e., completely releases the clutch 7a. By this, the blow-up of the engine and the first motor generator MG1 can be prevented. Further, by this, the required time until the completion of the releasing the clutch 7a can be shortened, and the drivability can be improved. Here, from time T1 to time T3, the ECU 4 may correct the MG2 torque in accordance with the engaging torque such that the driving force becomes equal to the requested driving force. By this, the driving force can be increased responsively with respect to the accelerator opening degree, and the drivability can be improved.

As described above, in the case that the accelerator opening degree increases and the vehicle operation point moves from the second fixed speed change mode area Ar2 to the infinite variable speed area Ar3, the ECU 4 performs the control of making the MG1 torque to be equal to the maximum rating torque and controls the pushing pressure of the clutch 7a when the reaction torque corresponding to the engine torque is larger than the maximum rating torque of the MG1 torque. Then, when the reaction torque corresponding to the engine torque becomes equal to the maximum rating torque TKmgx, the ECU 4 switches the speed change mode from the fixed speed change mode to the infinite variable speed mode by performing the control of releasing the clutch 7a.

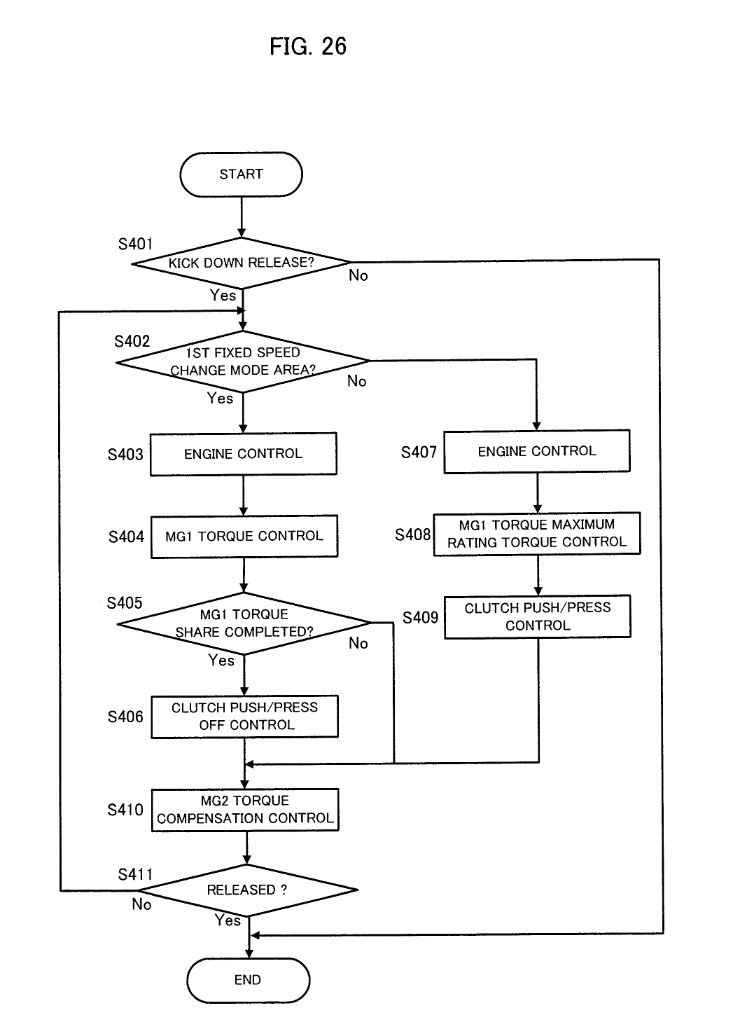

Next, the speed change mode switching process according to the fourth embodiment will be described with reference to the flow chart shown in FIG. 26. In the speed change mode switching process according to the fourth embodiment, based on the accelerator opening degree, the ECU 4 determines from which one of the fixed speed change mode areas Ar1 and Ar2 the vehicle operation point moves to the infinite variable speed mode area Ar3, and performs the speed change mode switching control in accordance with the respective cases.

In step S401, the ECU 4 determines, based on the accelerator opening degree, whether or not the clutch 7a of the lock mechanism 7 should be released. The ECU 4 ends this control process when it determines based on the accelerator opening degree that the clutch 7a should not be released (step S401: No), and goes to step S402 when it determines that the clutch 7a should be released (step S402: Yes).

In step S402, the ECU 4 determines, based on the speed change mode determination map, whether or not the vehicle operation point locates in the first fixed speed change mode area Ar1. The ECU 4 goes to step S403 when it determines that the vehicle operation point locates in the first fixed speed change mode area Ar1 (step S402: Yes), and goes to step S407 when it determines that the vehicle operation point does not locate in the first fixed speed change mode Ar1, i.e., the vehicle operation point locates in the second fixed speed change mode area Ar2 (step S402: No).

In step S403, the ECU 4 performs the engine control to increase the engine torque. In next step S404, the ECU 4 controls the MG1 torque to be equal to the reaction torque corresponding to the engine torque.

In step S405, the ECU 4 determines whether or not the MG1 torque reaches the reaction torque corresponding to the engine torque. The ECU 4 goes to step S406 when it determines that the MG1 torque reaches the reaction torque corresponding to the engine torque (step S405: Yes), and goes to step S411 when it determines that the MG1 torque does not reach the reaction torque corresponding to the engine torque (step S405: No). In step S406, the ECU 4 performs the clutch push/press OFF control of completely releasing the clutch 7a, and then goes to step S410.

In step S410, the ECU 4 performs the MG2 torque compensation control of correcting the MG2 torque such that the driving force becomes equal to the requested driving force. In next step S411, the ECU 4 determines whether or not the clutch 7a is released. The ECU 4 goes to step S402 when it determines that the clutch 7a is released, and ends this control process when it determines that the clutch 7a is not released.

On the other hand, when it is determined in the aforementioned step S402 that the vehicle operation point does not locate in the first fixed speed change mode area Ar1 (step S402: No), i.e., when it is determined that the vehicle operation point locates in the second fixed speed change mode area, the ECU 4 goes to step S407. The ECU 4 performs the engine control of decreasing the engine torque in step S407, and then goes to step S408.

The ECU 4 increases the MG1 torque to be equal to the maximum rating torque in step S408, and decreases the pushing pressure of the actuator 7b in accordance with the decrease of the engine torque to decrease the engaging torque in step S409. In this way, the reaction torque corresponding to the engine torque is outputted by the first motor generator and the clutch 7a. Thereafter, the ECU 4 goes to steps S410, S411, and ends this control process.

As is understood from the above description, in the fourth embodiment, in the case that the vehicle operation point moves from the first fixed speed change mode area Ar1 to the infinite variable speed mode area Ar3 by the increase of the accelerator opening degree, the ECU 4 promptly increases the MG1 torque to be equal to the reaction torque corresponding to the engine torque while keeping the clutch 7a in the engaged state. By this, the time required to complete the release of the clutch 7a can be shortened, and the drivability can be improved. In addition, in the case that the vehicle operation point moves from the second fixed speed change mode area Ar2 to the infinite variable speed mode area Ar3 by the increase of the accelerator opening degree, the ECU 4 makes the first motor generator MG1 and the clutch 7a receive the reaction torque corresponding to the engine torque until the reaction torque becomes equal to the maximum rating torque of the MG1 torque. Thus, the driving force can be increased.

### 5th Embodiment

Next, the fifth embodiment of the present invention will be described. In the first to fourth embodiments, when the reaction torque corresponding to the engine torque exceeds the maximum rating torque of the first motor generator MG1 at the time of switching the speed change mode, a part of the reaction torque corresponding to the engine torque is outputted by the clutch 7a. Specifically, the clutch 7a is a clutch configured to be able to perform differential revolution such as a wet type multiple plate clutch, and the ECU 4 outputs a part of the reaction torque corresponding to the engine torque by adjusting the engaging torque generated on the clutch 7a. However, if a clutch such as a dog clutch and a one-way clutch which is difficult to perform the differential revolution is used as the clutch 7a, it can take only one of the completely engaged state or the completely released state, and the engaging torque cannot be continuously changed. Therefore, in this case, the method described in the first to fourth embodiments cannot be used.

Therefore, in the fifth embodiment, in the case that the reaction torque corresponding to the engine torque exceeds the maximum rating torque of the first motor generator MG1 at the time of switching the speed change mode from the infinite variable speed mode to the fixed speed change mode, the ECU 4 controls the first motor generator MG1 to be able to temporarily output the MG1 torque larger than the maximum rating torque of the first motor generator MG1.

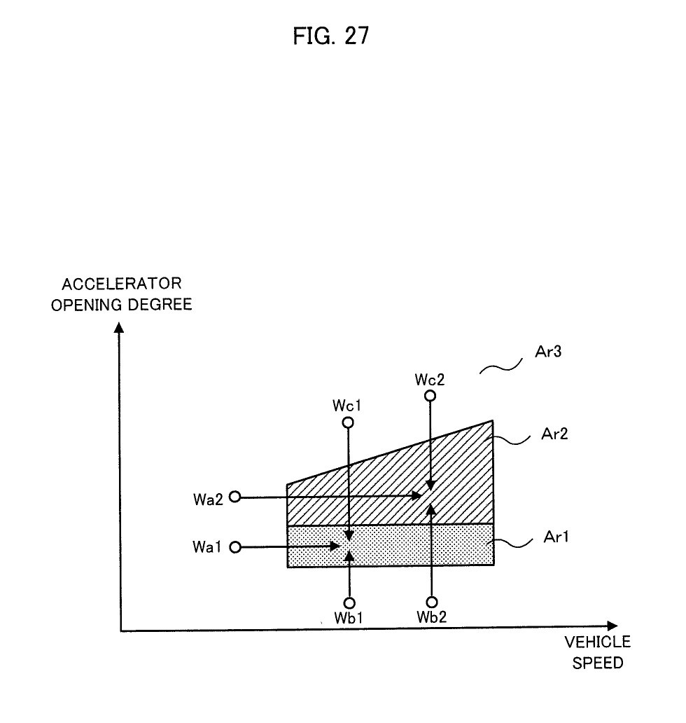

FIG. 27 shows the moving manner of the vehicle operation point in the fifth embodiment. The vertical axis shows the accelerator opening degree, and the horizontal axis shows the vehicle speed. FIG. 27 shows the infinite variable speed mode area Ar3, and the fixed speed change mode areas Ar1, Ar2. As shown in FIG. 27, in the fifth embodiment, the description will be given of the switching control method of the speed change mode in the case that the vehicle operation point moves from the infinite variable speed mode area Ar3 to the fixed speed change mode areas Ar1, Ar2, respectively shown in the case that the vehicle speed increases (the arrows Wa1, Wa2), that the accelerator opening degree increases (the arrows Wb1, Wb2) and that the accelerator opening degree decreases (the arrows Wc1, Wc2). In the following, as an example, the description will be given of the case in which the vehicle speed increases and the vehicle operation point moves from the infinite variable speed mode area Ar3 to the fixed speed change mode areas Ar1, Ar2, respectively.

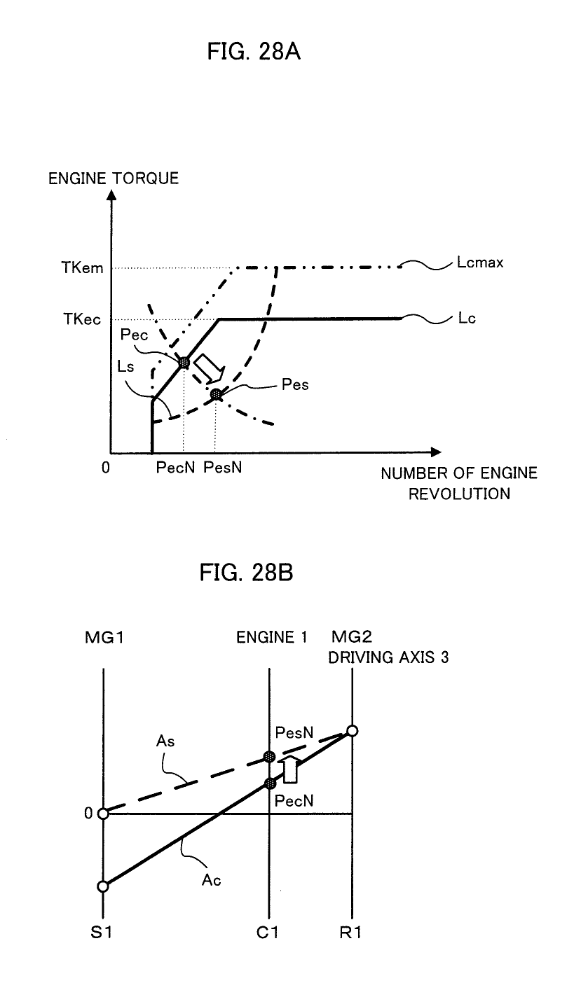

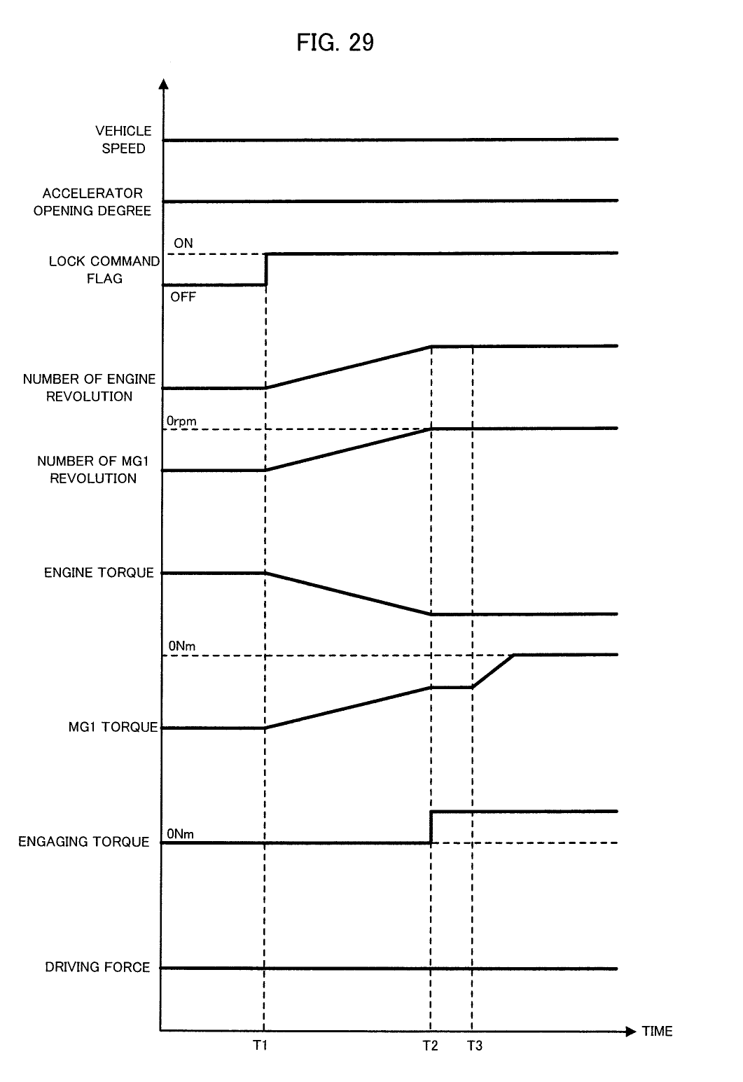

First, with reference to FIGS. 28, 29, the description will be given of the switching control method of the speed change mode in the case that the vehicle speed increases and the vehicle operation point moves from the infinite variable speed mode area Ar3 to the first fixed speed change mode area Ar1 (the case shown by the arrow W1a in FIG. 27).

FIG. 28A is a diagram showing the moving manner of the engine operation point in the case that the vehicle speed increases and the vehicle operation point moves from the infinite variable speed mode area Ar3 to the first fixed speed change mode area Ar1. The vertical axis shows the engine torque, and the horizontal axis shows the number of engine revolution. FIG. 28A shows the CVT operation line Lc, the operation line Ls of the engine 1 in the fixed speed change mode, the equi-power line Lp and the maximum engine torque operation line Lcmax. FIG. 28B shows changing manner of the alignment chart at that time.

In FIG. 28A, when the engine torque decreases and the number of engine revolution increases, the engine operation point moves along the equi-power line Lp from the point Pec on the CVT operation line Lc to the point Pes on the operation line Ls. At this time, as shown in FIG. 28B, the alignment chart changes from the straight line Ac to the straight line As. Namely, in order to engage the clutch 7a of the lock mechanism 7, the first motor generator MG1 is controlled from the state of negative revolution to the number of revolution “0”.

FIG. 29 shows the timing chart of the speed change mode switching control in the case that the engine operation point moves from the point Pec to the point Pes in FIG. 28A. In FIG. 29, the vertical axes show the vehicle speed, the accelerator opening degree, the lock command flag, the number of engine revolution, the number of MG1 revolution, the engine torque, the MG1 torque, the engaging torque of the clutch 7a of the lock mechanism 7 and the driving force, in this order from the top, and the horizontal axis shows the time.

The ECU 4 stores the relation of the vehicle speed and the accelerator opening degree with respect to the speed change mode, as shown in FIG. 27, in the memory or the like as the speed change mode determination map. When the ECU 4 determines, based on the vehicle speed by the speed change mode determination map, that the vehicle operation point moves from the infinite variable speed mode area Ar3 to the first fixed speed change mode area Ar1, it changes the lock command flag from OFF to ON (time T1). When the ECU 4 confirms that the lock command flag becomes ON, it starts the speed change mode switching control. In this example, since the engine operation point moves along the equi-power line Lp, the driving force is kept constant while the speed change mode switching control is performed.

From time T1 to time T2, the ECU 4 performs the control of gradually decreases the engine torque from the engine torque at the time T1. In addition, from time T1 to time T2, the ECU 4 controls the first motor generator MG1 to gradually decrease the MG1 torque to be equal to the reaction torque corresponding to the engine torque, and makes the number of MG1 revolution to “0” from the number of revolution of negative revolution. When the number of MG1 revolution approaches “0” from the number of revolution of negative revolution, the number of engine revolution increases as shown in FIG. 28B. By this, the engine operation point moves from the point Pec to the point Pes in FIG. 28A. From time T1 to time T2, the second motor generator MG2 is controlled such that the power balance becomes constant. When the number of MG1 revolution becomes “0” (time T2), the ECU 4 engages the clutch 7a. After the clutch 7a engages, the ECU 4 makes the MG1 torque “0” (time T3), and ends the speed change mode switching control. By this, it is possible to perform the synchronization control of making the number of MG1 revolution “0” by the responsive first motor generator MG1 while keeping the driving force. Further, since the second motor generator MG2 is controlled such that the power balance becomes “0” by the equi-power speed change, the load on the HV battery 33 can be suppressed.

As described above, in the case that the vehicle speed increases and the vehicle operation point moves from the infinite variable speed mode area Ar3 to the first fixed speed change mode area Ar1, the ECU 4 controls the MG1 torque to be equal to the reaction torque corresponding to the engine torque to switch the speed change mode from the infinite variable speed mode to the fixed speed change mode.

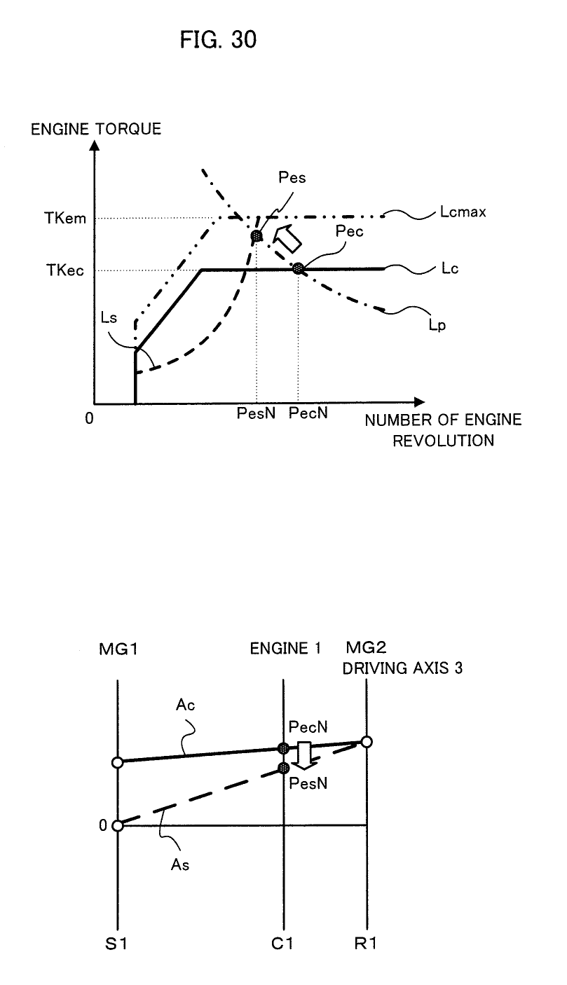

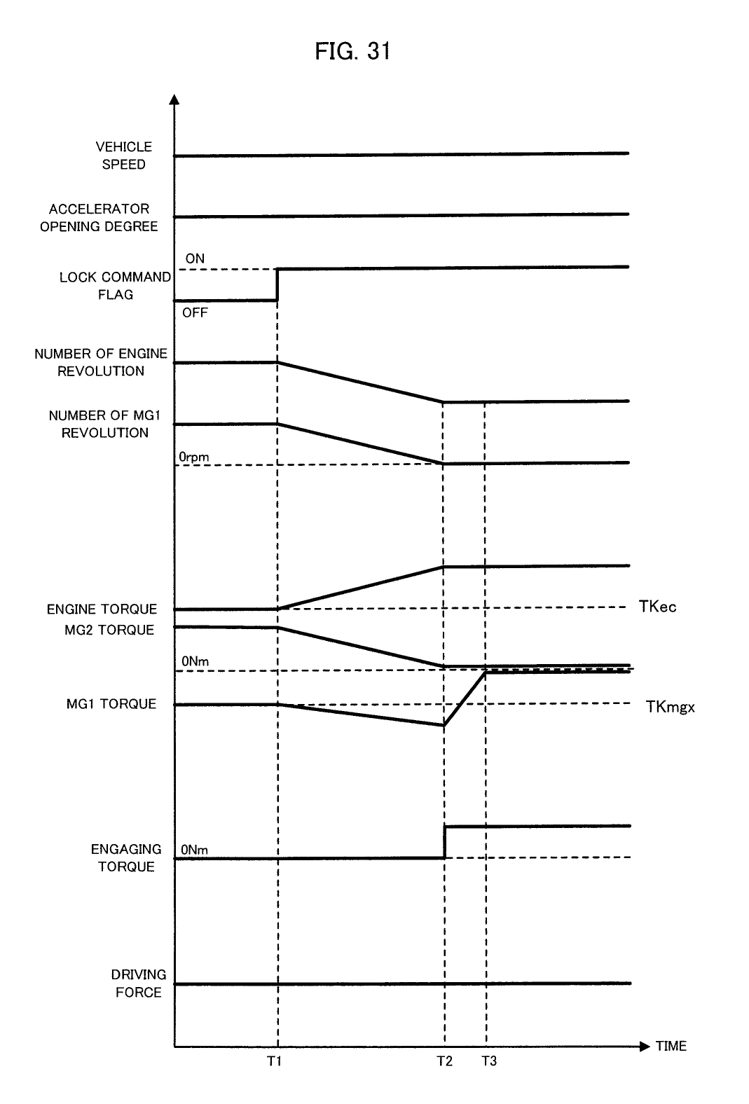

Next, with reference to FIGS. 30, 31, the description will be given of the speed change mode switching control method in the case that the vehicle speed increases and the vehicle operation point moves from the infinite variable speed mode area Ar3 to the second fixed speed change mode area Ar2 (the case shown by the arrow Wa2 in FIG. 27).

FIG. 30A is a diagram showing the moving manner of the engine operation point in the case that the vehicle speed increases and the vehicle operation point moves from the infinite variable speed mode area Ar3 to the second fixed speed change mode area Ar2. The vertical axis shows the engine torque, and the horizontal axis shows the number of engine revolution. FIG. 30A shows the CVT operation line Lc, the operation line Ls of the engine 1 in the fixed speed change mode, the equi-power line Lp and the maximum engine torque operation line Lcmax. FIG. 30B shows changing manner of the alignment chart at that time.

In FIG. 30A, when the engine torque increases and the number of engine revolution decreases, the engine operation point moves along the equi-power line Lp from the point Pec on the CVT operation line Lc to the point Pes on the operation line Ls. At this time, as shown in FIG. 30B, the alignment chart changes from the straight line Ac to the straight line As. Namely, in order to engage the clutch 7a of the lock mechanism 7, the first motor generator MG1 is controlled from the state of positive revolution to the state of the number of revolution “0”.

FIG. 31 shows the timing chart of the speed change mode switching control in the case that the engine operation point moves from the point Pec to the point Pes in FIG. 30A. In FIG. 31, the vertical axes show the vehicle speed, the accelerator opening degree, the lock command flag, the number of engine revolution, the number of MG1 revolution, the engine torque, the MG2 torque, the MG1 torque, the engaging torque of the clutch 7a of the lock mechanism 7 and the driving force, in this order from the top, and the horizontal axis shows the time. In this example, since the engine operation point moves along the equi-power line Lp, the driving force is kept constant while the speed change mode switching control is performed.

When the ECU 4 determines, based on the vehicle speed by the speed change mode determination map, that the vehicle operation point moves from the infinite variable speed mode area Ar3 to the second fixed speed change mode area Ar2, it changes the lock command flag from OFF to ON (time T1). When the ECU 4 confirms that the lock command flag becomes ON, it starts the speed change mode switching control.

From time T1 to time T2, the ECU 4 performs the control of gradually increasing the engine torque from the engine torque at the time T1. As shown in FIG. 30A, when the engine torque increases in the state that the engine operation point exists at the point Pec, the engine torque exceeds the reaction force upper limit engine torque TKec, i.e., the reaction torque corresponding to the engine torque exceeds the maximum rating torque TKmgx of the MG1 torque.

Therefore, from time T1 to time T2, the ECU 4 increases the current flowing through the first motor generator MG1 to make the first motor generator MG1 temporarily output the MG1 torque larger than the maximum rating torque TKmgx (MG1 torque-up). In addition, the ECU 4 performs the control of limiting the engine torque to correspond to the torque that can be outputted by the first motor generator MG1 after the torque-up. Specifically, the ECU 4 controls the engine torque such that the reaction torque becomes equal to or smaller than the torque that can be outputted by the first motor generator MG1 after the torque-up. By this, the reaction torque corresponding to the engine torque can be received by the first motor generator MG1, and the engine blow-up can be prevented. Then, the ECU 4 controls the first motor generator MG1 to increase the MG1 torque to be equal to the reaction torque corresponding to the engine torque, and makes the number of MG1 revolution approach “0” from the number of revolution of negative revolution. As the number of MG1 revolution decreases from time T1 to time T2, the number of engine revolution also decreases as shown in FIG. 30B. In this way, the engine operation point moves from the point Pec to the point Pes in FIG. 30A. From time T1 to time T2, the second motor generator MG2 is controlled such that the power balance becomes constant.

When the number of MG1 revolution becomes “0” (time T2), the ECU 4 engages the clutch 7a of the lock mechanism 7. Thereafter, the ECU 4 makes the MG1 torque “0”, and ends the speed change mode switching control. In this example, since the MG1 torque-up is temporarily performed, the first motor generator MG1 can be protected in comparison with the case in which the MG1 torque-up is always performed. By performing the MG1 torque-up, it is possible to perform the synchronization control of making the number of MG1 revolution “0” by the responsive first motor generator MG1, while keeping the driving force. Further, in this example, since the second motor generator MG2 is controlled by the equi-power speed change such that the power balance becomes “0”, the load on the HV battery can be suppressed.

As described above, in the case that the vehicle speed increases and the vehicle operation point moves from the infinite variable speed mode area Ar3 to the second fixed speed change mode area Ar2, the ECU 4 performs the MG1 torque-up control to switch the speed change mode from the infinite variable speed mode to the fixed speed change mode.

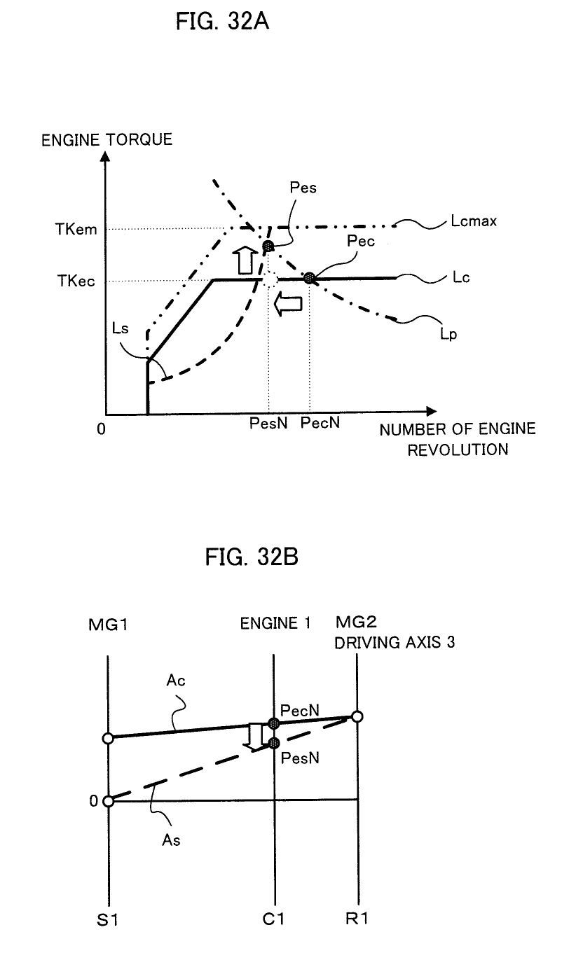

The example of FIG. 31 describes the case in which the MG1 torque-up can be performed. However, there is a case that the MG1 torque-up cannot be performed, depending upon the condition of the HV battery 33. Therefore, in the example described below, in the case that the reaction torque corresponding to the engine torque is determined to exceed the maximum rating torque of the first motor generator MG1, the engine torque is limited to the reaction force upper limit engine torque, instead of performing the MG1 torque-up. The specific description will be given with reference to FIGS. 32 to 34.

FIG. 32A is a diagram showing the moving manner of the engine operation point in the case that the vehicle operation point moves from the infinite variable speed mode area Ar3 to the second fixed speed change mode area Ar2. The vertical axis shows the engine torque, and the horizontal axis shows the number of engine revolution. FIG. 32A shows the CVT operation line Lc, the operation line Ls of the engine 1 in the fixed speed change mode, the equi-power line Lp and the maximum engine torque operation line Lcmax. FIG. 32B shows changing manner of the alignment chart at that time.

In FIG. 32A, when the engine torque decreases and then the engine torque increases, the engine operation point moves along the arrow from the point Pec on the CVT operation line Lc to the point Pes on the operation line Ls. At this time, as shown in FIG. 32B, the alignment chart changes from the straight line Ac to the straight line As. Namely, in order to engage the clutch 7a of the lock mechanism 7, the first motor generator MG1 is controlled from the state of positive revolution to the state of the number of revolution “0”.

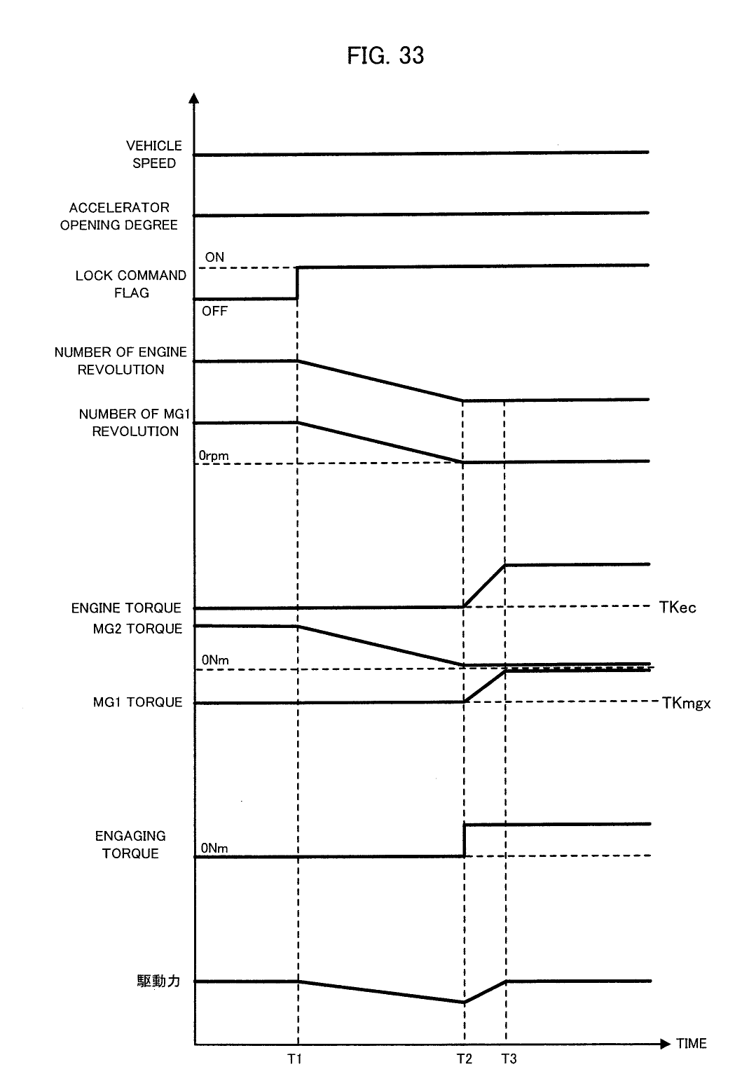

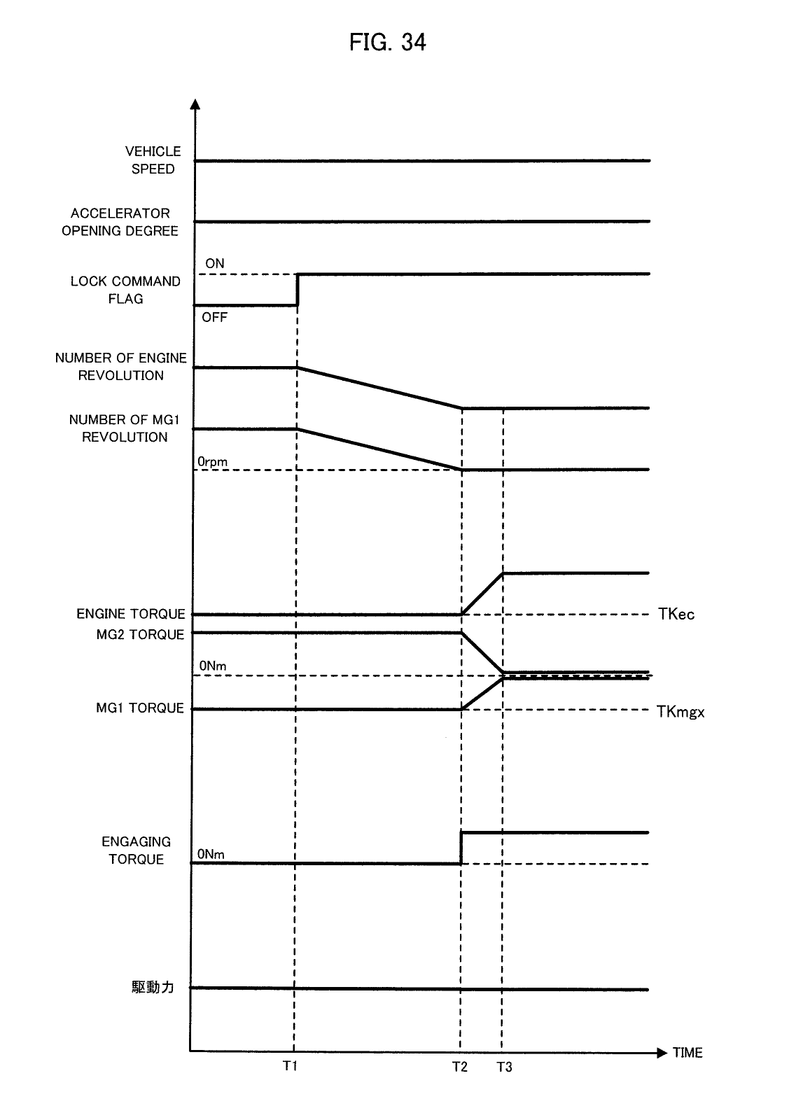

FIGS. 33, 34 show the timing chart of the speed change mode switching control in the case that the engine operation point moves from the point Pec to the point Pes in FIG. 32A. In FIGS. 33, 34 the vertical axes show the vehicle speed, the accelerator opening degree, the lock command flag, the number of engine revolution, the number of MG1 revolution, the engine torque, the MG2 torque, the MG1 torque, the engaging torque of the clutch 7a of the lock mechanism 7 and the driving force, in this order from the top, and the horizontal axis shows the time.

First, the description will be given with reference to FIG. 33. When the ECU 4 determines, based on the vehicle speed by the speed change mode determination map, that the vehicle operation point moves from the infinite variable speed mode area Ar3 to the second fixed speed change mode area Ar2, it changes the lock command flag from OFF to ON (time T1). When the ECU 4 confirms that the lock command flag becomes ON, it starts the speed change mode switching control.

At time T1, since the engine operation point exists at the point Pec, the engine torque is the reaction force upper limit engine torque TKec. From time T1 to time T2, the ECU 4 keeps the MG1 torque to be the maximum rating torque TKmgx, and limits the engine torque to be the reaction force upper limit engine torque TKec in order to prevent the engine blow-up. Since the MG1 torque is kept at the maximum rating torque TKmgx and the engaging torque cannot be controlled from time T1 to time T2, the ECU 4 control the number of engine revolution to perform the synchronization control of the number of MG1 revolution. Specifically, from time T1 to time T2, the ECU 4 decreases the number of engine revolution to make the number of MG1 revolution decrease to approach “0”. By this, the synchronization control of the number of MG1 revolution can be performed while keeping the MG1 torque at the maximum rating torque TKmgx. In the example of FIG. 33, the second motor generator MG2 is controlled such that the power balance becomes constant from time T1 to time T2.

When the number of MG1 revolution becomes “0” (time T2), the ECU 4 engages the clutch 7a of the lock mechanism 7. Then, from time T2 to time T3, the ECU 4 makes the MG1 torque “0” and increases the engine torque, thereby to end the speed change mode switching control. By doing this, the engine operation point moves along the arrow from the point Pec to the point Pes in FIG. 32A, and the speed change mode is switched from the infinite variable speed mode to the fixed speed change mode.

However, in the case that the second motor generator MG2 is controlled from time T1 to time T2 such that the power balance becomes constant, the MG2 torque gradually decreases, and the decrease of the driving force occurs as shown in FIG. 33.

In this view, in the fifth embodiment, as shown in FIG. 34, the ECU 4 performs controls the second motor generator MG2 from time T1 to time T2 to perform the MG2 torque compensation control which controls the MG2 torque such that the driving force becomes constant, in addition to the above control. By this, the decrease of the driving force is prevented from time T1 to time T2, and the drivability can be improved. Here, from time T1 to time T2, the MG1 torque is set to the maximum rating torque TKmgx. By this, in comparison with the case of setting the MG1 torque to the torque smaller than the maximum rating torque TKmgx, the power generation amount of the first motor generator MG1 can be larger, and it is possible to suppress the decrease of the power amount of the HV battery 33 caused by performing the MG2 torque compensation control. In addition, as described above, the engine torque is set to the reaction force upper limit engine torque TKec, i.e., the engine torque is controlled to possibly satisfy the requested driving force. Therefore, in the case of performing the MG2 torque compensation control, the required MG2 torque is suppressed. Namely, the MG2 torque compensation control is limited to minimum necessary. Further, by determining in advance that the MG1 torque is always set to the maximum rating torque TKmgx, the cooperative control is not necessary for the first motor generator MG1, and the control can be simplified.

When the number of MG1 revolution becomes “0” (time T2), the ECU 4 engages the clutch 7a. Then, from time T2 to time T3, the ECU 4 increases the engine torque and controls the second motor generator MG2 to decrease the MG2 torque to be “0” (time T3) such that the driving force becomes constant according to the increasing engine torque. This is because, when the MG2 torque compensation is performed, the power amount consumed by the second motor generator MG2 becomes larger than the power amount charged to the HV battery 33, and the shock may occur at the time of switching the speed change mode if the MG2 torque is not decreased according to the increasing engine torque. By this, the driving force can be kept constant. In this way, in the example of FIG. 34, the speed change mode is switched from the infinite variable speed mode to the fixed speed change mode without causing the decrease of the driving force.

As described above, in the case that the vehicle speed increases and the vehicle operation point moves from the infinite variable speed mode area Ar3 to the fixed speed change mode area Ar2, the ECU 4 limits the engine torque to the reaction force upper limit engine torque TKec, instead of performing the MG1 torque-up control, thereby to switch the speed change mode from the infinite variable speed mode to the fixed speed change mode. Further, at the time of performing the speed change mode switching control, the ECU 4 performs the MG2 torque compensation control by the second motor generator MG2. By this, the decrease of the driving force can be suppressed, and the occurrence of the shock can be prevented.

The above example describes the case in which the vehicle speed increases and the vehicle operation point moves from the infinite variable speed mode area Ar3 to the fixed speed change mode areas Ar1, Ar2, respectively (the cases shown by the arrows Wa1, Wa2 in FIG. 27). However, the present invention is not limited to this. The above switching control method can be similarly used in the case in which the accelerator opening degree increases or decreases, and the vehicle operation point moves from the infinite variable speed mode area Ar3 to the fixed speed change mode areas

Ar1, Ar2, respectively (the cases shown by the arrows Wb1, Wb2, or the arrows Wc1, Wc2 in FIG. 27).

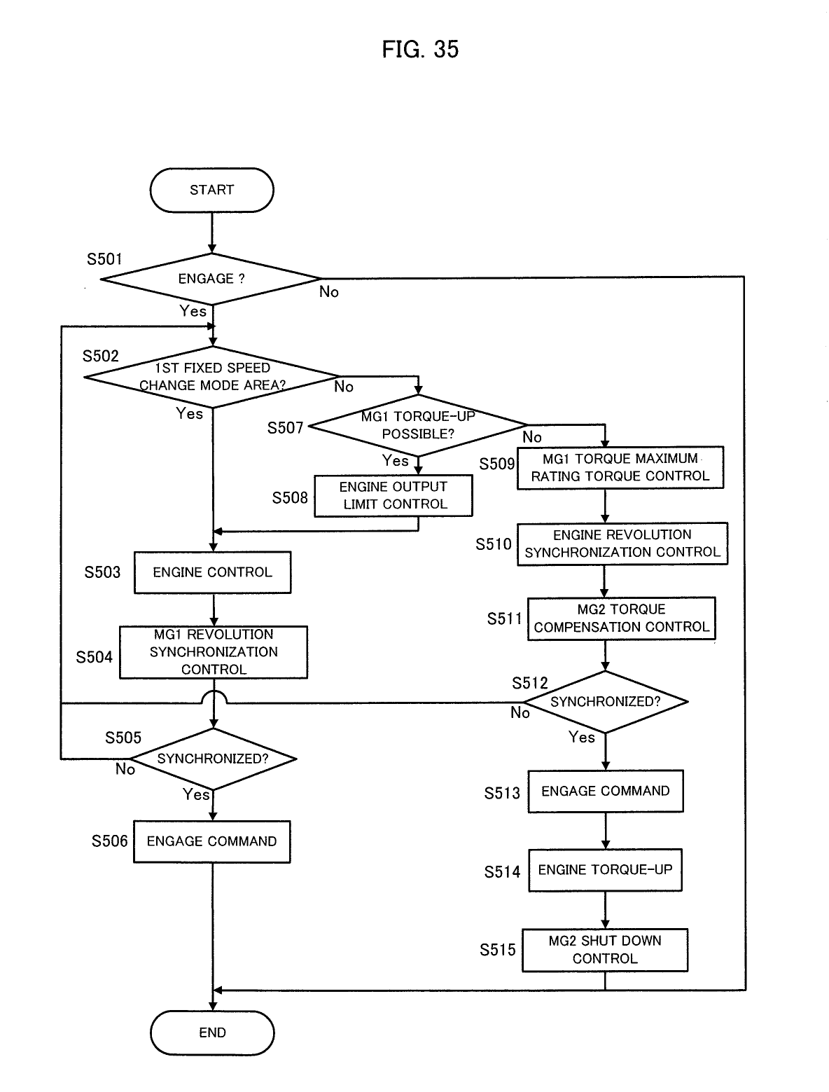

Next, the speed change mode switching process according to the fifth embodiment will be described with reference to the flowchart of FIG. 35. In the speed change mode switching process according to the fifth embodiment, the ECU 4 determines, to which one of the fixed speed change mode areas Ar1 or Ar2 the vehicle operation point moves, based on the accelerator opening degree or the vehicle speed, and performs the speed change mode switching control in the respective cases. Further, when the ECU 4 determines that the vehicle operation point moves from the infinite variable speed change mode area Ar3 to the second fixed speed change mode area Ar2, it determines whether or not the MG1 torque-up is possible. When the ECU 4 determines that the MG1 torque-up is possible, it performs the speed change mode switching control by using the MG1 torque-up control. When the ECU 4 determines that the MG1 torque-up is not possible, it performs the speed change mode switching control by using the engine torque limiting control and the MG2 torque compensation control.

First, in step S501, the ECU 4 determines whether or not the clutch 7a of the lock mechanism 7 should be engaged, based on the vehicle speed or the accelerator opening degree. When the ECU 4 determines based on the vehicle speed that the clutch 7a should not be engaged (step S501: No), it ends this control process.

When the ECU 4 determines that the clutch 7a should be engaged (step S501: Yes), it goes to step S502.

In step S502, the ECU 4 determines whether or not the vehicle operation point moves to the first fixed speed change mode area Ar1, based on the vehicle speed or the accelerator opening degree, by using the speed change mode determination map. When the ECU 4 determines that the vehicle operation point moves to the first fixed speed change mode area Ar1 (step S502: Yes), it goes to step S503. When the ECU 4 determines that the vehicle operation point does not move to the first fixed speed change mode area Ar1, i.e., determines that the vehicle operation point moves to the second fixed speed change mode area Ar2 (step S503: No), it goes to step S507.

In step S503, the ECU 4 controls the engine torque. In next step S504, the ECU 4 controls the first motor generator MG1 to control the MG1 torque to be equal to the reaction torque corresponding to the engine torque, and makes the number of MG1 revolution approach “0”.

In step S505, the ECU 4 determines whether or not the number of MG1 revolution becomes “0”, i.e., whether or not the number of MG1 revolution synchronization control is completed. When the ECU 4 determines that the synchronization control is not completed (step S505: No), it goes back to step S502. When the ECU 4 determines that the synchronization control is completed (step S505: Yes), it goes to step S506. In step S506, the ECU 4 transmits the control signal to the lock mechanism 7 to engage the clutch 7a. Thereafter, the ECU 4 ends this control process.

On the other hand, when the ECU 4 determines that the vehicle operation point is not in the first fixed speed change mode area Ar1, i.e., determines that the vehicle operation point is in the second fixed speed change mode area Ar2 (step S502: No), it goes to step S507 and determines whether the MG1 torque-up is possible, based on the SOC, the condition of the inverter 31, the temperature of the first motor generator MG1 itself and so on. For example, the ECU 4 detects the temperature of the first motor generator MG1 based on the detection signal from the temperature sensor mounted on the first motor generator MG1, and determines that the MG1 torque-up is possible if the temperature is equal to or lower than a predetermined temperature. Here, the predetermined temperature is set to the temperature with which the first motor generator MG1 is not broken if the torque larger than the maximum rating torque is temporarily outputted by the first motor generator MG1. When the ECU 4 determines that the MG1 torque-up is possible (step S507: Yes), it performs the MG1 torque-up and goes to step S508. When the ECU 4 determines that the MG1 torque-up is not possible (step S507: No), it goes to step S509.

In step S508, the ECU 4 performs the control of limiting the engine torque in accordance with the torque-up amount of the first motor generator MG1. Namely, the ECU 4 performs the control of limiting the engine torque such that the engine torque corresponding to the torque that can be outputted by the first motor generator MG1 after the torque-up is outputted. Thereafter, the ECU 4 goes to step S503.

On the other hand, when the ECU 4 determines that the torque-up of the first motor generator MG1 is not possible in step S507 (step S507: No), it goes to step S509 to limit the engine torque to the reaction force upper limit engine torque and keep the MG1 torque to the maximum rating torque. In next step S510, the ECU 4 controls the number of engine revolution to perform the number of engine revolution synchronization control of making the number of MG1 revolution approach “0”.

In step S511, the ECU 4 controls the second motor generator MG2 to perform the MG2 torque compensation control, which controls the MG2 torque such that the driving force becomes constant. In step S512, the ECU 4 determines whether or not the number of MG1 revolution is “0”, i.e., whether or not the number of engine revolution synchronization control is completed. When the ECU 4 determines that the synchronization control is not completed (step S512: No), it goes back to step S502. When the ECU 4 determines that the synchronization control is completed (step S512: Yes), it goes to step S513.

In step S513, the ECU 4 transmits the control signal to the lock mechanism 7 to engage the clutch 7a. Then, the ECU 4 increases the engine torque in step S514, and decreases the MG2 torque to “0” such that the driving force becomes constant according to the increasing engine torque in next step S515. Then, the ECU 4 ends this control process.

As is understood from the above description, in the fifth embodiment, in the case that the speed change mode is switched from the infinite variable speed mode to the fixed speed change mode, the ECU 4 determines whether or not the MG1 torque-up is possible, and performs the speed change mode switching control if the MG1 torque-up is possible. On the other hand, when the ECU 4 determines that the MG1 torque-up is not possible, it limits the engine torque to the reaction force upper limit engine torque and keeps the MG1 torque to the maximum rating torque to perform the speed change mode switching control. Thus, the engine blow-up can be prevented at the time of switching the speed change mode. Further, the ECU 4 performs the MG2 torque compensation control by the second motor generator MG2 when it limits the engine torque to the reaction force upper limit engine torque and keeps the MG1 torque to the maximum rating torque. By this, the decrease of the driving force can be prevented.

### 6th Embodiment

Next, the sixth embodiment of the present invention will be described.

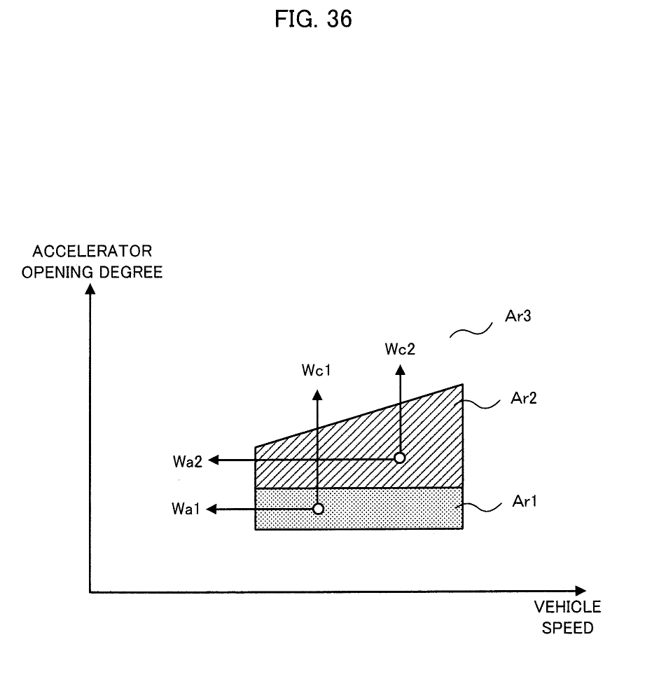

FIG. 36 shows the moving manner of the vehicle operation point in the sixth embodiment. The vertical axis shows the accelerator opening degree, and the horizontal axis shows the vehicle speed. FIG. 36 shows the infinite variable speed mode area Ar3, and the fixed speed change mode areas Ar1, Ar2. As shown by the arrows Wa1, Wa2, Wc1, Wc2 of FIG. 36, in the sixth embodiment, the description will be given of the switching control method of the speed change mode in the case that the vehicle speed decreases or the accelerator opening degree increases, and the vehicle operation point moves from the fixed speed change mode areas Ar1, Ar2, respectively, to the infinite variable speed mode area Ar3. In the following, as an example, the description will be given of the case in which the accelerator opening degree increases and the vehicle operation point moves from the fixed speed change mode areas Ar1, Ar2, respectively, to the infinite variable speed mode area Ar3.

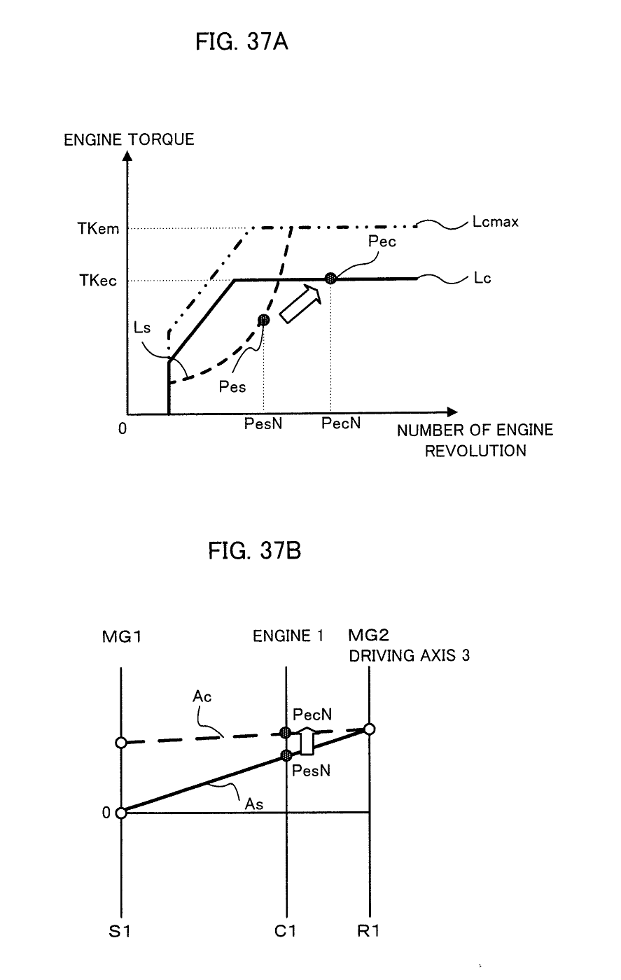

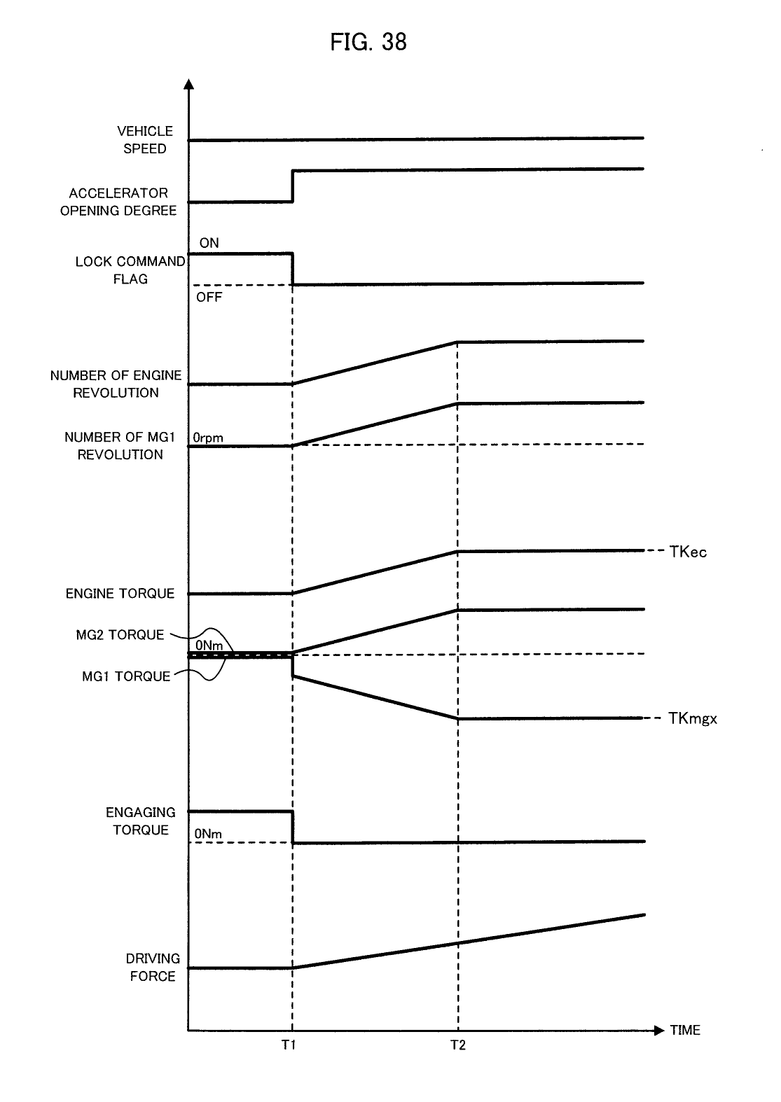

First, with reference to FIGS. 37, 38, the description will be given of the switching control method of the speed change mode in the case that the accelerator opening degree increases and the vehicle operation point moves from the first fixed speed change mode area Ar1 to the infinite variable speed mode area Ar3 (the case shown by the arrow Wc1 in FIG. 36).

FIG. 37A is a diagram showing the moving manner of the engine operation point in the case that the accelerator opening degree increases and the vehicle operation point moves from the first filed speed change mode area Ar1 to the infinite variable speed mode area Ar3. The vertical axis shows the engine torque, and the horizontal axis shows the number of engine revolution. FIG. 37A shows the CVT operation line Lc, the operation line Ls of the engine 1 in the fixed speed change mode, and the maximum engine torque operation line Lcmax. FIG. 37B shows changing manner of the alignment chart at that time.

In FIG. 37A, when the engine torque and the number of engine revolution increase, the engine operation point moves along the arrow from the point Pes on the operation line Ls to the point Pec on the CVT operation line Lc. At this time, as shown in FIG. 37B, the alignment chart changes from the straight line As to the straight line Ac. Namely, after the clutch 7a of the lock mechanism 7 is released, the first motor generator MG1 is controlled from the number of revolution “0” to the state of positive revolution.

FIG. 38 shows the timing chart of the speed change mode switching control in the case that the engine operation point moves from the point Pes to the point Pec in FIG. 37A. In FIG. 38, the vertical axes show the vehicle speed, the accelerator opening degree, the lock command flag, the number of engine revolution, the number of MG1 revolution, the engine torque, the MG2 torque, the MG1 torque, the engaging torque of the clutch 7a of the lock mechanism 7 and the driving force, in this order from the top, and the horizontal axis shows the time.

The ECU 4 stores the relation of the vehicle speed and the accelerator opening degree with respect to the speed change mode, as shown in FIG. 36, in the memory or the like as the speed change mode determination map. When the ECU 4 determines, based on the accelerator opening degree by the speed change mode determination map, that the vehicle operation point moves from the first fixed speed change mode area Ar1 to the infinite variable speed mode area Ar3, it changes the lock command flag from ON to OFF (time T1). When the ECU 4 confirms that the lock command flag becomes OFF, it starts the speed change mode switching control.

First, at time T1, the ECU 4 calculates the requested driving force based on the accelerator opening degree, and calculates the engine torque when the driving force becomes the requested driving force. At time T1, the ECU 4 performs the control of increasing the MG1 torque to be equal to the reaction torque corresponding to the engine torque, and releases the clutch 7a. Then, from time T1 to time T2, the ECU 4 performs the control of increasing the engine torque from the engine torque at the time T1 such that the driving force becomes the requested driving force. At this time, the ECU 4 controls the first motor generator MG1 to increase the MG1 torque to be equal to the reaction torque corresponding to the engine torque, and increases the number of MG1 revolution in the positive revolution direction. When the number of MG1 revolution increases in the positive revolution direction, the number of engine revolution also increases as shown in FIG. 37B. By this, the reaction torque can be received by the responsive first motor generator MG1. Further, after the time T1, the ECU 4 increases the MG2 torque to compensate for the shortage from the requested driving force. Here, as described above, since the engine torque is controlled such that the driving force becomes the requested driving force, the compensation amount by the MG2 is suppressed to be minimum. By this, the engine operation point moves from the point Pes to the point Pec in FIG. 37A, and the driving force increases.

As described above, in the case that the vehicle operation point moves from the first fixed speed change mode area Ar1 to the infinite variable speed mode area Ar3, the ECU 4 switches the speed change mode from the fixed speed change mode to the infinite variable speed mode by the releasing control of releasing the clutch 7a, the engine torque control and the MG2 torque compensation control.

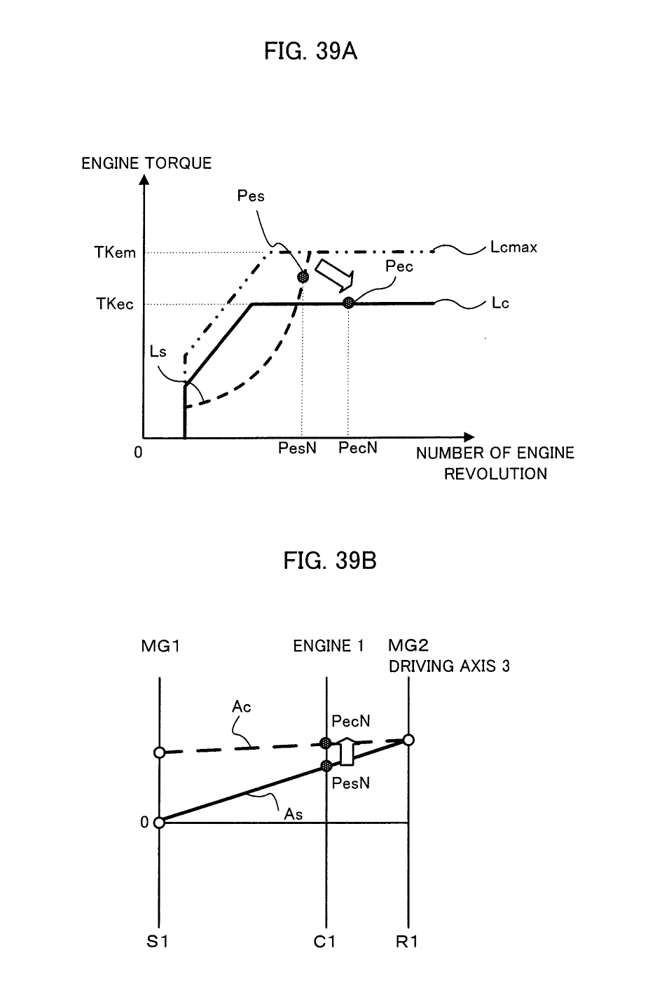

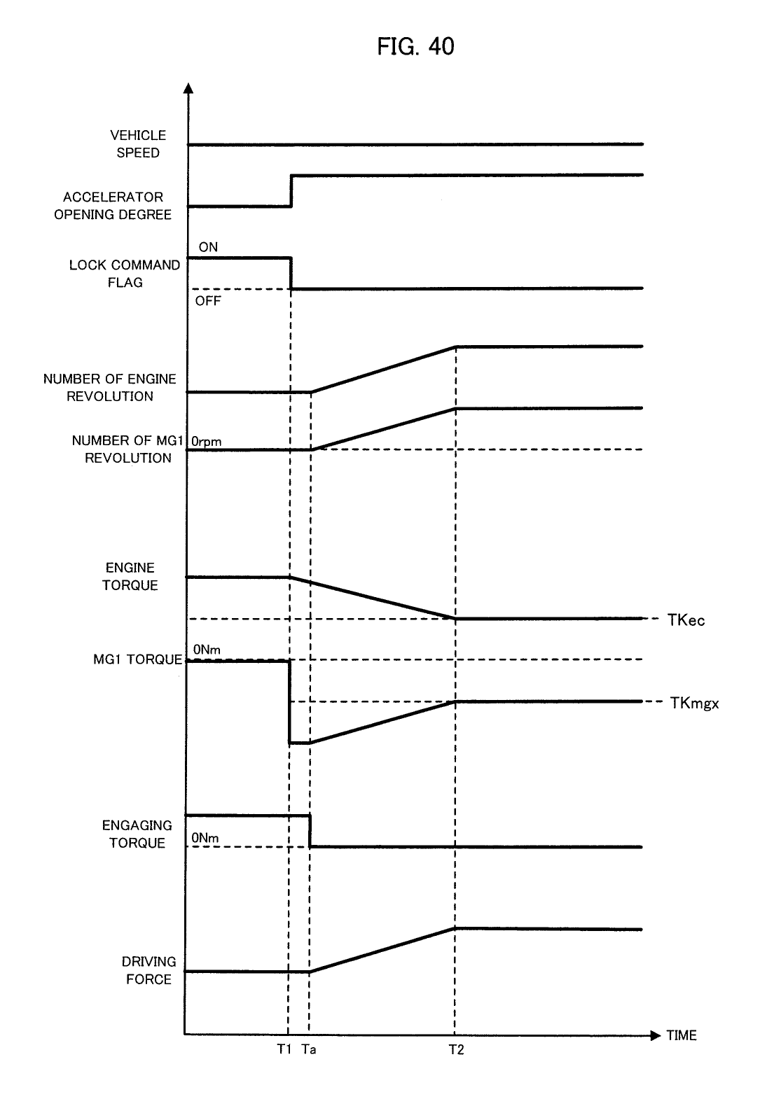

Next, the description will be given of the speed change mode switching control method in the case that the accelerator opening degree increases and the vehicle operation point moves from the second fixed speed change mode area Ar2 to the infinite variable speed mode area Ar3 (the case shown by the arrow Wc2 in FIG. 36). First, the speed change mode switching control method in the case of performing the MG1 torque-up control will be described with reference to FIGS. 39, 40.

FIG. 39A is a diagram showing the moving manner of the engine operation point in the case that the vehicle operation point moves from the second fixed speed change mode area Ar2 to the infinite variable speed mode area Ar3. The vertical axis shows the engine torque, and the horizontal axis shows the number of engine revolution. FIG. 39A shows the CVT operation line Lc, the operation line Ls of the engine 1 in the fixed speed change mode, and the maximum engine torque operation line Lcmax. FIG. 39B shows changing manner of the alignment chart at that time.

In FIG. 39A, when the engine torque decreases and the number of engine revolution increases, the engine operation point moves along the arrow from the point Pes on the operation line Ls to the point Pec on the CVT operation line Lc. At this time, as shown in FIG. 39B, the alignment chart changes from the straight line As to the straight line Ac. Namely, in order to engage the clutch 7a of the lock mechanism 7, the first motor generator MG1 is controlled from the number of revolution “0” to the state of positive revolution.

FIG. 40 shows the timing chart of the speed change mode switching control in the case that the engine operation point moves from the point Pes to the point Pec in FIG. 39A. In FIG. 40, the vertical axes show the vehicle speed, the accelerator opening degree, the lock command flag, the number of engine revolution, the number of MG1 revolution, the engine torque, the MG1 torque, the engaging torque of the clutch 7a of the lock mechanism 7 and the driving force, in this order from the top, and the horizontal axis shows the time.

When the ECU 4 determines, based on the accelerator opening degree by the speed change mode determination map, that the vehicle operation point moves from the second fixed speed change mode area Ar2 to the infinite variable speed mode area Ar3, it changes the lock command flag from ON to OFF (time T1). When the ECU 4 confirms that the lock command flag becomes OFF, it starts the speed change mode switching control.

At time T1, the ECU 4 makes the first motor generator MG1 output the torque larger than the maximum rating torque TKmgx, and limits the engine torque in accordance with the torque that can be outputted from the first motor generator after the torque-up. Thereafter, the ECU 4 releases the clutch 7a (time Ta). By this, the engine blow-up can be prevented at the time of releasing the clutch 7a.

Then, from time Ta to time T2, the ECU 4 gradually decreases the engine torque from the engine torque at the time Ta, and controls the engine torque to be equal to the reaction force upper limit engine torque TKec at the time T2. Also, the ECU 4 controls the first motor generator MG1 to perform the control of gradually decreasing the MG1 torque to be equal to the reaction torque corresponding to the engine torque, and increases the number of MG1 revolution in the position revolution direction. When the number of MG1 revolution increases in the positive revolution direction, the number of engine revolution also increases as shown in FIG. 39B. The ECU 4 gradually decreases the MG1 torque, and controls the MG1 torque to be equal to the maximum rating torque TKmgx at the time T2. Since the MG1 torque-up is temporary in this example, the first motor generator MG1 can be protected in comparison with the case of always performing the MG1 torque-up. In addition, by temporarily performing torque-up of the MG1 torque that can be outputted, the reaction torque can be received by the responsive first motor generator MG1. In this way, the engine operation point moves from the point Pes to the point Pec in FIG. 39A, and the driving force increases.

As described above, in the case that the accelerator opening degree increases and the vehicle operation point moves from the second fixed speed change mode area Ar2 to the infinite variable speed mode area Ar3, the ECU 4 performs the MG1 torque-up of increasing the torque that can be outputted by the MG1, if the MG1 torque-up is possible, thereby to switch the speed change mode from the fixed speed change mode to the infinite variable speed mode.

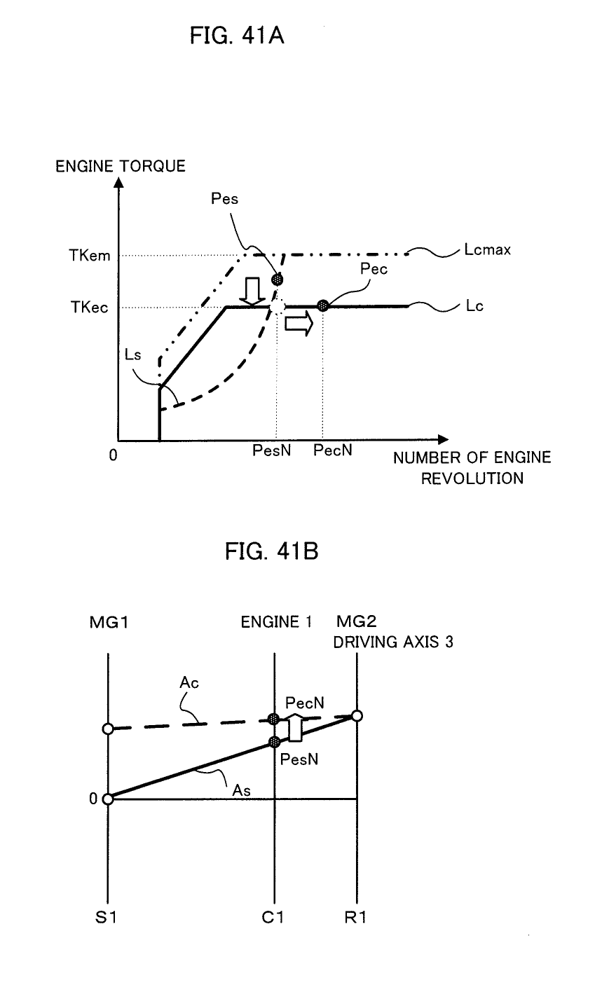

Next, the description will be given of the method of limiting the engine torque to the reaction force upper limit engine torque, as the speed change mode switching control method in the case that the vehicle operation point moves from the second fixed speed change mode area Ar2 to the infinite variable speed mode area Ar3, with reference to FIGS. 41 to 43.

FIG. 41A is a diagram showing the moving manner of the engine operation point in the case that the vehicle operation point moves from the second fixed speed change mode area Ar2 to the infinite variable speed mode area Ar3. The vertical axis shows the engine torque, and the horizontal axis shows the number of engine revolution. FIG. 41A shows the CVT operation line Lc, the operation line Ls of the engine 1 in the fixed speed change mode, and the maximum engine torque operation line Lcmax. FIG. 41B shows changing manner of the alignment chart at that time.

In FIG. 41A, when the engine torque decreases and the number of engine revolution increases, the engine operation point moves along the arrow from the point Pes to the point Pec. At this time, as shown in FIG. 41B, the alignment chart changes from the straight line As to the straight line Ac. Namely, in order to engage the clutch 7a of the lock mechanism 7, the first motor generator MG1 is controlled from the number of revolution “0” to the state of positive revolution.

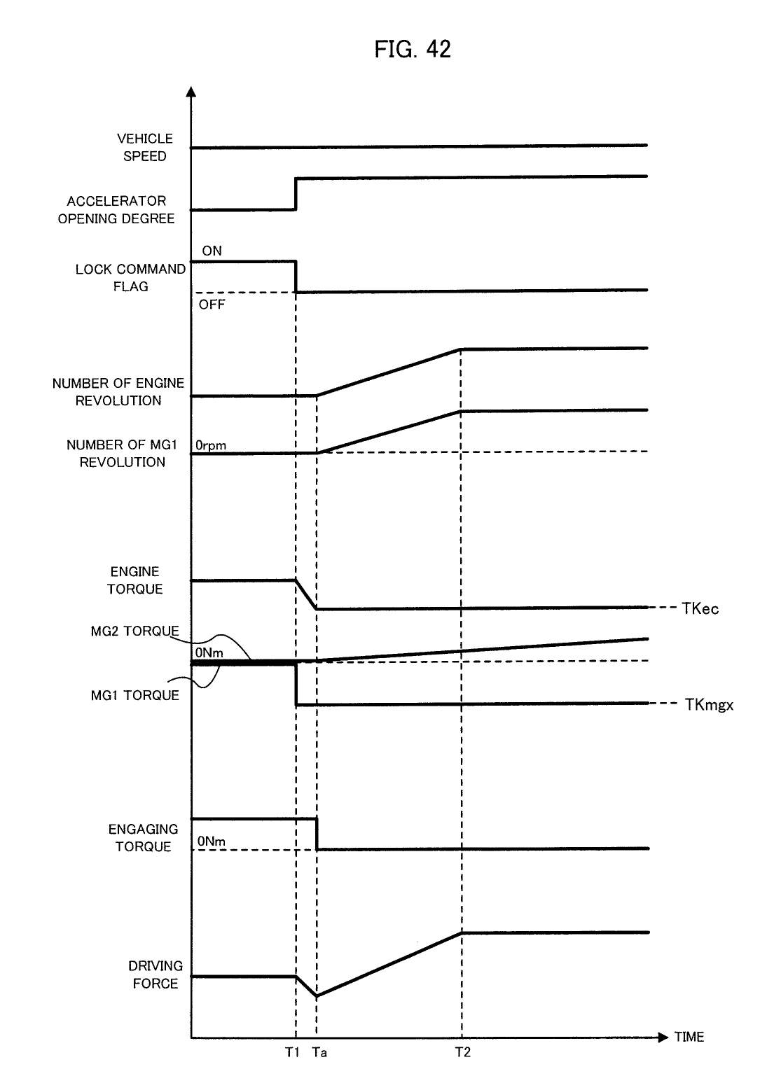

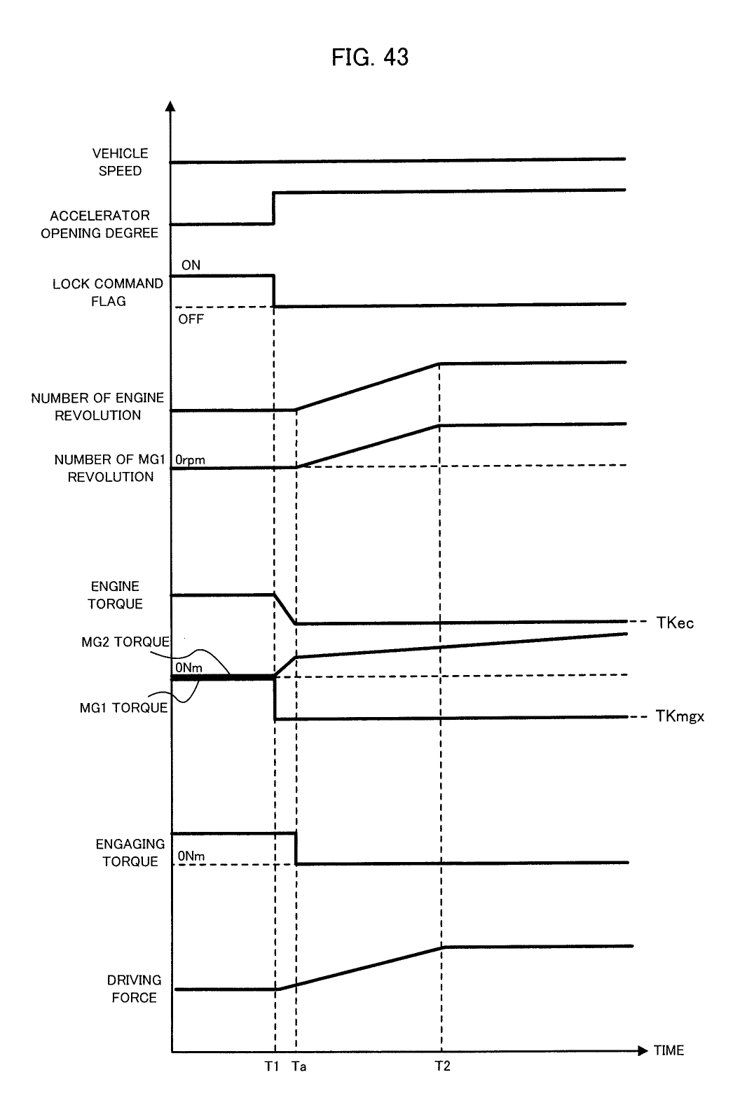

FIGS. 42, 43 show the timing chart of the speed change mode switching control in the case that the engine operation point moves from the point Pes to the point Pec in FIG. 41A. In FIGS. 42, 43, the vertical axes show the vehicle speed, the accelerator opening degree, the lock command flag, the number of engine revolution, the number of MG1 revolution, the engine torque, the MG2 torque, the MG1 torque, the engaging torque of the clutch 7a of the lock mechanism 7 and the driving force, in this order from the top, and the horizontal axis shows the time.

First, the description will be given with reference to FIG. 42. When the ECU 4 determines, based on the accelerator opening degree by the speed change mode determination map, that the vehicle operation point moves from the second fixed speed change mode area Ar2 to the infinite variable speed mode area Ar3, it changes the lock command flag from ON to OFF (time T1). When the ECU 4 confirms that the lock command flag becomes OFF, it starts the speed change mode switching control.

At time T1, the ECU 4 sets the MG1 torque to the maximum rating torque TKmgx. From time T1 to time Ta, the ECU 4 decreases the engine torque to the magnitude for which the first motor generator MG1 can receive the reaction torque, i.e., to the reaction force upper limit engine torque TKec. At the time Ta when the engine torque decreases and the first motor generator MG1 becomes able to receive the reaction torque, the ECU 4 releases the clutch 7a. By this, it is possible to prevent that the engine blow-up occurs at the time of releasing the clutch 7a.

Next, after releasing the clutch 7a at time Ta, the ECU 4 limits the engine torque to the reaction force upper limit engine torque TKec and keeps MG1 torque to the maximum rating torque TKmgx from time Ta to time T2, and increases the number of engine revolution to increase the number of MG1 revolution in the positive revolution direction. By this, the engine operation point moves from the point Pes to the point Pec in FIG. 39A. In this example, the second motor generator MG2 is controlled such that the power balance becomes constant, from time Ta to time T2. In this way, the speed change mode is switched from the infinite variable speed mode to the fixed speed change mode.

However, in the case that the ECU 4 controls the second motor generator MG2 such that the power balance becomes constant from time T1 to time T2, the driving force decreases at time Ta as shown in FIG. 42.

Therefore, in the sixth embodiment, in addition to the above-described control, the ECU 4 performs the MG2 torque assist control of controlling the second motor generator MG2 to increase the MG2 torque and decreasing the engine torque in accordance with the increased MG2 torque as shown in FIG. 43. Specifically, the ECU 4 increases the MG2 torque in accordance with the maximum rating torque of the second motor generator MG2 and the power amount that can be outputted from the HV battery 33, and decreases the engine torque in accordance with the increased amount of the MG2 torque such that the driving force becomes the requested driving force. By this, the decrease of the driving force can be prevented, and the drivability can be improved. Here, the MG1 torque is set to the maximum rating torque TKmgx. By this, the power generation amount of the first motor generator MG1 can be large, in comparison with the case in which the MG1 torque is set to the torque smaller than the maximum rating torque TKmgx, and the reduction of the power amount of the HV battery 33 due to the MG2 torque assist control can be suppressed. Then, when the engine torque becomes the reaction force upper limit engine torque TKec (time Ta), the ECU 4 releases the clutch 7a. By this, it is possible to prevent that the decrease of the driving force occurs, and the drivability can be improved.

As described above, in the case that the accelerator opening degree increases and the vehicle operation point moves from the fixed speed change mode area Ar2 to the infinite variable speed mode area Ar3, the ECU 4 limits the engine torque to the reaction force upper limit engine torque TKec, instead of performing the MG1 torque-up control, thereby to switch the speed change mode from the fixed speed change mode to the infinite variable speed mode. Further, in this speed change mode switching control, the ECU 4 performs the torque assist control by the second motor generator MG2. By this, the decrease of the driving force can be prevented.

The above example describes the case in which the accelerator opening degree increases and the vehicle operation point moves from the fixed speed change mode areas Ar1, Ar2, respectively, to the infinite variable speed mode area Ar3 (the cases shown by the arrows Wc1, Wc2 in FIG. 36). However, the present invention is not limited to this. The above switching control method can be similarly used in the case in which the vehicle speed decreases, and the vehicle operation point moves from the fixed speed change mode areas Ar1, Ar2, respectively, to the infinite variable speed mode area Ar3 (the cases shown by the arrows Wa1, Wa2 in FIG. 36).

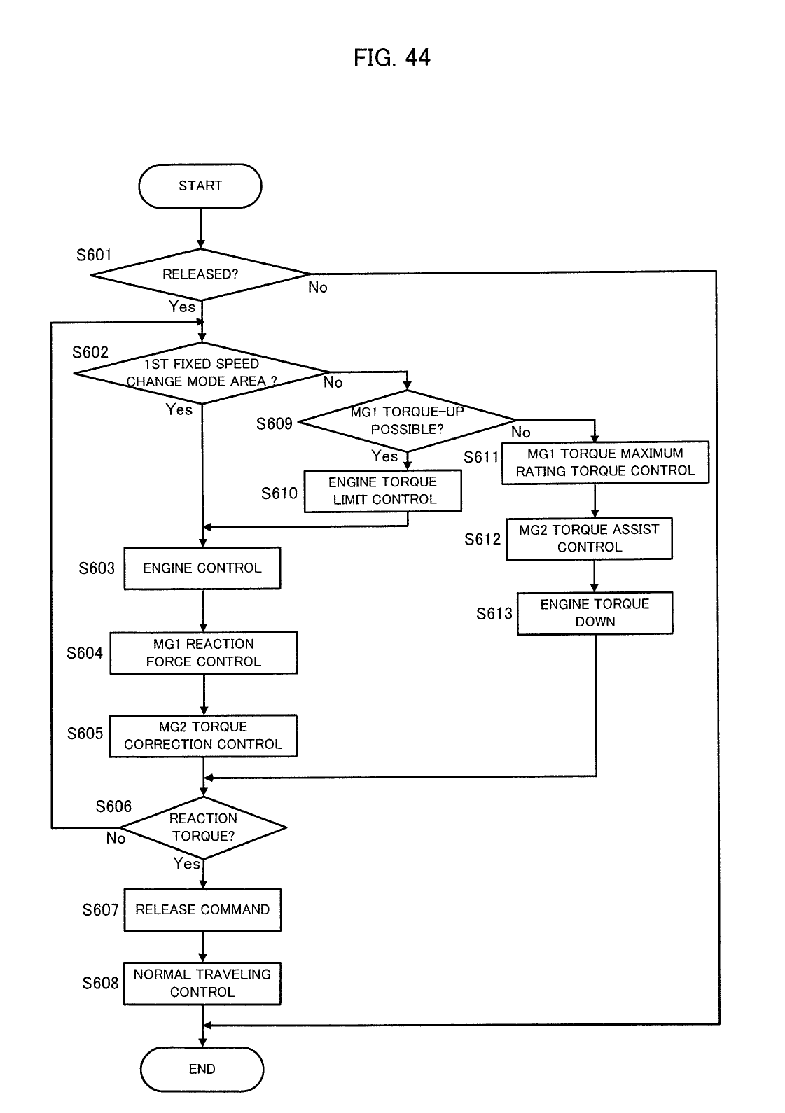

Next, the speed change mode switching process according to the sixth embodiment will be described with reference to the flowchart of FIG. 44. In the speed change mode switching process according to the sixth embodiment, the ECU 4 determines, from which one of the fixed speed change mode areas Ar1 or Ar2 the vehicle operation point moves to the infinite variable speed mode area Ar3, based on the accelerator opening degree or the vehicle speed, and performs the speed change mode switching control in the respective cases. Further, when the ECU 4 determines that the vehicle operation point moves from the second fixed speed change mode area Ar2 to the infinite variable speed change mode area Ar3, it determines whether or not the MG1 torque-up is possible. When the ECU 4 determines that the MG1 torque-up is possible, it performs the speed change mode switching control by using the MG1 torque-up control. When the ECU 4 determines that the MG1 torque-up is not possible, it performs the speed change mode switching control by using the MG2 torque compensation control.

First, in step S601, the ECU 4 determines whether or not the clutch 7a of the lock mechanism 7 should be released, based on the accelerator opening degree or the vehicle speed. When the ECU 4 determines based on the accelerator opening degree that the clutch 7a should not be released (step S601: No), it ends this control process. When the ECU 4 determines that the clutch 7a should be released (step S601: Yes), it goes to step S602.

In step S602, the ECU 4 determines whether or not the vehicle operation point locates in the first fixed speed change mode area Ar1, based on the accelerator opening degree or the vehicle speed, by using the speed change mode determination map. When the ECU 4 determines that the vehicle operation point locates in the first fixed speed change mode area Ar1 (step S602: Yes), it goes to step S603. When the ECU 4 determines that the vehicle operation point does not locate in the first fixed speed change mode area Ar1, i.e., determines that the vehicle operation point locates in the second fixed speed change mode area Ar2 (step S603: No), it goes to step S609.

In step S603, the ECU performs the engine torque control. In step S604, the ECU 4 controls the MG1 torque to be equal to the reaction torque corresponding to the engine torque. In next step S605, the ECU 4 compensates for the shortage from the requested driving force by correcting the MG2 torque.

In step S606, the ECU 4 determines whether or not the MG1 torque reaches the reaction torque corresponding to the engine torque. When the ECU 4 determines that the MG1 torque reaches the reaction torque corresponding to the engine torque (step S606: Yes), it performs the control of releasing the clutch 7a (step S607), and then performs the normal traveling control (step S608) and ends this control process. In step S606, when the ECU 4 determines that the MG1 torque does not reach the reaction torque corresponding to the engine torque (step S606: No), it goes back to step S602.

On the other hand, when the ECU 4 determines in step S602 that the vehicle operation point does not locate in the first fixed speed change mode area Ar1, i.e., the vehicle operation point locates in the second fixed speed change mode area Ar2 (step S602: No), it goes to step S609, and determines whether the MG1 torque-up is possible by the determination method similar to that described in the flowchart of the fifth embodiment (FIG. 35). When the ECU 4 determines that the MG1 torque-up is possible (step S609: Yes), it performs the MG1 torque-up control, and then goes to step S601. When the ECU 4 determines that the MG1 torque-up is not possible (step S609: No), it goes to step S611.

In step S610, the ECU 4 performs the control of limiting the engine torque in accordance with the torque-up amount of the first motor generator MG1. Namely, the ECU 4 performs the control of limiting the engine torque such that the engine torque corresponding to the torque that can be outputted by the first motor generator MG1 after the torque-up is outputted. Thereafter, the ECU 4 goes to step S603.

On the other hand, when the ECU 4 determines in step S609 that the MG1 torque-up is not possible (step S609: No), it goes to step S611, and controls the MG1 torque to be the maximum rating torque. In next step S612, the ECU 4 controls the second motor generator MG2 to perform the MG2 torque assist control of increasing the MG2 torque. In step S613, the ECU 4 decreases the engine torque in accordance with the increased amount of the MG2 torque. Thereafter, the ECU 4 goes to step S606, and ends this control process after executing the steps S607 and S608.

As is understood from the above description, in the sixth embodiment, in the case that the speed change mode is switched from the fixed speed change mode to the infinite variable speed mode, the ECU 4 determines whether or not the MG1 torque-up is possible, and performs the speed change mode switching control if the MG1 torque-up is possible, similarly to the fifth embodiment. When the ECU 4 determines that the MG1 torque-up is not possible, it limits the engine torque to the reaction force upper limit engine torque and keeps the MG1 torque to the maximum rating torque to perform the speed change mode switching control. Thus, the engine blow-up can be prevented at the time of switching the speed change mode. Further, the ECU 4 performs the MG2 torque assist control when it keeps the engine torque to the reaction force upper limit engine torque and keeps the MG1 torque to the maximum rating torque. By this, the decrease of the driving force can be prevented.

It goes without saying that the control method of the sixth embodiment and the control methods of the first to fifth embodiments can be executed in combination.

### Modified Example

While the power distribution mechanism is the single-pinion type planetary gear mechanism in the above embodiments, the present invention is not limited to this. Instead, a double-pinion type planetary gear mechanism can be used. Namely, instead of holding the pinion gear CP1 engaging both the ring gear R1 and the sun gear S1, the carrier C1 may hold the inner pinion gear configured to engage the sun gear S1 and the outer pinion gear configured to engage the inner pinion gear and the ring gear R1. Further, the pinion gear Cp1 may be the pinion gear having steps.

The mechanism of the hybrid vehicle to which the present invention is applied is not limited to the mechanism which achieves the fixed speed change mode by locking the rotor of the first motor generator MG1, i.e., by locking the sun gear S1. Instead, the present invention is applicable to the mechanism that the brake fixes any one of the revolution elements of the power distribution mechanism, except for the sun gear 1, to achieve the fixed speed change mode.

### INDUSTRIAL APPLICABILITY

This invention can be used for a hybrid vehicle configured to switch the speed change mode between the infinite variable speed mode and the fixed speed change mode.

1-11. (canceled)

12. A control device of a hybrid vehicle comprising: an engine; a motor generator; a power distribution mechanism to which the engine and the motor generator are connected; and an engaging mechanism which is connected to a driving axis that receives an output from the power distribution mechanism and any one of revolution elements of the power distribution mechanism, and which fixes and releases the revolution element, the control device comprising:
a map which is defined by an accelerator opening degree and a vehicle speed, and in which an infinite variable speed mode and a fixed speed change mode are set; and
a control unit which releases the revolution element by the engaging mechanism and switches a speed change mode to the infinite variable speed mode of making the motor generator output a reaction torque corresponding to an engine torque of the engine in a case that a vehicle operation point moves from a fixed speed change mode area to an infinite variable speed mode area on the map, and which fixes the revolution element by the engaging mechanism and switches the speed change mode to the fixed speed change mode of making the engaging mechanism receive the reaction torque in a case that the vehicle operation point moves from the infinite variable speed mode area to the fixed speed change mode area on the map,
wherein the fixed speed change mode area includes: a first fixed speed change mode area in which the reaction torque becomes equal to or smaller than a maximum rating torque of the motor generator; and a second fixed speed change mode area in which the reaction torque becomes larger than the maximum rating torque, and
wherein the control unit differentiates a switching method of the speed change mode in accordance with which one of the first and the second fixed speed change mode areas the vehicle operation point locates in or moves to.

13. The control device of the hybrid vehicle according to claim 12, further comprising an assist unit which outputs at least a part of the reaction torque,
wherein the control unit makes the assist unit output at least a part of the reaction torque in a case that the vehicle operation point moves to or locates in the second fixed speed change mode area and the revolution element is released at a time of switching the speed change mode.

14. The control device of the hybrid vehicle according to claim 13, wherein the control unit sets the torque outputted by the motor generator to the maximum rating torque in a case that the assist unit outputs the part of the reaction torque at the time of switching the speed change mode.

15. The control device of the hybrid vehicle according to claim 14, wherein the control unit sets the torque outputted by the motor generator to the maximum rating torque in a case that the vehicle operation point moves from the infinite variable speed mode area to the second fixed speed change mode area by an increase of the accelerator opening degree or the vehicle speed.

16. The control device of the hybrid vehicle according to claim 12,
wherein the hybrid vehicle includes an assist motor generator which outputs a torque to the driving axis by an electric power generated by the motor generator, and
wherein the control unit controls the torque outputted by the assist motor generator such that a driving force of the driving axis becomes a requested driving force, at the time of switching the speed change mode.

17. The control device of the hybrid vehicle according to claim 12, wherein the assist unit is the engaging mechanism configured such that engaging elements engaging with each other can perform differential rotation.

18. The control device of the hybrid vehicle according to claim 17, wherein the control unit controls the engine torque such that the driving force becomes constant, in a case that the vehicle operation point moves from the infinite variable speed mode area to the second fixed speed change mode area by the increase of the accelerator opening degree or the vehicle speed.

19. The control device of the hybrid vehicle according to claim 12, wherein the control unit makes the motor generator output the reaction torque in a case that the vehicle operation point moves from the first fixed speed change mode area to the infinite variable speed area by the increase of the accelerator opening degree.

20. The control device of the hybrid vehicle according to claim 12, wherein the control unit makes the motor generator and the assist unit output the reaction torque in a case that the vehicle operation point moves from the second fixed speed change mode area to the infinite variable speed area by the increase of the accelerator opening degree.

21. The control device of the hybrid vehicle according to claim 12,
wherein the assist unit is a torque-up unit which temporarily increases the torque, that can be outputted from the motor generator, to be larger than the maximum rating torque, and
wherein the control unit increases the torque outputted by the motor generator by the torque-up unit and limits the engine torque in accordance with the increased torque outputted by the motor generator in a case that the vehicle operation point moves from the infinite variable speed mode to the second fixed speed change mode.

22. The control device of the hybrid vehicle according to claim 15, wherein the control unit increases an assist torque outputted by the assist motor generator and decreases the engine torque in accordance with an increased amount of the assist torque such that a driving force of the driving axis becomes a requested driving force in a case that he vehicle operation point moves from the second fixed speed change mode to the infinite variable speed mode.
